(19) United States
(12) Patent Application Publication
(10) Pub. No.: US 2026/0269621 A1
(43) Pub. Date: Sep. 10, 2026

(54) DEVICES, SYSTEMS, AND METHODS FOR PROVIDING CONTROLS IN BATTERY SYSTEMS

(71) Applicant: Katz Water Tech, LLC, Houston, TX (US)

(72) Inventors: Gary P Katz, HOUSTON, TX (US); Darren P Yates, HOUSTON, TX (US)

(73) Assignee: Katz Water Tech, LLC, Houston, TX (US)

(21) Appl. No.: 19/559,819

(22) Filed: Mar. 6, 2026

Related U.S. Application Data
(60) Provisional application No. 63/767,742, filed on Mar. 6, 2025.

(51) Int. Cl. H02J 3/32; H01M 10/42; H01M 10/44; H01M 10/46; H01M 10/48; H02J 3/38; H02J 7/90; H02J 13/12

(52) U.S. Cl. CPC H02J 3/32; H01M 10/425; H01M 10/441; H01M 10/443; H01M 10/46; H01M 10/486; H02J 3/38; H02J 7/927; H02J 13/12; H01M 2010/4271; H01M 2220/10

(57) ABSTRACT

Embodiments of the present invention disclose a remote battery control system that can integrate advanced controls, fast pulse charging, open architecture, and grid and off-grid compatibility. The system can provide a robust framework for real-time monitoring, predictive maintenance, and energy optimization through IoT-enabled communication modules, machine learning algorithms, and artificial intelligence. A high-frequency switching circuit facilitates fast pulse charging, optimizing charging efficiency while reducing battery wear and thermal degradation. Open architecture ensures seamless interoperability with multiple power sources, including grid power, renewable energy systems, electric vehicles, and standalone generators. Mesh network options provide enhanced communication security and robustness. Open architecture can employ end-to-end encryption, dynamic routing, and intrusion detection mechanisms to protect against cyberattacks and ensure data integrity. The system's grid and off-grid compatibility enables uninterrupted power delivery, dynamically transitioning between power sources during outages, and provides comprehensive energy management, situational awareness, and AI decision support.

### FIELD OF DISCLOSURE

The present disclosure generally relates to energy storage systems and battery systems. More particularly, the present disclosure relates to devices, systems, and methods for integrating Internet of Things (IoT) controls to optimize the operation, monitoring, and management of battery systems, including Beyond The Meter (BTM) systems.

### RELATED FILINGS

This U.S. Non-provisional patent application claims the benefit of U.S. Provisional Patent Application No. 63/767,742, filed on Mar. 6, 2025, entitled "Devices, Systems, and Methods for Providing Controls in Battery Systems," the entire contents of which are incorporated herein by reference.

### BACKGROUND

The increasing integration of renewable energy sources, such as solar and wind, into residential, commercial, and industrial energy systems has created a growing need for efficient and reliable energy storage solutions. Beyond-the-meter (BTM) battery systems, installed on the consumer side of the electricity meter, have emerged as a critical component in meeting this need. These systems allow users to store energy generated onsite, manage energy consumption during peak periods, and ensure resilience in the event of power outages. Additionally, BTM batteries play a significant role in enabling decentralized energy management, reducing dependency on centralized grids, and supporting the global transition toward cleaner energy systems.

Despite their growing adoption, current BTM battery technologies face several challenges. High upfront costs remain a significant barrier, limiting accessibility for many consumers and businesses. Moreover, the performance and lifespan of these batteries are constrained by issues such as capacity degradation over time, energy density limitations, and thermal management inefficiencies. These factors contribute to reduced reliability and higher long-term costs.

Recycling and sustainability of battery materials further complicate the adoption of BTM systems. The disposal of used batteries, particularly those based on lithium-ion chemistries, raises environmental concerns and introduces logistical challenges. The lack of robust recycling frameworks exacerbates these issues, hindering the sustainable deployment of battery technology.

Another critical shortcoming is the lack of standardization and interoperability in BTM systems. The absence of uniform protocols and communication standards complicates the integration of these systems with diverse energy infrastructures, including smart grids and hybrid energy setups.

Additionally, regulatory and policy barriers, including unclear incentives and complex permitting processes, create uncertainty for potential adopters and slow market growth.

An emerging requirement for modern BTM battery systems is the integration of independent Internet of Things (IoT) controls, as well as associated software and cloud- based applications. IoT-enabled controls allow for real-time monitoring, remote management, predictive maintenance, and intelligent optimization of battery usage based on user behavior and grid conditions. These functionalities significantly enhance the efficiency, reliability, and user experience of BTM systems. However, incorporating IoT controls into BTM battery systems presents several challenges. These systems require sophisticated hardware and software integration to ensure seamless operation, secure data transmission, and low latency in response to dynamic conditions. IoT devices must be designed to withstand environmental factors and potential interference in harsh operating environments. Moreover, ensuring cybersecurity for IoT-connected BTM systems is paramount, as these devices are vulnerable to hacking and data breaches. The development and deployment of cloud-based applications for energy analytics, control, and reporting further add to the complexity, requiring robust infrastructure and cross-platform compatibility.

A key feature increasingly demanded of BTM battery systems is the ability to operate both on the grid and off the grid. Grid-connected functionality allows these systems to participate in demand response, load shifting, and energy trading, enhancing overall energy efficiency and reducing costs for users. Off-grid operation, on the other hand, ensures energy resilience during grid outages and enables deployment in remote or underserved areas with limited grid access.

However, integrating grid and off-grid capabilities into a single system is inherently complex. The system must be able to seamlessly transition between grid- connected and off-grid modes, often in real time, without disrupting power delivery to critical loads. This requires sophisticated power electronics, adaptive control algorithms, and robust energy management systems. Furthermore, grid-interactive systems must comply with stringent interconnection standards and safety regulations, which vary across regions and utilities, adding to the design and certification challenges. Off-grid functionality demands additional components, such as inverters and islanding protection mechanisms, which increase system cost and complexity. Balancing these requirements while maintaining system efficiency, reliability, and affordability remains a significant technological and engineering challenge.

These challenges underscore the need for innovation in BTM battery technology. There is an ongoing demand for systems that are cost-effective, durable, and sustainable, while also being interoperable, IoT-enabled, capable of dual-mode operation, and aligned with evolving regulatory frameworks. Addressing these needs would unlock the full potential of BTM batteries in revolutionizing energy storage, distribution, and consumption.

Modern energy systems demand flexibility, efficiency, and reliability to manage increasingly complex power requirements. BTM battery systems are integral to this landscape, enabling energy storage, load management, and backup power. However, current systems often face limitations in interoperability, responsiveness, and compatibility with diverse power sources and inverters. Integrating advanced technologies like IoT, PLCs, fast pulse charging, and open architecture into the battery system addresses these limitations.

The increasing integration of renewable energy sources, such as solar and wind, into residential, commercial, and industrial energy systems has created a growing need for efficient and reliable energy storage solutions. Beyond-the-meter (BTM) battery systems, installed on the consumer side of the electricity meter, have emerged as a critical component in meeting this need. These systems allow users to store energy generated onsite, manage energy consumption during peak periods, and ensure resilience in the event of power outages. Additionally, BTM batteries play a significant role in enabling decentralized energy management, reducing dependency on centralized grids, and supporting the global transition toward cleaner energy systems.

Despite their growing adoption, current BTM battery technologies face several challenges. High upfront costs remain a significant barrier, limiting accessibility for many consumers and businesses. Moreover, the performance and lifespan of these batteries are constrained by issues such as capacity degradation over time, energy density limitations, and thermal management inefficiencies. These factors contribute to reduced reliability and higher long-term costs.

Recycling and sustainability of battery materials further complicate the adoption of BTM systems. The disposal of used batteries, particularly those based on lithium-ion chemistries, raises environmental concerns and introduces logistical challenges. The lack of robust recycling frameworks exacerbates these issues, hindering the sustainable deployment of battery technology.

Another critical shortcoming is the lack of standardization and interoperability in BTM systems. The absence of uniform protocols and communication standards complicates the integration of these systems with diverse energy infrastructures, including smart grids and hybrid energy setups.

Additionally, regulatory and policy barriers, including unclear incentives and complex permitting processes, create uncertainty for potential adopters and slow market growth.

An emerging requirement for modern BTM battery systems is the integration of independent Internet of Things (IoT) controls, as well as associated software and cloud- based applications. IoT-enabled controls allow for real-time monitoring, remote management, predictive maintenance, and intelligent optimization of battery usage based on user behavior and grid conditions. These functionalities significantly enhance the efficiency, reliability, and user experience of BTM systems. However, incorporating IoT controls into BTM battery systems presents several challenges. These systems require sophisticated hardware and software integration to ensure seamless operation, secure data transmission, and low latency in response to dynamic conditions. IoT devices must be designed to withstand environmental factors and potential interference in harsh operating environments. Moreover, ensuring cybersecurity for IoT-connected BTM systems is paramount, as these devices are vulnerable to hacking and data breaches. The development and deployment of cloud-based applications for energy analytics, control, and reporting further add to the complexity, requiring robust infrastructure and cross-platform compatibility.

A key feature increasingly demanded of BTM battery systems is the ability to operate both on the grid and off the grid. Grid-connected functionality allows these systems to participate in demand response, load shifting, and energy trading, enhancing overall energy efficiency and reducing costs for users. Off-grid operation, on the other hand, ensures energy resilience during grid outages and enables deployment in remote or underserved areas with limited grid access.

However, integrating grid and off-grid capabilities into a single system is inherently complex. The system must be able to seamlessly transition between grid- connected and off-grid modes, often in real time, without disrupting power delivery to critical loads. This requires sophisticated power electronics, adaptive control algorithms, and robust energy management systems. Furthermore, grid-interactive systems must comply with stringent interconnection standards and safety regulations, which vary across regions and utilities, adding to the design and certification challenges. Off-grid functionality demands additional components, such as inverters and islanding protection mechanisms, which increase system cost and complexity. Balancing these requirements while maintaining system efficiency, reliability, and affordability remains a significant technological and engineering challenge.

These challenges underscore the need for innovation in BTM battery technology. There is an ongoing demand for systems that are cost-effective, durable, and sustainable, while also being interoperable, IoT-enabled, capable of dual-mode operation, and aligned with evolving regulatory frameworks. Addressing these needs would unlock the full potential of BTM batteries in revolutionizing energy storage, distribution, and consumption.

Modern energy systems demand flexibility, efficiency, and reliability to manage increasingly complex power requirements. BTM battery systems are integral to this landscape, enabling energy storage, load management, and backup power. However, current systems often face limitations in interoperability, responsiveness, and compatibility with diverse power sources and inverters. Integrating advanced technologies like IoT, PLCs, fast pulse charging, and open architecture into the battery system addresses these limitations.

Fast pulse charging represents an emerging approach to reducing charge times and mitigating electrochemical stress in BTM battery systems. Conventional constant- current and constant-voltage charging protocols may contribute to accelerated capacity degradation, lithium plating, and elevated thermal loads, particularly under high-demand conditions. Fast pulse charging techniques, which apply intermittent high-current pulses interspersed with rest or discharge intervals, may reduce internal resistance buildup, improve ion diffusion kinetics, and extend cycle life. However, implementing fast pulse charging in BTM systems presents challenges, including the need for precise waveform control, compatibility with existing battery chemistries, and integration with thermal management subsystems. The absence of standardized fast pulse charging protocols further complicates interoperability across battery management platforms.

Programmable logic controllers (PLCs) have been increasingly considered for integration into BTM battery systems as a means of providing deterministic, real-time control over charging, discharging, and load management operations. PLCs offer advantages over general-purpose computing platforms in terms of reliability, fault tolerance, and response latency in industrial and commercial energy environments. However, integrating PLCs into BTM battery systems introduces challenges related to communication protocol compatibility, firmware customization, and coordination with higher-level energy management software. Existing BTM architectures may lack the hardware interfaces and software abstraction layers necessary to accommodate PLC-based control, limiting the adoption of this approach in distributed energy storage applications.

Battery management systems (BMS) are responsible for monitoring and regulating cell-level parameters, including state of charge, state of health, temperature, and voltage balance, within BTM battery packs. Despite their central role, current BMS implementations face limitations in scalability, accuracy, and adaptability. Conventional BMS designs may rely on static algorithms that do not account for dynamic changes in battery chemistry, aging effects, or variable load profiles, resulting in suboptimal performance and premature capacity loss. Furthermore, the lack of open communication interfaces in many proprietary BMS platforms restricts integration with third-party energy management systems, IoT controllers, and grid-interactive software, reducing overall system flexibility and limiting the ability to implement advanced optimization strategies.

Energy arbitrage and grid services represent significant potential revenue streams for BTM battery system operators; however, current systems frequently lack the control sophistication and market interface capabilities necessary to fully exploit these opportunities. Energy arbitrage involves storing energy during periods of low electricity prices and discharging during high-price intervals, while grid services may include frequency regulation, voltage support, and demand response participation. Realizing these capabilities requires low-latency communication with grid operators, accurate state-of- charge estimation, and adaptive dispatch algorithms capable of responding to dynamic market signals. Many existing BTM systems operate with limited visibility into real-time pricing and grid conditions, and lack the software infrastructure to participate in ancillary service markets, thereby constraining the economic value and grid-support potential of deployed battery assets.

Fast pulse charging represents an emerging approach to reducing charge times and mitigating electrochemical stress in BTM battery systems. Conventional constant- current and constant-voltage charging protocols contribute to accelerated capacity degradation, lithium plating, and elevated thermal loads, particularly under high-demand conditions. Fast pulse charging techniques, which apply intermittent high-current pulses interspersed with rest or discharge intervals, reduce internal resistance buildup, improve ion diffusion kinetics, and extend cycle life. However, implementing fast pulse charging in BTM systems presents challenges, including the need for precise waveform control, compatibility with existing battery chemistries, and integration with thermal management subsystems. The absence of standardized fast pulse charging protocols further complicates interoperability across battery management platforms.

Programmable logic controllers (PLCs) have been increasingly considered for integration into BTM battery systems as a means of providing deterministic, real-time control over charging, discharging, and load management operations. PLCs offer advantages over general-purpose computing platforms in terms of reliability, fault tolerance, and response latency in industrial and commercial energy environments. However, integrating PLCs into BTM battery systems introduces challenges related to communication protocol compatibility, firmware customization, and coordination with higher-level energy management software. Existing BTM architectures lack the hardware interfaces and software abstraction layers necessary to accommodate PLC-based control, limiting the adoption of this approach in distributed energy storage applications.

Battery management systems (BMS) are responsible for monitoring and regulating cell-level parameters, including state of charge, state of health, temperature, and voltage balance, within BTM battery packs. Despite their central role, current BMS implementations face limitations in scalability, accuracy, and adaptability. Conventional BMS designs rely on static algorithms that do not account for dynamic changes in battery chemistry, aging effects, or variable load profiles, resulting in suboptimal performance and premature capacity loss. Furthermore, the lack of open communication interfaces in many proprietary BMS platforms restricts integration with third-party energy management systems, IoT controllers, and grid-interactive software, reducing overall system flexibility and limiting the ability to implement advanced optimization strategies.

Energy arbitrage and grid services represent potential revenue streams for BTM battery system operators; however, current systems frequently lack the control sophistication and market interface capabilities necessary to fully exploit these opportunities. Energy arbitrage involves storing energy during periods of low electricity prices and discharging during high-price intervals, while grid services include frequency regulation, voltage support, and demand response participation. Realizing these capabilities requires low-latency communication with grid operators, accurate state-of-charge estimation, and adaptive dispatch algorithms capable of responding to dynamic market signals. Many existing BTM systems operate with limited visibility into real-time pricing and grid conditions, and lack the software infrastructure to participate in ancillary service markets, thereby constraining the economic value and grid-support potential of deployed battery assets.

Open architecture frameworks have been proposed as a means of improving interoperability and extensibility in BTM battery systems. Proprietary system designs, which predominate in the current market, restrict the ability of operators and integrators to incorporate third-party components, update control software, or adapt system configurations to evolving application requirements. The absence of open application programming interfaces (APIs) and modular hardware platforms limits the scalability of BTM deployments and increases the cost and complexity of system upgrades. Furthermore, closed architectures impede the development of ecosystem-level integrations, including connections to building energy management systems, electric vehicle charging infrastructure, and utility-facing demand response platforms, reducing the overall utility of BTM battery assets across diverse deployment contexts.

Thermal management represents a persistent challenge in BTM battery system design. Elevated operating temperatures accelerate electrochemical degradation, reduce cycle life, and introduce safety risks including thermal runaway in lithium-ion cell chemistries. Conversely, operation at low temperatures reduces available capacity and increases internal resistance, degrading system performance. Existing thermal management approaches, including passive cooling, forced air circulation, and liquid cooling, each present trade-offs in terms of cost, complexity, energy consumption, and spatial requirements. The integration of thermal management subsystems with BMS and IoT control layers further complicates system design, as coordinated thermal regulation requires real-time data exchange across multiple hardware and software components. The absence of standardized thermal management interfaces limits the interoperability of thermal subsystems with diverse BTM platform architectures.

Scalability and modularity present additional challenges for BTM battery system deployment across residential, commercial, and industrial applications. Residential deployments typically require compact, low-cost systems with simplified installation procedures, while commercial and industrial applications demand higher energy and power capacities, more sophisticated control interfaces, and compliance with additional safety and interconnection standards. Current BTM platforms frequently lack modular architectures that allow capacity to be scaled incrementally to match evolving load requirements. The inability to add battery modules, inverter capacity, or control functionality without replacing entire system assemblies increases the total cost of ownership and reduces the adaptability of deployed assets over their operational lifetimes.

Communication protocol fragmentation further compounds the interoperability challenges facing BTM battery systems. Existing deployments utilize a heterogeneous mix of communication standards, including Modbus, CANbus, RS-485, Ethernet-based protocols, and proprietary wireless interfaces, without a unified framework for data exchange between system components. This fragmentation complicates the integration of BTM systems with building automation platforms, utility communication networks, and third-party energy management software. The lack of a common data model for battery state parameters, control commands, and diagnostic information prevents seamless interoperability across manufacturers and system generations, increasing integration costs and limiting the deployment of advanced control strategies that depend on coordinated data exchange across multiple system layers.

These challenges collectively underscore the demand for BTM battery systems that address the full spectrum of technical, economic, and operational deficiencies present in current implementations. There is an ongoing demand for systems that incorporate open architecture designs, standardized communication interfaces, modular scalability, advanced thermal management, PLC-based deterministic control, fast pulse charging capability, and robust IoT integration. Addressing these deficiencies would enable BTM battery systems to deliver improved performance, extended operational lifetimes, enhanced grid interactivity, and broader accessibility across residential, commercial, and industrial deployment contexts.

Fast pulse charging represents an emerging approach to reducing charge times and mitigating electrochemical stress in BTM battery systems. Conventional constant- current and constant-voltage charging protocols contribute to accelerated capacity degradation, lithium plating, and elevated thermal loads, particularly under high-demand conditions. Fast pulse charging techniques, which apply intermittent high-current pulses interspersed with rest or discharge intervals, reduce internal resistance buildup, improve ion diffusion kinetics, and extend cycle life. However, implementing fast pulse charging in BTM systems presents challenges, including the need for precise waveform control, compatibility with existing battery chemistries, and integration with thermal management subsystems. The absence of standardized fast pulse charging protocols further complicates interoperability across battery management platforms.

Programmable logic controllers (PLCs) have been increasingly considered for integration into BTM battery systems as a means of providing deterministic, real-time control over charging, discharging, and load management operations. PLCs offer advantages over general-purpose computing platforms in terms of reliability, fault tolerance, and response latency in industrial and commercial energy environments. However, integrating PLCs into BTM battery systems introduces challenges related to communication protocol compatibility, firmware customization, and coordination with higher-level energy management software. Existing BTM architectures lack the hardware interfaces and software abstraction layers necessary to accommodate PLC-based control, limiting the adoption of this approach in distributed energy storage applications.

Battery management systems (BMS) are responsible for monitoring and regulating cell-level parameters, including state of charge, state of health, temperature, and voltage balance, within BTM battery packs. Despite their central role, current BMS implementations face limitations in scalability, accuracy, and adaptability. Conventional BMS designs rely on static algorithms that do not account for dynamic changes in battery chemistry, aging effects, or variable load profiles, resulting in suboptimal performance and premature capacity loss. Furthermore, the lack of open communication interfaces in many proprietary BMS platforms restricts integration with third-party energy management systems, IoT controllers, and grid-interactive software, reducing overall system flexibility and limiting the ability to implement advanced optimization strategies.

Energy arbitrage and grid services represent potential revenue streams for BTM battery system operators; however, current systems frequently lack the control sophistication and market interface capabilities necessary to fully exploit these opportunities. Energy arbitrage involves storing energy during periods of low electricity prices and discharging during high-price intervals, while grid services include frequency regulation, voltage support, and demand response participation. Realizing these capabilities requires low-latency communication with grid operators, accurate state-of-charge estimation, and adaptive dispatch algorithms capable of responding to dynamic market signals. Many existing BTM systems operate with limited visibility into real-time pricing and grid conditions, and lack the software infrastructure to participate in ancillary service markets, thereby constraining the economic value and grid-support potential of deployed battery assets.

Open architecture frameworks have been proposed as a means of addressing interoperability limitations in BTM battery systems. Proprietary system designs restrict the ability of operators to integrate components from multiple vendors, upgrade individual subsystems, or adopt emerging communication standards without wholesale system replacement. The absence of open, modular architectures increases the total cost of ownership, limits scalability, and reduces the adaptability of BTM systems to evolving grid requirements and regulatory mandates. Furthermore, closed architectures impede the development of third-party software applications and analytics platforms that could otherwise enhance system performance and operator visibility.

Thermal management remains a persistent challenge in BTM battery system design. Elevated operating temperatures accelerate electrochemical degradation, reduce cycle life, and introduce safety risks including thermal runaway. Existing thermal management approaches, including passive cooling and conventional active cooling systems, face limitations in maintaining uniform temperature distribution across battery cell arrays under variable charge and discharge conditions. Inadequate thermal management contributes to cell imbalance, accelerated capacity fade, and reduced system reliability, particularly in installations subject to high ambient temperatures or demanding duty cycles.

The convergence of these technical, economic, regulatory, and operational challenges underscores the demand for BTM battery systems that are capable of addressing deficiencies across multiple dimensions simultaneously. There is an ongoing demand for systems that incorporate open architecture designs, PLC-based deterministic control, advanced BMS functionality, fast pulse charging capability, robust thermal management, and grid-interactive software interfaces within a unified, interoperable platform. Addressing these deficiencies would enable BTM battery systems to deliver enhanced performance, extended service life, broader deployment applicability, and greater participation in grid services and energy markets.

### SUMMARY

This section provides a general summary of the disclosure and is not a comprehensive disclosure of the full scope of all its features. The purpose is to introduce the reader to various aspects of art, which may be associated with embodiments of the present invention. This discussion is believed to help and provide the reader with information to facilitate a better understanding of the techniques of the present invention. Accordingly, these statements are to be read in this light, and not necessarily as admissions of prior art.

Embodiments of the invention relate to a device for monitoring fluids. In one embodiment this device comprises an outer protective housing; a wireless communication device inside the outer protective housing; at least one device for determining at least one property of a fluid that may be connected to the outer protective housing; and at least one transmitter for sending data from the at least one device for determining the at least one property of a fluid to the wireless communication device.

The present invention provides devices, systems, and methods for integrating IoT controls into BTM battery systems. These controls may enable seamless communication between the battery system and external devices, real-time data processing, and intelligent energy management through cloud-based and local software platforms. The invention addresses key challenges such as secure data transmission, low-latency operation, and adaptive energy management to enhance the performance and usability of BTM battery systems.

An embodiment may comprise IoT-enabled controls, PLCs, and variable two-way inverters, enabling intelligent energy management, precise control, and real-time adaptability. Fast pulse charging technology may accelerate charging while minimizing degradation. Grid/off-grid capabilities may ensure uninterrupted power delivery even in unstable grid conditions. The system's open

Additional aspects and advantages of the present disclosure will become apparent to those skilled in this art from the following detailed description, wherein only illustrative embodiments of the present disclosure are shown and described. The present disclosure is capable of other and different embodiments, and its several details are capable of modifications in various obvious respects, all without departing from the disclosure. Accordingly, the drawings, descriptions, and examples in this summary are intended for purposes of illustration only and are not intended to limit the scope of the present disclosure.

### SUMMARY

This section provides a general summary of the disclosure and is not a comprehensive disclosure of the full scope of all its features. The purpose is to introduce the reader to various aspects of art, which may be associated with embodiments of the present invention. This discussion is believed to help and provide the reader with information to facilitate a better understanding of the techniques of the present invention. Accordingly, these statements are to be read in this light, and not necessarily as admissions of prior art. Embodiments of the invention relate to a device for monitoring fluids. In one embodiment this device comprises an outer protective housing; a wireless communication device inside the outer protective housing; at least one device for determining at least one property of a fluid that may be connected to the outer protective housing; and at least one transmitter for sending data from the at least one device for determining the at least one property of a fluid to the wireless communication device. The present invention provides devices, systems, and methods for integrating IoT controls into BTM battery systems. These controls may enable seamless communication between the battery system and external devices, real-time data processing, and intelligent energy management through cloud-based and local software platforms. The invention addresses key challenges such as secure data transmission, low-latency operation, and adaptive energy management to enhance the performance and usability of BTM battery systems.

This section provides a general summary of the disclosure and is not a comprehensive disclosure of the full scope of all its features. The purpose is to introduce the reader to various aspects of art, which may be associated with embodiments of the present invention. This discussion is believed to help and provide the reader with information to facilitate a better understanding of the techniques of the present invention. Accordingly, these statements are to be read in this light, and not necessarily as admissions of prior art.

Embodiments of the invention relate to a device for monitoring fluids. In one embodiment this device comprises an outer protective housing; a wireless communication device inside the outer protective housing; at least one device for determining at least one property of a fluid that may be connected to the outer protective housing; and at least one transmitter for sending data from the at least one device for determining the at least one property of a fluid to the wireless communication device.

The present invention provides devices, systems, and methods for integrating IoT controls into BTM battery systems. These controls may enable seamless communication between the battery system and external devices, real-time data processing, and intelligent energy management through cloud-based and local software platforms. The invention addresses key challenges such as secure data transmission, low-latency operation, and adaptive energy management to enhance the performance and usability of BTM battery systems.

An embodiment may comprise IoT-enabled controls, PLCs, and variable two-way inverters, enabling intelligent energy management, precise control, and real-time adaptability. Fast pulse charging technology may accelerate charging while minimizing degradation. Grid/off-grid capabilities may ensure uninterrupted power delivery even in unstable grid conditions. The system's open

Additional aspects and advantages of the present disclosure will become apparent to those skilled in this art from the following detailed description, wherein only illustrative embodiments of the present disclosure are shown and described. The present disclosure is capable of other and different embodiments, and its several details are capable of modifications in various obvious respects, all without departing from the disclosure. Accordingly, the drawings, descriptions, and examples in this summary are intended for purposes of illustration only and are not intended to limit the scope of the present disclosure.

### BRIEF OVERVIEW

The foregoing is intended to give a general idea of the invention and is not intended to fully define nor limit the invention. The invention will be more fully understood and better appreciated by reference to the following description and drawings. FIG. 1 illustrates a flowchart of monitoring battery system parameters, including state of charge, temperature, and power flow, using an IoT module integrated with the battery system, transmitting the monitored parameters to an external platform via a communication network, analyzing the transmitted parameters using control algorithms on the external platform, generating control signals based on the analysis to optimize battery system performance, and implementing the control signals on the battery system via the IoT module. FIG. 2 illustrates a flowchart of monitoring battery system parameters including state of charge, temperature, and power flow using an IoT module integrated with the battery system, transmitting the monitored parameters to an external platform via a communication network, analyzing the transmitted parameters using control algorithms on the external platform, generating control signals based on the analysis to optimize battery system performance, and implementing the control signals on the battery system via the IoT module. FIG. 3 illustrates a flowchart of detecting and identifying external devices connected to the battery system using an external device detection module, adapting input and output power characteristics using a dynamic signal conversion unit to match the requirements of the connected devices, transmitting compatibility and energy flow data to an external platform via a communication network, processing the compatibility data to generate optimized energy management strategies, and adjusting energy flow between the battery system and the connected devices based on real-time operational parameters. FIG. 4 illustrates a flowchart of monitoring grid conditions in real-time using a grid monitoring module, detecting grid instability including voltage or frequency fluctuations, transitioning the battery system from grid-connected mode to off-grid mode using an intelligent transfer switch, prioritizing power delivery to critical loads during off-grid operation, transitioning the battery system back to grid-connected mode when stability is restored, and transmitting operational data to an external platform for analysis and user monitoring. FIG. 5 illustrates a flowchart of monitoring system parameters including state of charge, temperature, and voltage using an IoT-enabled device, implementing fast pulse charging by generating high- frequency electrical pulses with adjustable characteristics, adapting power inputs from multiple sources using a dynamic signal conversion unit, detecting grid instability and transitioning between grid-connected and off-grid modes using an intelligent transfer switch, optimizing energy flow and system performance through an IoT platform, and providing real-time data and system control to users through a mobile or web application. FIG. 6 illustrates a flowchart of deploying sensors to monitor environmental and operational parameters including air quality, water quality and quantity, battery health, and equipment performance, transmitting data from the sensors to an IoT-enabled platform, analyzing the sensor data using artificial intelligence algorithms to detect trends and anomalies, adjusting system operations dynamically based on insights generated from the analysis, and providing actionable feedback and recommendations to users via a connected interface. FIG. 7 illustrates a flowchart of establishing communication between multiple nodes within a mesh topology, encrypting data transmissions between nodes, monitoring network traffic for anomalies, rerouting data through alternative nodes in response to network disruptions, and integrating network operations with a cloud platform for secure data synchronization. FIG. 8 illustrates a schematic of the battery management system embodiment. FIG. 9 illustrates a visual display of battery system parameters including voltage, current, temperature, and charging and discharging status. FIG. 10 is an illustration of faradaic charge transfer and charge storage operating principles. FIG. 11 is a schematic of a hybrid DC microgrid incorporating both DC and AC inputs and outputs. FIG. 12 is a schematic illustrating integration of the battery management system into a smart home environment with multiple energy inputs including solar, grid, and generator sources. FIGS. 13a, 13b, 13c and 13d illustrate the battery management system housing, the battery management system connected to a residential meter, the battery management system connected to a home generator, and the battery pack during assembly, respectively.

The drawings are not necessarily to scale and the disclosed embodiments are sometimes illustrated diagrammatically and in partial views. In certain instances, details that are not necessary for an understanding of the disclosed methods and apparatuses, or which render other details difficult to perceive may have been omitted. It should be understood, of course, that this disclosure is not limited to any specific embodiment illustrated herein.

### BRIEF DESCRIPTION OF THE DRAWINGS

The accompanying drawings are briefly described below. The foregoing is intended to give a general idea of the invention and is not intended to fully define nor limit the invention. The invention will be more fully understood and better appreciated by reference to the following description and drawings.

FIG. 1 illustrates a flowchart of monitoring battery system parameters, including state of charge, temperature, and power flow, using an IoT module integrated with the battery system, transmitting the monitored parameters to an external platform via a communication network, analyzing the transmitted parameters using control algorithms on the external platform, and generating and implementing control signals to optimize battery system performance.

FIG. 2 illustrates a flowchart of monitoring battery system parameters using an IoT module integrated with the battery system, transmitting the monitored parameters to an external platform via a communication network, analyzing the transmitted parameters using control algorithms, and generating and implementing control signals to optimize battery system performance.

FIG. 3 illustrates a flowchart of detecting and identifying external devices connected to the battery system using an external device detection module, adapting input and output power characteristics using a dynamic signal conversion unit, transmitting compatibility and energy flow data to an external platform via a communication network, processing the compatibility data to generate optimized energy management strategies, and adjusting energy flow between the battery system and connected devices based on real-time operational parameters.

FIG. 4 illustrates a flowchart of monitoring grid conditions in real-time using a grid monitoring module, detecting grid instability including voltage or frequency fluctuations, transitioning the battery system between grid-connected and off-grid modes using an intelligent transfer switch, prioritizing power delivery to critical loads during off-grid operation, and transmitting operational data to an external platform for analysis and user monitoring.

FIG. 5 illustrates a flowchart of monitoring system parameters including state of charge, temperature, and voltage using an IoT-enabled device, implementing fast pulse charging by generating high-frequency electrical pulses with adjustable characteristics, adapting power inputs from multiple sources using a dynamic signal conversion unit, detecting grid instability and transitioning between grid-connected and off-grid modes using an intelligent transfer switch, and optimizing energy flow and system performance through an IoT platform while providing real-time data and system control to users through a mobile or web application.

FIG. 6 illustrates a flowchart of deploying sensors to monitor environmental and operational parameters including air quality, water quality and quantity, battery health, and equipment performance, transmitting data from the sensors to an IoT-enabled platform, analyzing the sensor data using artificial intelligence algorithms to detect trends and anomalies, adjusting system operations dynamically based on insights generated from the analysis, and providing actionable feedback and recommendations to users via a connected interface.

FIG. 7 illustrates a flowchart of establishing communication between multiple nodes within a mesh topology, encrypting data transmissions between nodes, monitoring network traffic for anomalies, rerouting data through alternative nodes in response to network disruptions, and integrating network operations with a cloud platform for secure data synchronization.

FIG. 8 illustrates a schematic of the battery management system embodiment.

FIG. 9 illustrates a visual display of battery system parameters including voltage, current, temperature, and charging and discharging status.

FIG. 10 is an illustration of how faradaic charge transfer and charge storage operate within the battery system.

FIG. 11 is a schematic of a hybrid DC microgrid incorporating both DC and AC inputs and outputs.

FIG. 12 is a schematic illustrating integration of the battery management system into a smart home with multiple energy inputs including solar panels, a grid connection, and a generator.

FIGS. 13a, 13b, 13c, and 13d illustrate the battery management system housing, the battery management system connecting to a residential meter, the battery management system connected to a home generator, and the battery pack during assembly, respectively.

The drawings are not necessarily to scale and the disclosed embodiments are sometimes illustrated diagrammatically and in partial views. In certain instances, details that are not necessary for an understanding of the disclosed methods and apparatuses, or which render other details difficult to perceive may have been omitted. It should be understood, of course, that this disclosure is not limited to any specific embodiment illustrated herein.

### DETAILED DESCRIPTION

Embodiments of this disclosure are intended to include all battery components including the battery management systems and related components. All battery components including battery management components, devices, and systems are intended to be included in the claimed invention.

Before describing selected embodiments of the present disclosure in detail, it is to be understood that the present disclosure is not limited to the embodiments described herein. The disclosure and description herein are illustrative and explanatory of one or more presently preferred embodiments and variations thereof, and it will be appreciated by those skilled in the art that various changes in the design, organization, means of operation, structures and location, methodology, and use of mechanical equivalents may be made without departing from the spirit of the disclosure.

The drawings are intended to illustrate and disclose presently preferred embodiments to one of skill in the art but are not intended to be manufacturing-level drawings or renditions of final products and may include simplified conceptual views to facilitate understanding or explanation. Also, the relative size and arrangement of the components may differ from that shown and still operate within the spirit of the disclosure. Moreover, it will be understood that various directions such as "upper," "lower," "bottom," "top," "left," "right," "first," "second," and so forth are made only concerning explanation in conjunction with the drawings, and that components may be oriented differently, for instance, during transportation and manufacturing as well as operation. Because many varying and different embodiments may be made within the scope of the concept(s) herein taught, and because many modifications may be made in the embodiments described herein, it is to be understood that the details herein are to be interpreted as illustrative and non-limiting.

### Operating Environments

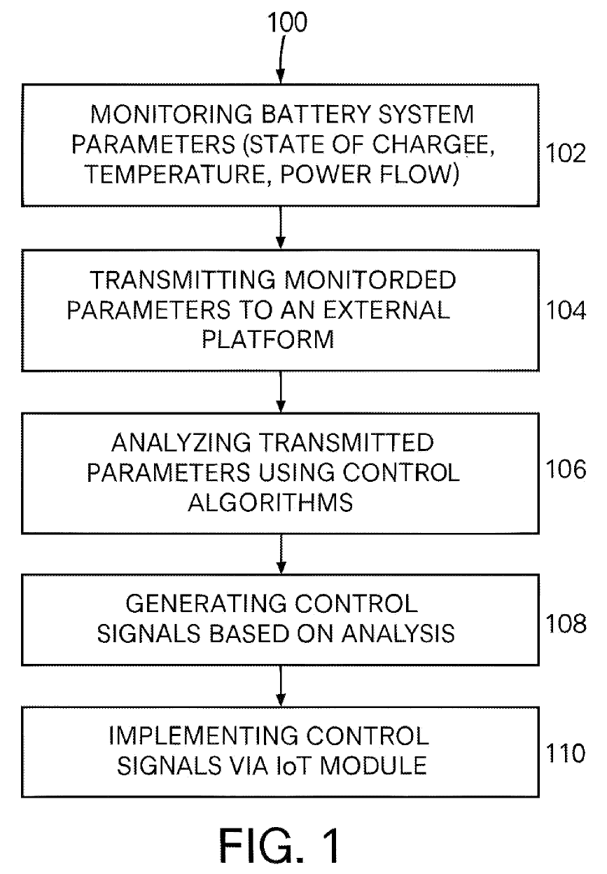

FIG. 1 illustrates a flowchart 100 depicting the operating environment of the IoT- enabled monitoring and control process. In this environment, a battery system may be deployed in a residential, commercial, or industrial setting where continuous oversight of battery parameters may be required. The process may begin at step 102, where battery system parameters including state of charge (SOC), temperature, and power flow may be monitored by sensors integrated within the battery system. At step 104, the monitored parameters may be transmitted from the battery system to an external platform via a communication network, which may include cellular, Wi-Fi, Ethernet, or low-power wide- area network (LPWAN) connections. At step 106, the external platform may analyze the transmitted parameters using control algorithms, which may include rule-based logic, optimization routines, or machine learning models. At step 108, the external platform may generate control signals based on the analysis, with the objective of optimizing battery system performance, extending battery lifespan, and maintaining safe operating conditions. At step 110, the generated control signals may be implemented on the battery system via the IoT module, which may deliver updated setpoints, charge or discharge commands, or protective actions to the local battery management system (BMS) controller. This closed-loop operating environment may support remote management of one or more battery installations from a centralized or distributed cloud platform.

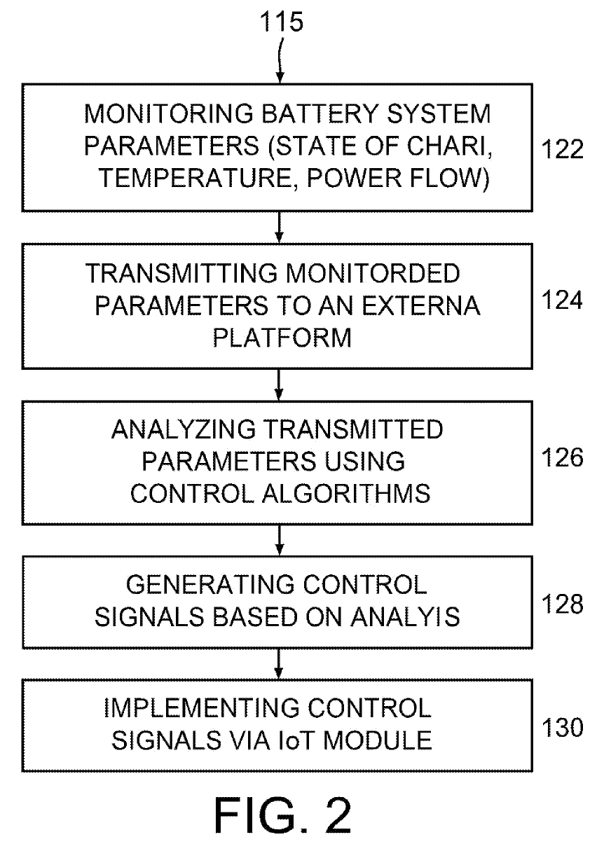

FIG. 2 illustrates a flowchart 115 depicting a second operating environment for IoT-enabled monitoring and control. This environment may be substantially similar to that of FIG. 1 and may represent an alternative or supplementary control loop within the same deployment. At step 122, battery system parameters including SOC, temperature, and power flow may be monitored by the IoT module integrated with the battery system. At step 124, the monitored parameters may be transmitted to the external platform via the communication network. At step 126, the transmitted parameters may be analyzed using control algorithms executing on the external platform. At step 128, control signals may be generated based on the analysis to optimize battery system performance. At step 130, the control signals may be implemented on the battery system via the IoT module. This second control loop may operate in parallel with the loop of FIG. 1, may serve a different subset of battery parameters, or may represent a redundant monitoring pathway that may maintain system oversight in the event that one communication channel may become unavailable.

FIG. 2 illustrates a flowchart 115 depicting a second operating environment for IoT-enabled monitoring and control of a battery system. The flowchart 115 may represent a redundant monitoring pathway that may operate as a parallel control loop within the same deployment as the primary control loop of FIG. 1. The parallel control loop of FIG. 2 may serve a different subset of battery parameters from those monitored in the primary control loop of FIG. 1. This parallel architecture may contribute to a fault-tolerant communication design by maintaining system oversight when one communication channel or one monitoring pathway may become unavailable or compromised.

The parallel control loop of flowchart 115 may begin at step 122, where battery system parameters may be monitored by the IoT module integrated with the battery system. The parameters monitored at step 122 may include state of charge (SOC), temperature, and power flow. These parameters may be monitored independently of the parameters monitored at step 102 of FIG. 1. The IoT module may perform the monitoring function at step 122 using a plurality of sensors integrated with the battery system. The sensors may include voltage sensors, current sensors, and thermal sensors configured to monitor per-cell operational conditions of the battery system. The monitoring performed at step 122 may occur concurrently with the monitoring performed at step 102 of the primary control loop, such that both pathways may collect battery system data simultaneously and independently of one another.

At step 124, the monitored parameters may be transmitted from the battery system to the external platform via the communication network. The communication network used at step 124 may operate independently of the communication channel used at step 104 of FIG. 1. The communication network may include cellular, Wi-Fi, Ethernet, or low- power wide-area network (LPWAN) connections. The independent operation of the communication channel at step 124 may allow the parallel control loop to continue transmitting monitored parameters to the external platform even when the communication channel associated with the primary control loop of FIG. 1 may experience disruption or degradation. This independent transmission pathway may contribute to the fault-tolerant communication design of the overall battery monitoring system.

At step 126, the transmitted parameters may be analyzed using control algorithms executing on the external platform. The control algorithms executing at step 126 may include rule-based logic, optimization routines, or machine learning models. The analysis performed at step 126 may operate independently of the analysis performed at step 106 of FIG. 1. The external platform may execute the control algorithms of step 126 on a separate processing thread or on a separate processing module from those used in the primary control loop. This independent execution may allow the parallel control loop to continue analyzing battery system parameters even when the primary control loop analysis may be interrupted or unavailable.

At step 128, control signals may be generated based on the analysis performed at step 126. The control signals generated at step 128 may be directed toward optimizing battery system performance based on the subset of parameters monitored by the parallel control loop. The control signals generated at step 128 may differ from those generated at step 108 of FIG. 1 in that they may be derived from a different subset of monitored parameters or from a different analytical pathway. The external platform may generate the control signals of step 128 concurrently with the control signals of step 108, such that both sets of control signals may be available for implementation at the battery system.

At step 130, the control signals generated at step 128 may be implemented on the battery system via the IoT module. The IoT module may receive the control signals from the external platform and may relay them to the BMS controller 204 for execution. The implementation of control signals at step 130 may occur independently of the implementation at step 110 of FIG. 1. When the primary control loop of FIG. 1 may be compromised due to a communication failure, a sensor fault, or a disruption in the primary communication channel, the parallel control loop of FIG. 2 may continue to deliver control signals to the battery system via the IoT module, thereby maintaining closed-loop control of the battery system without interruption.

The parallel control loop of flowchart 115 may operate in a complementary relationship with the primary control loop of flowchart 100. The two control loops may monitor overlapping or distinct subsets of battery system parameters. In one embodiment, the primary control loop of FIG. 1 may monitor parameters associated with energy throughput and state of charge, while the parallel control loop of FIG. 2 may monitor parameters associated with thermal conditions and power flow. In another embodiment, both control loops may monitor the same parameters through independent sensor pathways, such that the parallel control loop may serve as a redundant monitoring pathway capable of detecting discrepancies or faults in the primary monitoring pathway.

The fault-tolerant communication design supported by the parallel control loop of FIG. 2 may allow the battery monitoring system to maintain continuous operation under conditions where one pathway may become unavailable. The communication network may support redundant communication protocols to maintain data transmission reliability during network disruptions. When the primary communication channel may experience a failure, the parallel control loop may continue to transmit monitored parameters to the external platform via an alternative communication channel. The external platform may detect the loss of data from the primary control loop and may rely on the data transmitted by the parallel control loop to continue generating control signals for the battery system. This redundant architecture may prevent gaps in monitoring coverage and may ensure that the battery system continues to receive updated control signals even during communication disruptions.

The IoT module may manage the operation of both the primary control loop and the parallel control loop. The IoT module may include a communication interface configured to receive and transmit data between the battery system and the external platform via the communication network. The communication interface may support at least one wireless protocol, including Wi-Fi, Zigbee, Bluetooth, and cellular networks. The IoT module may maintain separate communication channels for the primary control loop and the parallel control loop, such that a failure in one channel may not affect the operation of the other channel. The memory of the IoT module may store control algorithms for dynamic adjustment of battery system operations, and the processor of the IoT module may execute these algorithms independently for each control loop.

The parallel control loop of FIG. 2 may also contribute to the detection of anomalous conditions within the battery system. When the parameters monitored by the parallel control loop at step 122 may deviate from expected values, the control algorithms executing at step 126 may generate alerts or protective control signals at step 128. These alerts may be transmitted to the external platform and may be relayed to the user interface accessible through a mobile application and a web application communicatively coupled to the external platform. The user interface may display the alerts alongside real-time battery system performance metrics, allowing users to identify and respond to anomalous conditions detected by the parallel monitoring pathway.

The redundant monitoring pathway of FIG. 2 may further support the predictive maintenance capabilities of the battery monitoring system. The parameters monitored at step 122 may be analyzed at step 126 using machine learning algorithms stored in the memory of the IoT module or executing on the external platform. These machine learning algorithms may identify patterns in the monitored parameters that may be indicative of impending component degradation or failure. The control signals generated at step 128 may include maintenance recommendations or adjusted operating parameters designed to mitigate the identified degradation patterns. The delivery of these control signals via the parallel control loop at step 130 may allow the battery system to implement protective adjustments even when the primary control loop may be temporarily unavailable.

The architecture represented by FIG. 2 may be deployed in residential, commercial, or industrial settings where continuous oversight of battery parameters may be required. In a residential setting, the parallel control loop may monitor thermal parameters of the battery system while the primary control loop monitors energy throughput parameters, such that both sets of parameters may be continuously monitored and controlled regardless of the availability of either individual communication pathway. In a commercial or industrial setting, the parallel control loop may serve as a dedicated safety monitoring pathway, transmitting thermal and power flow data to the external platform independently of the primary energy management control loop. This separation of monitoring functions across independent pathways may allow the battery monitoring system to maintain safety oversight even when the primary energy management pathway may be undergoing maintenance or reconfiguration.

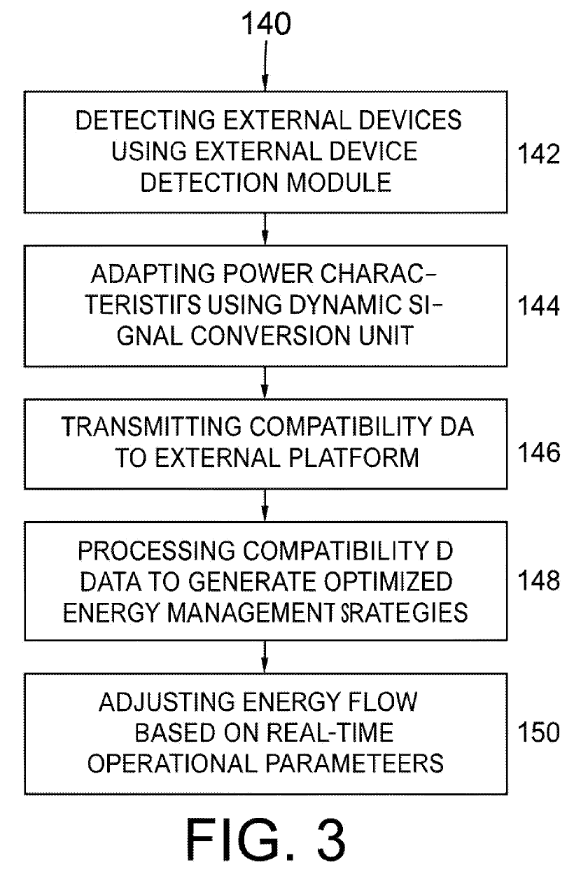

FIG. 3 illustrates a flowchart 140 depicting the operating environment for external device detection and adaptive power management. In this environment, the battery system may be connected to one or more external devices, which may include solar photovoltaic (PV) panels, wind turbines, electric vehicles (EVs), standalone generators, additional battery packs, or grid power sources. At step 142, an external device detection module may detect and identify the external devices connected to the battery system, characterizing each device by its power type, voltage range, current capacity, and communication protocol. At step 144, a dynamic signal conversion unit may adapt the input and output power characteristics of the battery system to match the requirements of the detected devices, performing voltage conversion, current limiting, waveform shaping, or impedance matching as appropriate. At step 146, compatibility data and energy flow data may be transmitted to the external platform via the communication network. At step 148, the external platform may process the compatibility data to generate optimized energy management strategies, which may include source prioritization, charge scheduling, and load routing decisions. At step 150, energy flow between the battery system and the connected devices may be adjusted based on real-time operational parameters, ensuring that power exchange remains within safe and efficient limits for all connected devices.

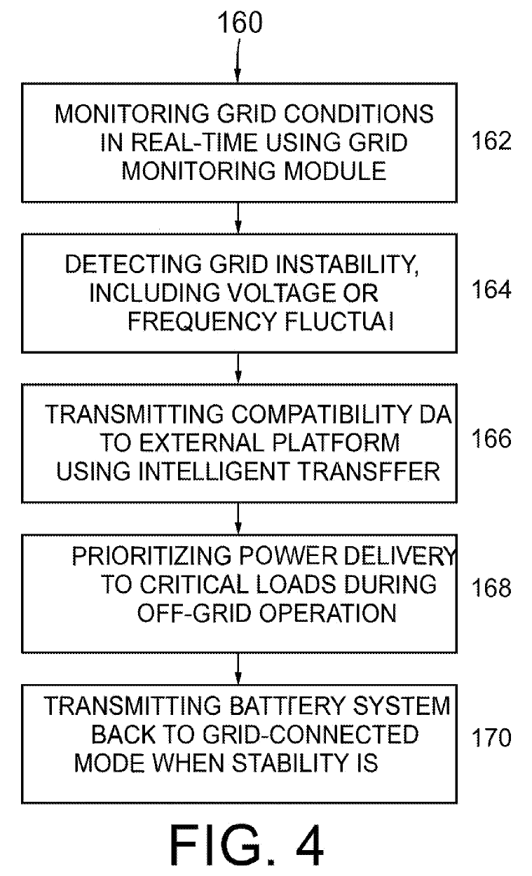

FIG. 4 illustrates a flowchart 160 depicting the operating environment for grid monitoring and mode transition management. In this environment, the battery system may be connected to a utility grid and may be required to maintain uninterrupted power delivery to critical loads during grid disturbances. At step 162, a grid monitoring module may monitor grid conditions in real time, measuring parameters including grid voltage, frequency, and power quality. At step 164, the grid monitoring module may detect grid instability, which may include voltage sags, voltage swells, frequency deviations, or complete grid failure events. At step 166, upon detecting instability, the system may transmit operational data to the external platform via an intelligent transfer switch, which may also initiate the mode transition sequence. At step 168, the battery system may prioritize power delivery to critical loads during off-grid operation, activating a load prioritization protocol that may ensure designated devices such as medical equipment, security systems, and essential appliances may receive uninterrupted power. At step 170, when grid stability may be restored, the battery system may transition back to grid-connected mode, with the intelligent transfer switch performing synchronization checks before reconnection to prevent back-feeding or phase mismatch. This operating environment may be applicable to residential, commercial, and industrial deployments in regions with unstable or unreliable grid infrastructure.

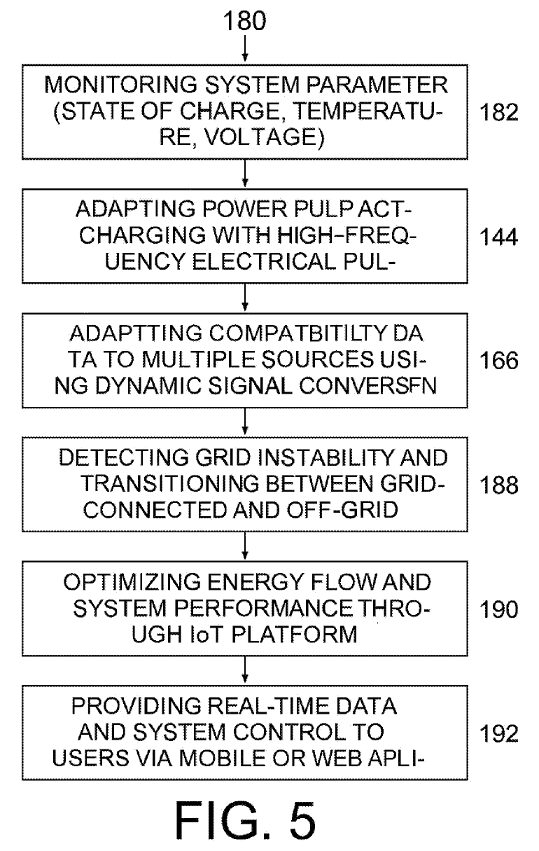

FIG. 5 illustrates a flow diagram 180 depicting a multi-function operating environment that integrates fast pulse charging, dynamic signal conversion, grid mode management, IoT optimization, and user interface control within a single operational context. At step 182, system parameters including SOC, temperature, and voltage may be monitored using an IoT-enabled device integrated with the battery system. At step 184, fast pulse charging may be implemented by generating high-frequency electrical pulses with adjustable amplitude, duration, and frequency, which may be applied to the battery cells to accelerate charging while minimizing heat generation and electrochemical stress. At step 186, power inputs from multiple sources may be adapted using the dynamic signal conversion unit, which may standardize the electrical characteristics of inputs from solar panels, wind turbines, grid power, generators, and electric vehicles to ensure compatibility with the battery system. At step 188, grid instability may be detected and the battery system may transition between grid-connected and off-grid modes using the intelligent transfer switch. At step 190, energy flow and system performance may be optimized through the IoT platform, which may apply machine learning algorithms to balance charging efficiency, source prioritization, and load management. At step 192, real-time data and system control may be provided to users through a mobile or web application, enabling remote monitoring, configuration, and alert management.

FIG. 5 illustrates a flow diagram 180 depicting a multi-function operating environment. As shown in FIG. 5, the second process block and the third process block of flow diagram 180 may bear reference numerals 144 and 166, respectively. It may be noted that reference numeral 144 also appears in FIG. 3, where it designates the second process block of flowchart 140 relating to adapting power characteristics using the dynamic signal conversion unit. Similarly, reference numeral 166 also appears in FIG. 4, where it designates the third process block of flowchart 160 relating to transmitting operational data to the external platform using the intelligent transfer switch. The reuse of reference numerals 144 and 166 in FIG. 5 may reflect that the process blocks so labeled in FIG. 5 correspond to functionally analogous operations as those designated by the same numerals in FIGS. 3 and 4, respectively. Specifically, the process block labeled 144 in FIG. 5 may relate to adapting power inputs from multiple sources using the dynamic signal conversion unit, which may correspond to the dynamic signal conversion function designated by reference numeral 144 in FIG. 3. The process block labeled 166 in FIG. 5 may relate to detecting grid instability and transitioning between grid-connected and off-grid operating modes, which may correspond to the grid instability detection and mode transition function designated by reference numeral 166 in FIG. 4. In this manner, the reuse of reference numerals 144 and 166 across FIGS. 3, 4, and 5 may be understood as denoting process steps that share functional correspondence across the respective operating environments depicted in those figures, and not as references to structurally identical elements. Each instance of these reference numerals may be read in the context of the figure in which it appears.

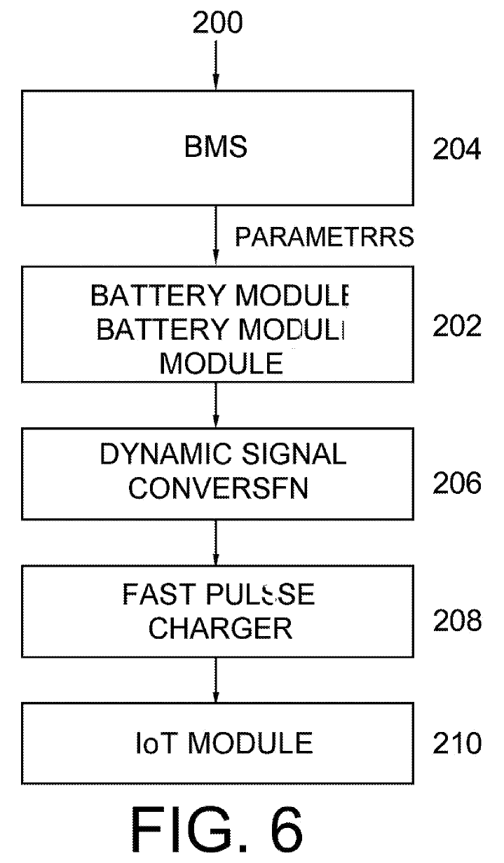

Referring now to FIG. 6, a battery management system architecture 200 may be described. The architecture 200 may comprise a battery module 202. The battery module 202 may serve as the primary energy storage element of the system. A battery management system (BMS) controller 204 may be coupled to the battery module 202. The BMS controller 204 may monitor battery conditions including voltage, temperature, and current. A dynamic signal conversion unit 206 may be coupled to the BMS controller 204. The dynamic signal conversion unit 206 may adjust electrical characteristics to ensure compatibility between the battery system and external power sources. A fast pulse charger 208 may be coupled to the dynamic signal conversion unit 206. The fast pulse charger 208 may implement pulse- based charging strategies. An IoT module 210 may be coupled to the fast pulse charger 208. The IoT module 210 may provide communication with external monitoring platforms, enabling remote control and data analysis.

The BMS controller 204 may receive real-time sensor data from the battery module 202. The BMS controller 204 may issue commands to the dynamic signal conversion unit 206. The BMS controller 204 may also issue commands to the fast pulse charger 208. The BMS controller 204 may exchange data and control signals with the IoT module 210. The IoT module 210 may transmit battery operational parameters to an external platform. The IoT module 210 may also receive control signals from the external platform and relay those signals to the BMS controller 204 for execution.

The dynamic signal conversion unit 206 may adapt voltage levels, current limits, and waveform characteristics. The dynamic signal conversion unit 206 may enable the battery system to interface with heterogeneous power sources including solar panels, wind turbines, grid power, electric vehicle chargers, and generators. The fast pulse charger 208 may apply high-frequency electrical pulses to the battery module 202 during charging operations. The fast pulse charger 208 may dynamically adjust pulse amplitude, duration, and frequency based on real-time battery conditions monitored by the BMS controller 204.

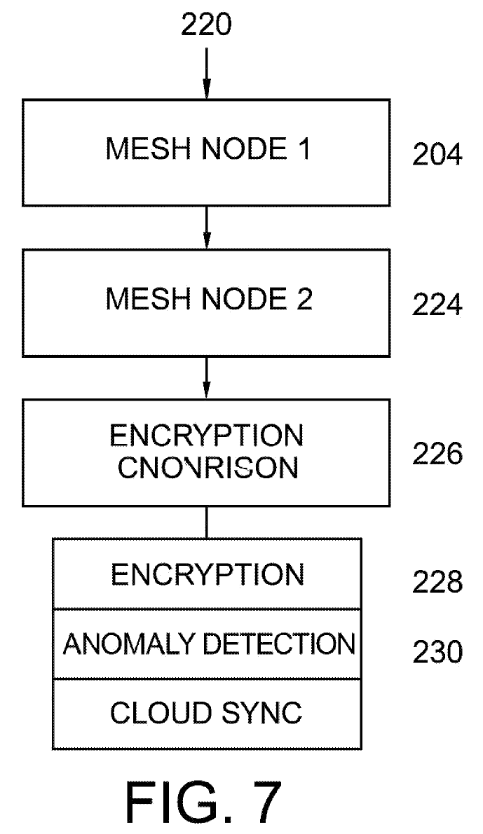

Referring now to FIG. 7, a secure mesh communication network 220 may be described. The secure mesh communication network 220 may enable communication among distributed battery systems. The network 220 may include a first node 222. The first node 222 may transmit and receive system data within the mesh topology. A second node 224 may also be included. The second node 224 may relay data within the mesh network. The first node 222 and the second node 224 may communicate bidirectionally with each other.

An encryption conversion component 226 may be coupled within the network 220. The encryption conversion component 226 may secure communications between nodes. An encryption module 228 may be coupled to the encryption conversion component 226. The encryption module 228 may protect transmitted data using encryption protocols including AES-256 and TLS. An anomaly detection module 230 may be coupled within the composite processing block of the network 220. The anomaly detection module 230 may analyze network traffic to detect potential cybersecurity threats. A cloud synchronization module may also be included within the network 220. The cloud synchronization module may transmit aggregated data to remote monitoring platforms.

The anomaly detection module 230 may operate continuously to identify and flag potential intrusion attempts or data integrity violations. The encryption module 228 may apply cryptographic protocols to all data transmitted between the first node 222 and the second node 224. The encryption conversion component 226 may process outbound data packets prior to encryption. The cloud synchronization module may aggregate operational data from multiple nodes for fleet-level monitoring and analysis.

Referring now to FIG. 7, the secure mesh communication network 220 may be further described with respect to additional components that may enable secure and distributed communication among battery system nodes. As shown in FIG. 7, a first mesh node, designated herein by reference numeral 222, may be positioned at the top of the network architecture 220. It may be noted that FIG. 7 depicts a block labeled "MESH NODE 1" to which the reference numeral 204 has been assigned in the drawing as originally submitted. To avoid ambiguity with respect to reference numeral 204 as used in FIG. 6, where that numeral designates the BMS controller 204 of the battery management system architecture 200, a distinct reference numeral is hereby assigned to the MESH NODE 1 block appearing in FIG. 7. Accordingly, the MESH NODE 1 block in FIG. 7 may be referred to herein by reference numeral 222, consistent with the label assigned to the first node in the written description of the secure mesh communication network 220. Reference numeral 204 as used throughout this disclosure may refer exclusively to the BMS controller depicted in FIG. 6, and reference numeral 222 may refer exclusively to the first mesh node depicted in FIG. 7. These two elements may be structurally and functionally distinct from one another. The BMS controller 204 may serve as the central processing and control unit of the local battery system architecture 200. The first mesh node 222 may serve as a distributed communication unit within the secure mesh communication network 220. The reuse of reference numeral 204 in the originally submitted drawing of FIG. 7 may be understood as a drafting artifact, and the written description may control such that reference numeral 222 may be the operative designation for the first mesh node element in FIG. 7 for all purposes of this disclosure.

The first mesh node 222 may comprise a hardware communication unit associated with a battery system installation. The first mesh node 222 may transmit and receive system data within the mesh topology. The second node 224 may also comprise a hardware communication unit. The second node 224 may relay data between adjacent nodes within the mesh network 220. The first mesh node 222 and the second node 224 may communicate bidirectionally with each other within the network 220.

An encryption conversion component 226 maybe coupled to the second node 224 within the network 220. The encryption conversion component 226 may process outbound data packets prior to transmission between nodes. The encryption conversion component 226 may prepare data for application of cryptographic protocols by the encryption module 228. The encryption module 228 may be coupled to the encryption conversion component 226. The encryption module 228 may implement cryptographic protocols to protect data transmitted between mesh network nodes. The encryption module 228 may apply protocols including, but not limited to, AES-256 and TLS to secure inter-node communications. The encryption module 228 may also apply cryptographic protocols to data transmitted between the battery system and external platforms.

An anomaly detection module 230 may be coupled to the encryption module 228 within the network 220. The anomaly detection module 230 may analyze network traffic patterns in real time. The anomaly detection module 230 may identify traffic patterns indicative of cybersecurity threats. The anomaly detection module 230 may also identify unauthorized access attempts or data integrity violations within the mesh network 220. Upon detection of an anomaly, the anomaly detection module 230 may generate a security alert. The security alert may be transmitted to a cloud synchronization module for relay to an external platform for further action.

A cloud synchronization module may also be included within the network architecture 220. The cloud synchronization module may transmit aggregated operational data from the mesh network nodes to remote monitoring platforms. The cloud synchronization module may operate in conjunction with the encryption module 228 to ensure that all data transmitted to remote platforms may be cryptographically secured.

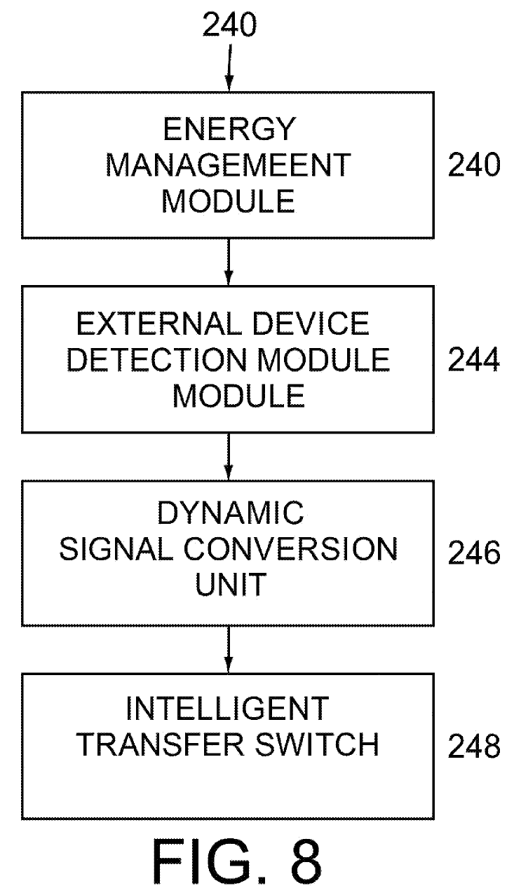

Referring now to FIG. 8, an energy management system architecture 240 may be described. The architecture 240 may comprise an energy management module 242. The energy management module 242 may coordinate overall system operations and energy dispatch. An external device detection module 244 may be coupled to the energy management module 242. The external device detection module 244 may automatically identify external devices connected to the battery system. Detectable device types may include solar panels, generators, electric vehicle chargers, grid connections, and additional battery storage units. A dynamic signal conversion unit 246 may be coupled to the external device detection module 244. The dynamic signal conversion unit 246 may adapt electrical characteristics to ensure compatibility between system components and connected external devices. An intelligent transfer switch 248 may be coupled to the dynamic signal conversion unit 246. The intelligent transfer switch 248 may control switching between power sources and operating modes.

The energy management module 242 may receive input from the external device detection module 244. The energy management module 242 may also receive input from the dynamic signal conversion unit 246. The energy management module 242 may direct the intelligent transfer switch 248 to route power appropriately based on received inputs and real-time system conditions. The intelligent transfer switch 248 may transition the battery system between a grid-connected mode and an off-grid mode. The intelligent transfer switch 248 may perform this transition upon receiving a mode-transition command from the energy management module 242.

The external device detection module 244 may determine the power characteristics of each detected device. Power characteristics that may be determined may include voltage ratings, current limits, and interface type. The external device detection module 244 may transmit device compatibility information to the dynamic signal conversion unit 246 for electrical adaptation. The external device detection module 244 may also transmit compatibility data to an external platform for energy management strategy generation.

The dynamic signal conversion unit 246 may dynamically adjust voltage levels, current limits, and waveform characteristics. The dynamic signal conversion unit 246 may bridge the compatibility gap between the electrical output of a connected external device and the operating requirements of the battery system. The dynamic signal conversion unit 246 may continuously monitor and adjust electrical characteristics in real time as operating conditions change.

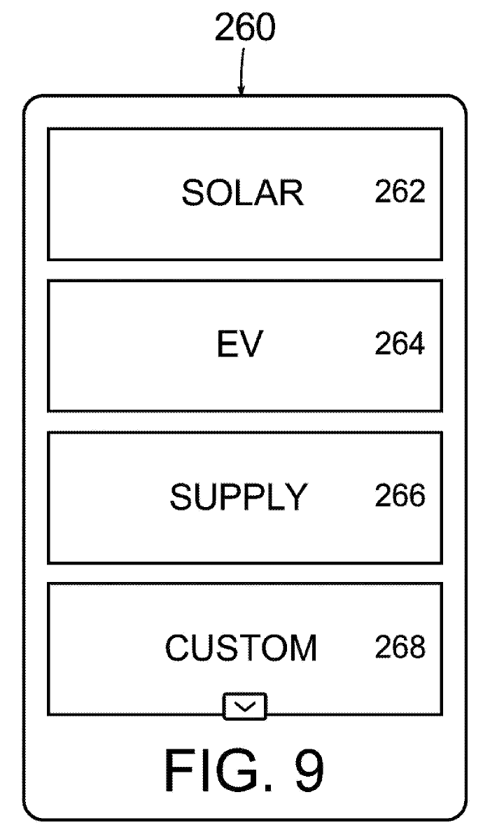

Referring now to FIG. 9, a graphical user interface 260 may be described. The graphical user interface 260 may be accessible via a mobile application or a web browser. The graphical user interface 260 may display selectable energy source configurations. A solar power source option 262 may be selectable within the graphical user interface 260. An electric vehicle power interface option 264 may also be selectable. A utility or grid power source option 266 may be selectable within the graphical user interface 260. A custom or user-defined configuration option 268 may also be selectable. The graphical user interface 260 may display real-time metrics including energy flow, battery state of charge, system alerts, and charging status.

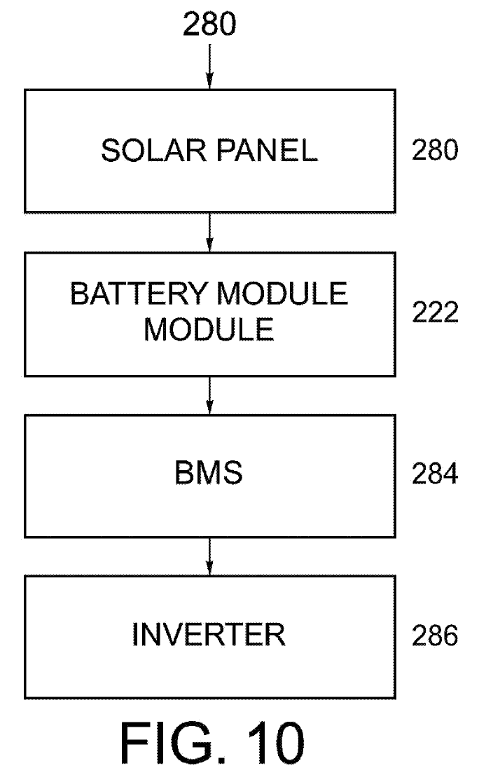

Referring now to FIG. 10, a pulse charging waveform 280 may be described. The pulse charging waveform 280 may be applied to a battery system by the fast pulse charger 208. The waveform 280 may include alternating intervals of charging pulses 282 and rest intervals 284. The pulse amplitude, duration, and frequency of the charging pulses 282 may be dynamically adjusted by the fast pulse charger 208 based on real-time battery conditions monitored by the BMS controller 204. The rest intervals 284 may allow the battery module 202 to recover electrochemically between successive charging pulses 282. Pulse charging as represented by the waveform 280 may reduce heat generation during charging operations. Pulse charging may also improve charge acceptance and may extend the service life of the battery module 202 relative to conventional continuous charging strategies.

Referring now to FIG. 10, the electrochemical mechanism of faradaic charging as implemented by the fast pulse charger 208 maybe further described. As depicted in FIG. 10, the pulse charging waveform 280 may be applied to a battery system comprising a solar panel 280, a battery module 222, a battery management system 284, and an inverter 286. The electrochemical process underlying faradaic charging may be distinguished from conventional pulse charging methodologies by the nature of the charge transfer mechanism occurring at the electrode surfaces of the battery module 222 during each charging pulse 282 and each rest interval 284.

Faradaic charging, as represented by the waveform 280, may involve a charge transfer process in which electrons may be exchanged across the electrode-electrolyte interface of the battery module 222. This electron exchange may be accompanied by a corresponding migration of ions within the electrolyte of the battery module 222. During each charging pulse 282, ions within the electrolyte may migrate toward the electrode surfaces of the battery module 222 in response to the applied electric field generated by the fast pulse charger 208. This ion migration may constitute the faradaic current component of the charging process. The faradaic current may arise from oxidation and reduction reactions occurring at the electrode surfaces of the battery module 222 during each charging pulse 282.

The charge transfer occurring during each charging pulse 282 may result in the accumulation of charge at the electrode surfaces of the battery module 222. This charge accumulation may take the form of intercalated ions within the electrode material of the battery module 222. The intercalation process may involve the insertion of migrating ions into the crystalline lattice structure of the electrode material. The degree of ion intercalation at the electrode surfaces of the battery module 222 may be governed by the amplitude, duration, and frequency of the charging pulses 282 as dynamically adjusted by the fast pulse charger 208 based on real-time battery conditions monitored by the BMS controller 204.

During each rest interval 284, the ion migration within the electrolyte of the battery module 222 may decelerate. The rest interval 284 may allow the ion concentration gradient within the electrolyte to redistribute toward an equilibrium condition. This redistribution may reduce the localized ion depletion that may otherwise develop at the electrode surfaces of the battery module 222 during sustained continuous charging. The reduction of localized ion depletion at the electrode surfaces during each rest interval 284 may improve the charge acceptance of the battery module 222 during the subsequent charging pulse 282.

The faradaic charge transfer mechanism underlying the waveform 280 may be distinguished from the non-faradaic charge storage mechanism associated with conventional capacitive or double-layer charging approaches. In non-faradaic charging, charge may accumulate at the electrode-electrolyte interface without electron transfer or ion intercalation. In faradaic charging as implemented by the fast pulse charger 208, charge transfer may occur through electrochemical reactions at the electrode surfaces of the battery module 222, resulting in a net change in the oxidation state of the electrode material. This electrochemical reaction-based charge transfer may enable a greater quantity of charge to be stored within the electrode material of the battery module 222 per unit time relative to non-faradaic surface accumulation mechanisms.

The BMS controller 204 may monitor the electrochemical response of the battery module 222 during each charging pulse 282. The BMS controller 204 may receive voltage and current data from the battery module 222 and may transmit this data to the IoT module 210 for relay to the external platform. The external platform may analyze the electrochemical response data using control algorithms and may generate control signals that may be transmitted back to the BMS controller 204 via the IoT module 210. The BMS controller 204 may relay these control signals to the fast pulse charger 208, which may adjust the amplitude, duration, and frequency of subsequent charging pulses 282 based on the analyzed electrochemical response of the battery module 222.

The faradaic fast pulse charging methodology implemented by the fast pulse charger 208 may be further distinguished from conventional pulse charging methods by the manner in which the pulse parameters may be dynamically adjusted in response to the electrochemical state of the battery module 222. Conventional pulse charging methods may apply pulses of fixed amplitude, duration, and frequency without regard to the real-time electrochemical state of the battery being charged. The fast pulse charger 208, by contrast, may dynamically adjust pulse amplitude, duration, and frequency based on real-time electrochemical data received from the BMS controller 204. This dynamic adjustment may allow the fast pulse charger 208 to maintain the faradaic charge transfer process within an electrochemically favorable operating range throughout the charging cycle of the battery module 222.

The dynamic signal conversion unit 206 may supply conditioned electrical energy to the fast pulse charger 208 during faradaic charging operations. The dynamic signal conversion unit 206 may adapt the voltage and current characteristics of the input power supplied to the fast pulse charger 208 to ensure that the charging pulses 282 applied to the battery module 222 may remain within the electrochemical operating limits of the battery module 222. The dynamic signal conversion unit 206 may continuously monitor and adjust these electrical characteristics in real time as the electrochemical state of the battery module 222 changes during the charging cycle.

The inverter 286, as depicted in FIG. 10, may receive electrical energy from the battery module 222 following the completion of a faradaic charging cycle. The inverter 286 may convert the direct current electrical energy stored within the battery module 222 into alternating current electrical energy for delivery to connected loads. The BMS controller 284, as depicted in FIG. 10, may monitor the state of the battery module 222 and may coordinate the operation of the inverter 286 with the faradaic charging operations performed by the fast pulse charger 208 to ensure that charging and discharging operations may not occur simultaneously within the battery module 222.

The faradaic charging process implemented by the fast pulse charger 208 may reduce heat generation within the battery module 222 during charging operations relative to conventional continuous charging strategies. The reduction in heat generation may result from the periodic interruption of ion migration during each rest interval 284, which may allow thermal energy generated at the electrode surfaces of the battery module 222 during each charging pulse 282 to dissipate before the subsequent charging pulse 282 may be applied. This thermal management benefit of the faradaic fast pulse charging methodology may contribute to the extended service life of the battery module 222 relative to battery modules charged using conventional continuous or fixed-parameter pulse charging strategies.

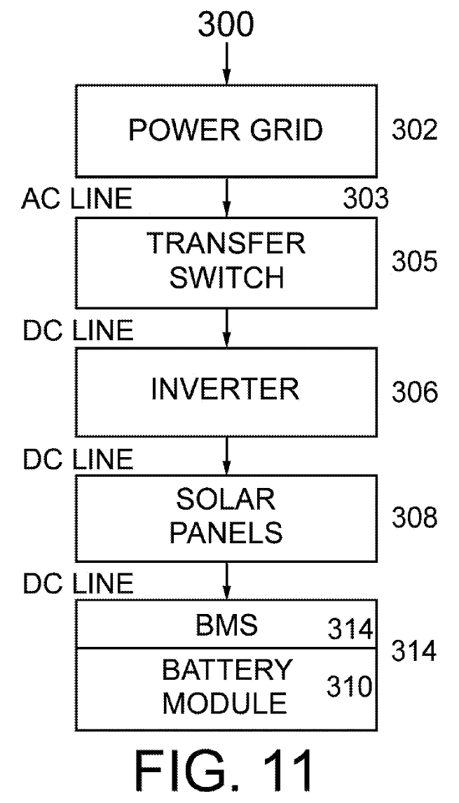

Referring now to FIG. 11, a hybrid DC microgrid system 300 may be described. The hybrid DC microgrid system 300 may include a power grid 302. The power grid 302 may supply alternating current power to the system 300 via an AC line 303. A transfer switch 305 may be coupled to the power grid 302. The transfer switch 305 may manage switching between the power grid 302 and other power sources within the microgrid system 300. An inverter 306 may be coupled to the transfer switch 305 via a DC line. Solar panels 308 may be coupled to the inverter 306 via a DC line. A battery module 310 may be coupled to the solar panels 308 via a DC line. A BMS 314 may be associated with the battery module 310. The BMS 314 may monitor and manage the operating conditions of the battery module 310 within the microgrid system 300. The battery system may coordinate power distribution among the components of the hybrid DC microgrid system 300.

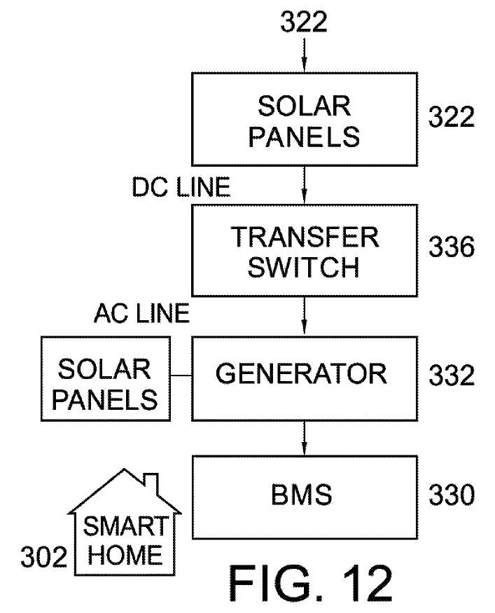

Referring now to FIG. 12, a smart home energy system 320 may be described. The smart home energy system 320 may integrate multiple energy sources for residential energy management. Solar panels 322 may supply power to the system 320 via a DC line. A transfer switch 336 may be coupled to the solar panels 322. A generator 332 may be coupled to the transfer switch 336 via an AC line. A BMS 330 may be coupled to the generator 332. The smart home energy system 320 may also include a smart home 302 that may receive power managed by the BMS 330. The BMS 330 may control energy distribution among the components of the smart home energy system 320. The BMS 330 may optimize energy usage and may maintain power availability to residential loads within the smart home 302.

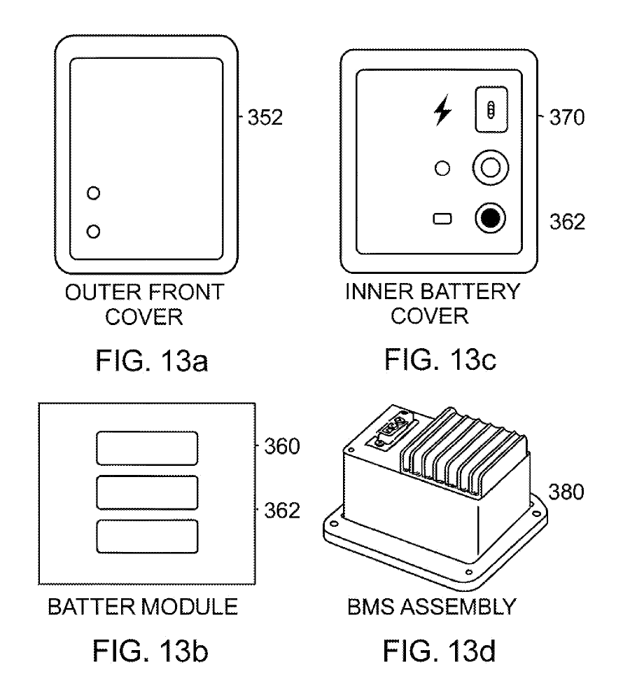

Referring now to FIG. 13, example installed configurations of the battery system may be described. FIG. 13a illustrates a battery system housing 340 that may represent a standalone installation configuration. The battery system housing 340 may include an outer front cover 352. The outer front cover 352 may enclose the internal components of the battery system in a standalone deployment. FIG. 13b illustrates a battery module 360 that may be connected to a residential inverter system 342. The battery module 360 may include a plurality of cell compartments arranged within the module housing. A dimension indicator 362 may be associated with the battery module 360. FIG. 13c illustrates an inner battery cover 370 that may be associated with a battery system connected to a home generator 344. The inner battery cover 370 may include indicators for battery status and charging condition. FIG. 13d illustrates a BMS assembly 380 that may represent a battery pack assembly 346 for modular deployment. The BMS assembly 380 may include a finned housing section that may dissipate heat generated during battery system operation. These configurations may illustrate example installation environments and physical arrangements of the battery management system across residential and modular deployment contexts.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

Referring now to FIG. 8, an energy management system architecture 240 may be described. The architecture 240 may comprise an energy management module 242. The energy management module 242 may coordinate overall system operations and energy dispatch. An external device detection module 244 may be coupled to the energy management module 242. The external device detection module 244 may identify and characterize external devices connected to the battery system. A dynamic signal conversion unit 246 may be coupled to the external device detection module 244. The dynamic signal conversion unit 246 may adapt electrical characteristics to ensure compatibility between system components and connected external devices. An intelligent transfer switch 248 may be coupled to the dynamic signal conversion unit 246. The intelligent transfer switch 248 may control switching between power sources and operating modes.

The energy management module 242 may receive input from the external device detection module 244. The energy management module 242 may also receive input from the dynamic signal conversion unit 246. The energy management module 242 may direct the intelligent transfer switch 248 to route power appropriately based on the received inputs. The external device detection module 244 may automatically detect external devices including solar panels, generators, electric vehicle chargers, grid connections, and additional battery storage units. Upon detection, the external device detection module 244 may forward device power characteristics to the dynamic signal conversion unit 246 for electrical adaptation.

The dynamic signal conversion unit 246 of FIG. 8 may be functionally analogous to the dynamic signal conversion unit 206 of FIG. 6. Both units may adapt electrical characteristics to ensure compatibility between the battery system and connected devices or power sources. The intelligent transfer switch 248 may transition the battery system between grid-connected and off-grid operating modes. The intelligent transfer switch 248 may perform synchronization checks prior to reconnection to the grid to prevent back- feeding or phase mismatch.

Referring now to FIG. 9, a graphical user interface 260 may be described. The graphical user interface 260 may be used to monitor and control the battery system. The graphical user interface 260 may be accessible via a mobile application or a web browser. The graphical user interface 260 may display selectable energy source configurations. A solar power source 262 may be selectable through the graphical user interface 260. An electric vehicle power interface 264 may also be selectable. A utility or grid power source 266 may be selectable. A custom or user-defined configuration 268 may also be selectable through the graphical user interface 260.

The graphical user interface 260 may display real-time metrics including energy flow, battery state-of-charge, system alerts, and charging status. The graphical user interface 260 may enable a user to remotely monitor the battery system. The graphical user interface 260 may also enable a user to remotely configure the battery system. The graphical user interface 260 may transmit configuration inputs from the user to the external platform via the communication network. The external platform may process the configuration inputs and generate corresponding control signals for transmission to the battery system via the IoT module 210.

Referring now to FIG. 10, a pulse charging waveform 280 may be described. The pulse charging waveform 280 may be applied to the battery system during charging operations. The waveform 280 may include alternating intervals of charging pulses 282 and rest intervals 284. The charging pulses 282 may represent active charging intervals during which high-frequency electrical pulses may be applied to the battery module 202. The rest intervals 284 may represent periods during which no charging current may be applied, allowing the battery module 202 to recover electrochemically.

The pulse amplitude of the charging pulses 282 may be dynamically adjusted by the fast pulse charger 208 based on real-time battery conditions. The pulse duration of the charging pulses 282 may also be dynamically adjusted. The frequency of the charging pulses 282 may be dynamically adjusted as well. The dynamic adjustment of pulse amplitude, duration, and frequency may reduce heat generation during charging. The dynamic adjustment may also improve charge acceptance by the battery module 202. The dynamic adjustment may further extend the service life of the battery module 202 compared to conventional constant-current or constant-voltage charging strategies.

Referring now to FIG. 10, a solar microgrid architecture may be described. FIG. 10 depicts a four-block vertical diagram in which four components may be arranged in a sequential top-to-bottom configuration. The four blocks may represent, in order from top to bottom, a solar panel 280, a battery module 222, a BMS 284, and an inverter 286. Each block may be connected to the adjacent block by a directional arrow indicating the flow of energy and control signals through the system. This arrangement may represent a solar microgrid architecture in which each component may perform a distinct function within the overall system.

The solar panel 280 may occupy the topmost position in the four-block vertical diagram. The solar panel 280 may serve as the primary energy generation source within the solar microgrid architecture. The solar panel 280 may convert incident solar irradiance into direct current (DC) electrical energy. The DC electrical energy generated by the solar panel 280 may be directed downward through the system to the battery module 222.

The battery module 222 may occupy the second position in the four-block vertical diagram, directly below the solar panel 280. The battery module 222 may receive DC electrical energy from the solar panel 280. The battery module 222 may store the received electrical energy for subsequent use by downstream components of the solar microgrid architecture. The battery module 222 may also supply stored electrical energy to the BMS 284 positioned directly below it in the diagram.

The BMS 284 may occupy the third position in the four-block vertical diagram, directly below the battery module 222. The BMS 284 may monitor the operating conditions of the battery module 222. The BMS 284 may measure parameters including voltage, current, temperature, and state of charge of the battery module 222. The BMS 284 may generate control signals based on the monitored parameters. The BMS 284 may transmit those control signals to regulate energy flow between the battery module 222 and the inverter 286. The BMS 284 may also protect the battery module 222 from operating conditions that may exceed safe limits, including overvoltage, overcurrent, and thermal excursions.

The inverter 286 may occupy the fourth and lowermost position in the four-block vertical diagram. The inverter 286 may receive DC electrical energy from the battery module 222 as managed by the BMS 284. The inverter 286 may convert the received DC electrical energy into alternating current (AC) electrical energy. The AC electrical energy produced by the inverter 286 may be supplied to connected loads within the solar microgrid. The inverter 286 may also support bidirectional energy flow, enabling the solar microgrid to interface with a utility grid or to operate in an off-grid islanded mode.

The four-block vertical arrangement of FIG. 10 may represent the solar microgrid architecture as a distinct system configuration. In this configuration, the solar panel 280 may function as the energy generation source. The battery module 222 may function as the energy storage element. The BMS 284 may function as the monitoring and control element. The inverter 286 may function as the power conversion element. These four components may operate in functional sequence such that energy generated by the solar panel 280 may be stored in the battery module 222, managed by the BMS 284, and converted for delivery to loads by the inverter 286.

The solar microgrid architecture depicted in FIG. 10 may be deployed in residential, commercial, or industrial settings. The solar panel 280 may be coupled to a photovoltaic array of any suitable capacity. The battery module 222 may comprise one or more electrochemical cells or battery packs configured to store energy at a capacity appropriate for the intended deployment. The BMS 284 may be implemented as a hardware controller with integrated sensors and communication interfaces. The inverter 286 may be implemented as a hybrid inverter capable of supporting both grid-connected and off-grid operating modes.

The functional relationship among the four blocks of FIG. 10 may extend beyond the context of any single charging strategy. The solar microgrid architecture may operate independently of any particular charging methodology. The BMS 284 may coordinate energy dispatch among the solar panel 280, the battery module 222, and the inverter 286 based on real-time system conditions. The BMS 284 may also communicate with an external platform via an IoT module to receive control signals and transmit operational data. The inverter 286 may receive switching commands from the BMS 284 to manage transitions between grid- connected and off-grid operating modes. The solar panel 280 may supply energy to the battery module 222 during periods of solar generation, and the battery module 222 may supply energy to the inverter 286 during periods of low or absent solar generation.

The solar microgrid architecture of FIG. 10 may further support integration with additional energy sources and loads. The inverter 286 may interface with a utility grid connection, enabling the solar microgrid to participate in grid-tied energy exchange. The BMS 284 may implement load prioritization protocols to ensure that designated critical loads may receive uninterrupted power during off-grid operation. The battery module 222 may be configured in a modular arrangement, enabling the energy storage capacity of the solar microgrid to be scaled by adding additional battery modules without modifying the remaining components of the architecture.

Referring now to FIG. 11, a hybrid DC microgrid system 300 may be described. The microgrid system 300 may include a power grid 302. The power grid 302 may supply alternating current power to the system. An AC line 303 may connect the power grid 302 to a transfer switch 305. The transfer switch 305 may control switching between the power grid 302 and other power sources within the microgrid. An inverter 306 may be coupled to the transfer switch 305 via a DC line. The inverter 306 may perform bidirectional conversion between DC and AC power. Solar panels 308 may be coupled to the inverter 306 via a DC line. The solar panels 308 may supply DC power generated from photovoltaic conversion. A battery module 310 may be coupled to the solar panels 308 via a DC line. A BMS 314 may be associated with the battery module 310. The BMS 314 may monitor and manage the operating conditions of the battery module 310 within the microgrid system 300.

The microgrid system 300 may coordinate power distribution among the power grid 302, the solar panels 308, the battery module 310, and connected loads. The transfer switch 305 may transition the microgrid system 300 between grid-connected and off-grid operating modes. The inverter 306 may manage bidirectional energy flow in both grid- connected and off-grid modes. The BMS 314 may interface with the IoT module 210 to transmit operational data to the external platform and receive control signals for execution.

Referring now to FIG. 12, a smart home energy system 320 may be described. The smart home energy system 320 may integrate multiple energy sources for residential energy management. Solar panels 322 may supply DC power to the system. A transfer switch 336 may be coupled to the solar panels 322 via a DC line. The transfer switch 336 may manage switching between power sources within the smart home energy system 320. A generator 332 may be coupled to the transfer switch 336. The generator 332 may supply backup power during grid outages or periods of insufficient renewable generation. A BMS 330 may be coupled to the generator 332. The BMS 330 may monitor and manage the battery energy storage system within the smart home energy system 320. A smart home 302 may be associated with the smart home energy system 320. The smart home 302 may receive power from the battery energy storage system managed by the BMS 330.

The smart home energy system 320 may control energy distribution among the solar panels 322, the generator 332, the battery energy storage system, and residential loads within the smart home 302. The BMS 330 may optimize energy usage and maintain power availability across the smart home energy system 320. The transfer switch 336 may perform mode transitions between grid-connected and off-grid operation. The smart home energy system 320 may communicate with the external platform via the IoT module 210 to enable remote monitoring and control by the end user through the graphical user interface 260.

Referring now to FIG. 12, the smart home energy system 320 may be further described with respect to a second solar panels block that may be depicted in FIG. 12 as distinct from the upper solar panels block 322. The second solar panels block may be assigned reference numeral 334. The second solar panels block 334 may be positioned to the left of the generator 332 within the smart home energy system 320. The second solar panels block 334 may be connected to the generator 332 via an AC line. The AC line may serve as the signal path through which alternating current power generated or conditioned by the second solar panels block 334 may be delivered to the generator 332.

The second solar panels block 334 may represent a photovoltaic generation subsystem that may supply power to the smart home energy system 320 via an alternating current pathway. This AC line connection may be distinct from the DC line connection through which the upper solar panels block 322 may supply power to the transfer switch 336. The AC line associated with the second solar panels block 334 may interface with the generator 332 to provide an additional renewable energy input to the system 320. The generator 332 may receive power from the second solar panels block 334 via the AC line and may coordinate that power input with other energy sources within the smart home energy system 320.

The second solar panels block 334 may represent a separate and independently operable solar energy source within the smart home energy system 320. The second solar panels block 334 may supply alternating current power to the generator 332 independently of the power supplied by the upper solar panels block 322 to the transfer switch 336. The upper solar panels block 322 may supply power via a DC line to the transfer switch 336. The second solar panels block 334 may supply power via the AC line to the generator 332. These two solar input pathways may operate concurrently within the smart home energy system 320.

The AC line connecting the second solar panels block 334 to the generator 332 may carry alternating current power that the generator 332 may receive and process for distribution within the smart home energy system 320. The generator 332 may coordinate the power received from the second solar panels block 334 via the AC line with power received from other sources within the system 320. The BMS 330 may monitor and manage energy distribution from the generator 332, including energy derived from the second solar panels block 334 via the AC line pathway. The BMS 330 may optimize energy dispatch from the generator 332 to the smart home 302 based on the combined inputs available to the system 320, including the AC line input from the second solar panels block 334.

The smart home energy system 320 may thereby integrate multiple renewable energy sources through distinct signal pathways. The upper solar panels block 322 may supply DC power via a DC line to the transfer switch 336. The second solar panels block 334 may supply AC power via the AC line to the generator 332. These two solar input pathways may provide the smart home energy system 320 with multi-source renewable energy integration capability. The BMS 330 may manage energy derived from both solar input pathways and may coordinate power delivery to the smart home 302 based on real-time system conditions. The smart home energy system 320 may communicate with the external platform via the IoT module 210 to enable remote monitoring and control of all energy sources, including the second solar panels block 334 and its associated AC line pathway, through the graphical user interface 260.

Referring now to FIG. 13, example installed configurations of the battery system may be described. FIG. 13a illustrates a battery system housing 340. The battery system housing 340 may represent a standalone installation configuration. The battery system housing 340 may comprise an outer front cover 352. The outer front cover 352 may enclose the internal components of the battery system in a standalone deployment.

FIG. 13b illustrates a battery module 360. The battery module 360 may be connected to a residential inverter system 342. The battery module 360 may include a plurality of cell compartments arranged within the module housing. The battery module 360 may interface with the BMS controller 204 for continuous condition monitoring during operation in conjunction with the residential inverter system 342.

FIG. 13c illustrates an inner battery cover 370. The inner battery cover 370 may be associated with a battery system connected to a home generator 344. The inner battery cover 370 may include indicators and interface elements including a lightning bolt symbol and a battery indicator. The inner battery cover 370 may provide access to internal battery components during maintenance operations.

FIG. 13d illustrates a BMS assembly 380. The BMS assembly 380 may represent a battery pack assembly 346 for modular deployment. The BMS assembly 380 may comprise a housing with a finned upper section. The finned upper section may facilitate thermal management during operation of the battery system. The BMS assembly 380 may be deployed in modular configurations to scale the battery system capacity for residential, commercial, or industrial applications.

The installation configurations illustrated in FIG. 13 may represent example physical deployment environments for the battery management system. Each configuration may be adapted to interface with the IoT module 210, the dynamic signal conversion unit 206, the fast pulse charger 208, and the BMS controller 204 as described with reference to FIG. 6. Each configuration may also communicate with the external platform via the communication network to enable remote monitoring and control through the graphical user interface 260 as described with reference to FIG. 9.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

FIG. 6 illustrates a block diagram 200 depicting the operating environment of the core battery management system hardware architecture. In this environment, a battery module (202) may serve as the primary energy storage component and may comprise one or more battery cells or battery packs equipped with integrated sensing elements for monitoring cell-level voltage, current, and temperature. A BMS controller (204) may be communicatively and electrically coupled to the battery module (202) and may receive sensor signals from the battery module (202) to compute battery state estimates, enforce safety limits, and generate control outputs. The BMS controller (204) may be coupled to a dynamic signal conversion unit (206), which may perform voltage conversion, current regulation, and waveform adaptation to ensure compatibility between the battery module (202) and external power sources or loads. The BMS controller (204) may also be coupled to a fast pulse charger (208), which may apply high-frequency electrical pulses with adjustable amplitude, duration, and frequency to the battery module (202) under the direction of the BMS controller (204). An IoT module (210) may be coupled to the BMS controller (204) and may provide bidirectional communication between the battery system and an external platform, transmitting telemetry data and receiving control commands via one or more wireless or wired communication protocols. This hardware architecture may form the foundational operating environment upon which the higher-level functions described in FIGS. 1 through 5 may be implemented.

Referring now to FIG. 6, the signal path between the BMS controller 204 and the battery module 202 may be further described with respect to the directional label depicted along the arrow connecting those two blocks within the battery management system architecture 200. As shown in FIG. 6, a downward-pointing arrow may extend from the bottom edge of the BMS controller block 204 to the top edge of the battery module block 202. Along the right side of this arrow, in proximity to the arrow shaft, the label "PARAMETRRS" may be printed in small text. This label may be assigned reference numeral 212 for purposes of this disclosure. The signal path 212 may represent the communication pathway through which the BMS controller 204 may transmit parameter-related signals to the battery module 202.

The signal path 212 may carry parameter signals from the BMS controller 204 to the battery module 202. The parameter signals transmitted along the signal path 212 may include operating setpoints, charge control commands, discharge rate instructions, and protective action directives generated by the BMS controller 204 based on real-time battery condition data. The direction of the signal path 212 as depicted in FIG. 6 may indicate that the BMS controller 204 may serve as the originating source of the parameter signals conveyed along that pathway. The battery module 202 may receive the parameter signals transmitted along the signal path 212 and may respond to those signals by adjusting its operating state in accordance with the commands encoded therein.

The signal path 212 may be understood as a distinct labeled element of the battery management system architecture 200. The signal path 212 may be separate and distinguishable from the data pathways through which the BMS controller 204 may receive sensor data from the battery module 202. The BMS controller 204 may receive sensor data from the battery module 202 via a separate upstream data pathway. The signal path 212 may represent the downstream command pathway through which the BMS controller 204 may communicate parameter signals back to the battery module 202 following processing of the received sensor data.

The parameter signals conveyed along the signal path 212 may include voltage regulation parameters. The parameter signals may also include current limit parameters. The parameter signals may further include temperature-based operating constraints generated by the BMS controller 204 in response to thermal sensor data received from the battery module 202. The BMS controller 204 may dynamically update the parameter signals transmitted along the signal path 212 as real-time battery conditions change. The battery module 202 may implement the updated parameter signals received via the signal path 212 to maintain operation within safe and efficient limits as determined by the BMS controller 204.

The signal path 212 may be implemented as a wired electrical connection between the BMS controller 204 and the battery module 202. The signal path 212 may alternatively be implemented as a communication bus, such as a Controller Area Network (CAN) bus or a Modbus interface, through which parameter data may be transmitted in a structured digital format. The signal path 212 may support bidirectional communication in certain embodiments, enabling the battery module 202 to transmit acknowledgment signals or status responses back to the BMS controller 204 via the same physical pathway. In embodiments where the signal path 212 may support bidirectional communication, the primary direction of parameter signal flow may remain from the BMS controller 204 to the battery module 202, consistent with the directional arrow depicted in FIG. 6.

The label "PARAMETRRS" associated with the signal path 212 in FIG. 6 may functionally identify the nature of the signals conveyed along that pathway as parameter signals. The label may distinguish the signal path 212 from other signal pathways within the battery management system architecture 200, including the command pathways through which the BMS controller 204 may communicate with the dynamic signal conversion unit 206 and the fast pulse charger 208. The signal path 212 may thereby constitute a dedicated communication channel within the architecture 200 through which the BMS controller 204 may exercise parameter-level control over the operating conditions of the battery module 202.

FIG. 7 illustrates a block diagram 220 depicting the operating environment of the secure mesh network architecture. In this environment, a first mesh node (222) may be communicatively coupled to a second mesh node (224), forming a peer-to-peer communication link within a mesh topology. Each mesh node may represent a battery system installation or a dedicated network relay device. An encryption and comparison block (226) may be coupled to the mesh nodes and may perform cryptographic operations on data transmitted between nodes, including message encryption, decryption, and integrity verification. A processing block may be coupled to the encryption and comparison block (226) and may include an encryption module (228) and an anomaly detection module (230). The encryption module (228) may implement industry-standard encryption protocols, which may include AES-b for data at rest and TLS for data in transit, to secure communications between mesh nodes and between the mesh network and cloud-based services. The anomaly detection module (230) may monitor network traffic patterns for deviations indicative of unauthorized access attempts, denial-of-service (DoS) attacks, or other cybersecurity threats, and may trigger protective responses including node isolation, traffic rate limiting, and administrator alerts. The mesh network may further support cloud synchronization, enabling selected operational data from the mesh nodes to be aggregated and stored on a remote cloud platform for fleet-level monitoring and analysis. This operating environment may provide a resilient, self-healing communication infrastructure that may maintain data integrity and system control even when individual nodes may be compromised or may experience connectivity disruptions.

FIG. 8 illustrates a block diagram 240 depicting the operating environment of the energy management and device integration architecture. In this environment, an energy management module (242) may serve as the central coordination element and may be communicatively coupled to an external device detection module (244). The external device detection module (244) may identify and characterize devices connected to the battery system, including solar PV panels, wind turbines, electric vehicles, generators, and additional battery packs, by measuring their electrical characteristics and, where available, reading device identification data. The external device detection module (244) may be coupled to a dynamic signal conversion unit (246), which may receive device characterization data and may adjust its conversion parameters to establish a compatible electrical interface between the battery system and each detected external device. The dynamic signal conversion unit (246) may be coupled to an intelligent transfer switch (248), which may route power between the battery system, the external devices, and the load circuits based on commands from the energy management module (242). The intelligent transfer switch (248) may execute mode transitions between grid-connected and off-grid operation, may enforce load prioritization during off-grid conditions, and may perform synchronization checks prior to grid reconnection. This operating environment may support simultaneous connection to multiple power sources and may prioritize renewable energy inputs when available.

FIG. 9 illustrates a front view of a user interface device and display (260) depicting the operating environment of the system's human-machine interface (HMI). The display (260) may present selectable regions corresponding to energy source modes, including a SOLAR region (262), an EV region (264), a SUPPLY region (266), and a CUSTOM region (268). A user may interact with the display (260) to select a preferred energy source or operating mode, and the selection may be communicated to the BMS controller and energy management module to update the system's source prioritization and power routing configuration. In addition to source selection, the display (260) may present real-time operational data including battery voltage, current, SOC percentage, a bar-graph charge level indicator, delta voltage, average voltage, metal-oxide-semiconductor (MOS) temperature, ambient temperature, alarm status, balance status, charge status, and discharge status. This operating environment may serve both on-site users and maintenance technicians who may require immediate access to system status without relying on a remote mobile or web application.

Referring now to FIG. 9, the display (260) may present the CUSTOM region (268) as a selectable operating mode within the user interface. The CUSTOM region (268) may allow a user to define a user-specified energy source configuration or power routing arrangement that may differ from the predefined SOLAR region (262), EV region (264), and SUPPLY region (266) configurations. At the bottom center of the CUSTOM region (268), a mode selection control element (270) may be disposed along the lower interior border of the CUSTOM region (268). The mode selection control element (270) may appear as a small horizontal rectangle containing a downward-pointing triangular shape. The mode selection control element (270) may function as an interactive control feature of the display (260). The mode selection control element (270) may be configured to receive a user input, such as a touch or press gesture directed at the display (260). Upon receiving such a user input, the mode selection control element (270) may expand or reveal a dropdown menu or a set of selectable sub-options associated with the CUSTOM region (268). The dropdown menu or sub-options revealed by the mode selection control element (270) may include user- configurable parameters such as source prioritization sequences, power routing assignments, charge scheduling preferences, or other user-defined operational settings. The downward-pointing triangular shape within the mode selection control element (270) may serve as a visual indicator to a user that additional selectable options may be accessible beneath or below the current display state of the CUSTOM region (268). The mode selection control element (270) may communicate a user selection to the BMS controller (204) and the energy management module (242). The BMS controller (204) and the energy management module (242) may update the system's source prioritization and power routing configuration in accordance with the user selection received through the mode selection control element (270). The mode selection control element (270) may thereby provide an interactive mechanism through which a user may access and configure custom operating parameters directly from the display (260) without requiring access to a remote mobile or web application.

FIG. 10 illustrates a block diagram (280) depicting the operating environment of the faradaic fast pulse charging process and a representative solar-to-battery integration architecture. A solar panel (280) may be coupled to a battery module (282), which may be coupled to a BMS (284), which may in turn be coupled to an inverter (286). In this operating environment, DC power generated by the solar panel (280) may be delivered to the battery module (282) for storage, with the BMS (284) governing the charge process. The BMS (284) may implement fast pulse charging by applying high-frequency electrical pulses to the battery module (282), with each pulse followed by a rest interval during which the electrochemical state of the battery cells may be assessed. The left-hand portion of the diagram may depict the charge transfer phase, wherein ions represented by positive and negative charge symbols may migrate toward an electrode boundary under the influence of an applied electrical pulse. The right-hand portion may depict the charge storage phase, wherein accumulated charge symbols at the electrode surface may represent stored electrochemical energy resulting from the faradaic charging process. The inverter (286) may convert DC power from the battery module (282) to AC power for delivery to AC loads or for grid export. This operating environment may illustrate the electrochemical basis of fast pulse charging as implemented within the broader solar-powered battery system architecture.

Referring now to FIG. 10, the electrochemical mechanism underlying faradaic fast pulse charging may be further described with respect to the ion migration symbols and electrode charge accumulation symbols depicted in the left and right portions of the diagram. As introduced above, FIG. 10 depicts a four-block vertical diagram in which a solar panel 280, a battery module 222, a BMS 284, and an inverter 286 may be arranged in a sequential top- to-bottom configuration. In addition to this vertical block arrangement, FIG. 10 may include visual representations of electrochemical processes that may occur within the battery module 222 during faradaic fast pulse charging operations. These visual representations may be disposed in the left and right portions of the diagram and may depict two distinct phases of the faradaic charging process.

The left portion of FIG. 10 may depict a charge transfer phase representation 290. The charge transfer phase representation 290 may include a plurality of ion migration symbols 292. The ion migration symbols 292 may appear as positive charge symbols and negative charge symbols arranged in proximity to a depicted electrode boundary. The ion migration symbols 292 may represent the directional movement of ionic species within the electrolyte of the battery module 222 during the application of a charging pulse by the fast pulse charger 208. During the charge transfer phase, an applied electrical pulse may establish a transient electric field across the electrode-electrolyte interface. The ion migration symbols 292 may represent the migration of cations and anions toward their respective electrode surfaces under the influence of this transient electric field. The directional orientation of the ion migration symbols 292 may indicate the polarity of the applied pulse and the resulting direction of ionic flux within the electrolyte. The charge transfer phase representation 290 may thereby depict the faradaic mechanism by which electrical energy may be converted into electrochemical energy through the migration of ionic species toward electrode surfaces during each active charging pulse interval 282.

The right portion of FIG. 10 may depict a charge storage phase representation 294. The charge storage phase representation 294 may include a plurality of electrode charge accumulation symbols 296. The electrode charge accumulation symbols 296 may appear as charge symbols concentrated at or near the depicted electrode surface. The electrode charge accumulation symbols 296 may represent the accumulation of electrochemical charge at the electrode surface following the completion of a charge transfer event. During the charge storage phase, the ionic species that migrated toward the electrode surface during the charge transfer phase may undergo faradaic electrochemical reactions at the electrode-electrolyte interface. The electrode charge accumulation symbols 296 may represent the stored electrochemical energy that may result from these faradaic reactions. The concentration of the electrode charge accumulation symbols 296 at the electrode surface may indicate that charge storage may occur as a surface-localized electrochemical phenomenon during faradaic fast pulse charging. The charge storage phase representation 294 may thereby depict the mechanism by which electrochemical energy may be retained at the electrode surface during the rest interval 284 that follows each active charging pulse 282.

The ion migration symbols 292 depicted in the left portion of FIG. 10 and the electrode charge accumulation symbols 296 depicted in the right portion of FIG. 10 may together represent the two-phase electrochemical cycle that may characterize faradaic fast pulse charging as implemented by the fast pulse charger 208. In the first phase, represented by the ion migration symbols 292, the application of a high-frequency electrical pulse by the fast pulse charger 208 may drive ionic migration toward the electrode surface, initiating a faradaic charge transfer reaction. In the second phase, represented by the electrode charge accumulation symbols 296, the charge transferred during the active pulse interval 282 may accumulate at the electrode surface and may be retained during the subsequent rest interval 284. The BMS 284 may monitor the electrochemical state of the battery module 222 during the rest interval 284 to assess the extent of charge accumulation at the electrode surface before initiating the next charging pulse 282.

The two-phase electrochemical cycle represented by the ion migration symbols 292 and the electrode charge accumulation symbols 296 may distinguish faradaic fast pulse charging from conventional continuous charging approaches. In conventional constant- current or constant-voltage charging, ionic species may be driven continuously toward electrode surfaces without intervening rest intervals. This continuous ionic flux may result in concentration polarization at the electrode-electrolyte interface, which may impede further charge transfer and may generate thermal energy as a byproduct of resistive losses within the electrolyte. The ion migration symbols 292 depicted in the left portion of FIG. 10 may represent the controlled, pulse-driven ionic migration that may occur during each discrete active charging interval 282. The electrode charge accumulation symbols 296 depicted in the right portion of FIG. 10 may represent the electrochemical charge that may accumulate at the electrode surface as a result of each discrete faradaic charge transfer event. The alternating application of active charging pulses 282 and rest intervals 284, as represented by the waveform 280 and the electrochemical symbols 292 and 296 of FIG. 10, may allow concentration gradients at the electrode-electrolyte interface to dissipate during each rest interval 284. This dissipation of concentration gradients may reduce the electrochemical impedance of the battery module 222 during subsequent charging pulses 282, which may improve charge acceptance and may reduce heat generation during charging operations.

The fast pulse charger 208 may dynamically adjust the amplitude, duration, and frequency of the charging pulses 282 based on real-time battery condition data received from the BMS 284. The BMS 284 may assess the degree of charge accumulation at the electrode surface, as represented by the electrode charge accumulation symbols 296, during each rest interval 284. The BMS 284 may transmit this assessment to the fast pulse charger 208 via the signal path 212. The fast pulse charger 208 may use this assessment to modulate the parameters of the subsequent charging pulse 282 to optimize the rate of ionic migration, as represented by the ion migration symbols 292, while maintaining the electrode charge accumulation, as represented by the electrode charge accumulation symbols 296, within safe electrochemical limits. This dynamic parameter adjustment may extend the service life of the battery module 222 by preventing electrode degradation that may otherwise result from excessive ionic flux or charge accumulation at electrode surfaces during high-rate charging operations.

The charge transfer phase representation 290 and the charge storage phase representation 294 depicted in FIG. 10 may together provide a visual basis for understanding the electrochemical mechanism by which faradaic fast pulse charging may achieve improved charging performance relative to conventional charging strategies. The ion migration symbols 292 may represent the electrochemical basis of the charge transfer function performed by the fast pulse charger 208 during each active pulse interval 282. The electrode charge accumulation symbols 296 may represent the electrochemical basis of the charge storage function that may occur at the electrode surface during each rest interval 284. The BMS 284 may coordinate the timing and parameters of these two phases by monitoring the battery module 222 and issuing control signals to the fast pulse charger 208 via the signal path 212. The inverter 286 may receive DC power from the battery module 222 as managed by the BMS 284 and may convert that power for delivery to connected loads following the completion of a faradaic fast pulse charging cycle.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

FIG. 11 illustrates a block diagram depicting the operating environment of a hybrid DC microgrid incorporating both DC and AC inputs and outputs. In this environment, a power grid (302) may supply AC power via an AC line (303) to a transfer switch (305). The transfer switch (305) may be coupled via a DC line to an inverter (306), which may perform bidirectional AC-DC and DC-AC conversion to interface the DC microgrid bus with AC loads and the AC grid. The inverter (306) may be coupled via a DC line to solar panels (308), which may supply DC power directly to the microgrid bus. The inverter (306) may also be coupled via a DC line to a combined BMS (314) and battery module (310), which may store energy from the solar panels (308) or the grid (302) and may discharge stored energy to support DC loads or to supply the inverter (306) during periods of low generation or grid unavailability. The transfer switch (305) may manage the transition between grid-connected and off-grid operation, isolating the microgrid from the utility grid when instability may be detected and reconnecting when stable grid conditions may be restored. This operating environment may illustrate how the battery system may function as the central energy storage and dispatch element within a hybrid microgrid that may accommodate multiple generation sources and both AC and DC load types.

FIG. 11 illustrates a block diagram depicting the operating environment of a hybrid DC microgrid system (300). In this environment, a power grid (302) may supply AC power via an AC line (303) to a transfer switch (305). The transfer switch (305) may comprise a solid-state switching element configured to interface the utility grid (302) with the DC microgrid bus. The transfer switch (305) may be coupled via a DC line to an inverter (306). The inverter (306) may perform bidirectional AC-to-DC and DC-to-AC power conversion to interface the DC microgrid bus with AC loads and the AC power grid (302). The inverter (306) may be coupled via a DC line to solar panels (308). The solar panels (308) may supply DC power directly to the microgrid bus. The inverter (306) may also be coupled via a DC line to a combined BMS (314) and battery module (310). The battery module (310) may store energy received from the solar panels (308) or from the power grid (302). The battery module (310) may discharge stored energy to support DC loads or to supply the inverter (306) during periods of reduced solar generation or grid unavailability. The BMS (314) may govern the charge and discharge operations of the battery module (310) and may communicate operational data to the broader system.

The transfer switch (305) may serve as the interface element between the AC power grid (302) and the DC microgrid architecture. The transfer switch (305) may receive AC power from the power grid (302) via the AC line (303) and may route that power to the inverter (306) via a DC line when operating in a grid-connected mode. The transfer switch (305) may monitor grid conditions and may detect grid instability events, which may include voltage sags, voltage swells, frequency deviations, or complete grid failure. Upon detecting grid instability, the transfer switch (305) may isolate the DC microgrid from the utility grid (302) by interrupting the AC line (303) connection, thereby transitioning the microgrid to an off-grid operating mode. In the off-grid operating mode, the battery module (310) and solar panels (308) may supply power to the microgrid bus independently of the power grid (302). When stable grid conditions may be restored, the transfer switch (305) may perform synchronization checks prior to reconnecting the microgrid to the power grid (302). The synchronization checks may prevent back-feeding and phase mismatch events that may otherwise occur during reconnection. Upon successful synchronization, the transfer switch (305) may restore the AC line (303) connection and may return the microgrid to grid- connected operation.

The transfer switch (305) may thus function as the boundary element between the AC domain of the power grid (302) and the DC domain of the microgrid bus. The transfer switch (305) may coordinate with the inverter (306) to manage bidirectional energy flow across this boundary. The transfer switch (305) may also coordinate with the BMS (314) to ensure that the battery module (310) may be appropriately charged or discharged in response to changes in grid availability. The transfer switch (305) may further coordinate with the solar panels (308) by enabling the microgrid to continue receiving DC generation from the solar panels (308) during off-grid operation, independent of the grid connection status. In this manner, the transfer switch (305) may enable the hybrid DC microgrid to operate continuously across both grid-connected and off-grid conditions while accommodating multiple generation sources and both AC and DC load types.

Referring now to FIG. 11, the hybrid DC microgrid system 300 may be further described with respect to the labeled signal paths depicted along the connecting arrows between the component blocks of the system 300. As shown in FIG. 11, the connecting arrows between the blocks of the microgrid system 300 may carry labels identifying the electrical nature of each signal path. These labels may appear as either "AC LINE" or "DC LINE" along the respective arrows, and each label may designate a distinct type of power pathway within the power conversion architecture of the hybrid DC microgrid system 300.

The AC line 303 may designate the signal path through which alternating current power may be conveyed from the power grid 302 to the transfer switch 305. The AC line 303 may appear along the connecting arrow between the power grid 302 and the transfer switch 305 in FIG. 11. The AC line 303 may carry alternating current power supplied by the power grid 302 to the transfer switch 305 for distribution within the microgrid system 300. The AC line 303 may represent the point of interface between the utility grid and the internal architecture of the hybrid DC microgrid system 300. The transfer switch 305 may receive alternating current power via the AC line 303 and may manage the routing of that power within the system 300 based on prevailing grid conditions and operating mode.

The DC line designations may appear along each of the connecting arrows that extend below the transfer switch 305 within the block diagram of FIG. 11. A DC line may connect the transfer switch 305 to the inverter 306. A DC line may also connect the inverter 306 to the solar panels 308. A further DC line may connect the solar panels 308 to the battery module 310 and the BMS 314. Each DC line designation may indicate that the signal path so labeled may carry direct current power between the respective components. The DC line connecting the transfer switch 305 to the inverter 306 may carry direct current power that the inverter 306 may receive for bidirectional AC-DC and DC-AC conversion operations. The DC line connecting the inverter 306 to the solar panels 308 may carry direct current power generated by the solar panels 308 for delivery to the inverter 306 and to the DC microgrid bus. The DC line connecting the solar panels 308 to the battery module 310 may carry direct current power for storage within the battery module 310 under the management of the BMS 314.

The AC LINE and DC LINE labels depicted in FIG. 11 may thereby serve as functional designators that distinguish the alternating current input pathway from the direct current distribution pathways within the hybrid DC microgrid system 300. The AC line 303 may represent the boundary at which alternating current power from the power grid 302 may enter the microgrid system 300. The DC lines may represent the internal power distribution network through which direct current power may flow among the inverter 306, the solar panels 308, the battery module 310, and the BMS 314. The inverter 306 may perform the conversion function that bridges the AC line 303 pathway and the DC line pathways within the system 300. The transfer switch 305 may manage the transition between the AC line 303 input from the power grid 302 and the DC line distribution network of the microgrid system 300 during mode transitions between grid-connected and off-grid operation.

The hybrid DC microgrid system 300 may thereby integrate both AC and DC power pathways within a single coordinated architecture. The AC line 303 may provide the grid-sourced alternating current input to the system 300. The DC lines may provide the internal direct current distribution network through which solar-generated power and battery-stored power may be routed among the components of the microgrid system 300. The BMS 314 may monitor and manage the battery module 310 as the central energy storage element within the DC line network of the hybrid DC microgrid system 300. The IoT module 210 may interface with the BMS 314 to transmit operational data from the hybrid DC microgrid system 300 to the external platform and to receive control signals for execution within the system 300.

Referring now to FIG. 11, the hybrid DC microgrid system 300 may be further described with respect to the functional roles of each component within the hybrid microgrid topology and the manner in which those components may interact across the AC and DC bus architecture of the system 300.

The transfer switch 305 may serve as the boundary element between the AC domain supplied by the power grid 302 and the DC bus of the microgrid system 300. The transfer switch 305 may receive alternating current power from the power grid 302 via the AC line 303. The transfer switch 305 may coordinate transitions between the power grid 302 and the other power sources within the microgrid system 300. Upon detecting grid instability, which may include voltage sags, voltage swells, frequency deviations, or complete grid failure events, the transfer switch 305 may interrupt the AC line 303 connection. This interruption may isolate the DC bus of the microgrid system 300 from the power grid 302 and may transition the system 300 to an off-grid operating mode. When stable grid conditions may be restored, the transfer switch 305 may perform synchronization checks prior to reconnecting the AC line 303 to the power grid 302. The synchronization checks performed by the transfer switch 305 may prevent back-feeding and phase mismatch events that may otherwise occur during reconnection. Upon successful synchronization, the transfer switch 305 may restore the AC line 303 connection and may return the microgrid system 300 to grid-connected operation.

The inverter 306 may be coupled to the transfer switch 305 via a DC line. The inverter 306 may function as a bidirectional power conversion element within the hybrid DC microgrid system 300. The inverter 306 may perform AC-to-DC conversion when power flows from the power grid 302 through the transfer switch 305 into the DC bus of the microgrid system 300. The inverter 306 may also perform DC-to-AC conversion when power flows from the DC bus to AC loads connected to the system 300. This bidirectional conversion capability of the inverter 306 may enable power flow in both directions between the AC bus associated with the power grid 302 and the DC bus through which the solar panels 308 and the battery module 310 may operate. The inverter 306 may receive switching commands from the transfer switch 305 and may coordinate with the BMS 314 to manage energy dispatch across the DC bus during both grid-connected and off-grid operating modes. In grid- connected operation, the inverter 306 may support energy export from the battery module 310 to the power grid 302 via the AC line 303. In off-grid operation, the inverter 306 may convert DC power drawn from the battery module 310 into AC power for delivery to AC loads connected to the microgrid system 300.

The solar panels 308 may be coupled to the inverter 306 via a DC line. The solar panels 308 may supply direct current power generated through photovoltaic conversion to the DC bus of the microgrid system 300. The DC power supplied by the solar panels 308 may be delivered to the inverter 306 for conversion and distribution to connected loads. The DC power supplied by the solar panels 308 may also be directed to the battery module 310 for storage under the management of the BMS 314. The solar panels 308 may supply DC power to the DC bus independently of the grid connection status of the microgrid system 300. During off-grid operation, the solar panels 308 may continue to supply DC power to the DC bus through the inverter 306 and to the battery module 310 via the DC line connecting those components within the system 300.

The battery module 310 may be coupled to the solar panels 308 via a DC line within the hybrid DC microgrid system 300. The battery module 310 may store electrical energy received from the solar panels 308 during periods of solar generation. The battery module 310 may also store electrical energy received from the power grid 302 via the inverter 306 and the transfer switch 305 during grid-connected operation. The battery module 310 may discharge stored electrical energy to the DC bus to supply the inverter 306 during periods of reduced solar generation or grid unavailability. The battery module 310 may thereby function as the central energy storage element of the DC bus architecture within the hybrid DC microgrid system 300.

The BMS 314 may be associated with the battery module 310 within the hybrid DC microgrid system 300. The BMS 314 may monitor the operating conditions of the battery module 310, including voltage, current, temperature, and state of charge. The BMS 314 may govern the charge and discharge operations of the battery module 310 based on the monitored operating conditions. The BMS 314 may generate control signals directing the charge and discharge behavior of the battery module 310 in response to real-time system conditions within the microgrid system 300. The BMS 314 may coordinate with the inverter 306 to manage bidirectional energy flow across the DC bus during both grid-connected and off-grid operating modes. The BMS 314 may also interface with the IoT module 210 to transmit operational data from the hybrid DC microgrid system 300 to the external platform and to receive control signals for execution within the system 300.

The hybrid DC microgrid system 300 may thereby integrate both AC and DC power pathways within a single coordinated architecture. The AC line 303 may provide the grid-sourced alternating current input to the system 300 via the transfer switch 305. The DC lines may provide the internal direct current distribution network through which solar- generated power from the solar panels 308 and battery-stored power from the battery module 310 may be routed among the components of the microgrid system 300. The inverter 306 may bridge the AC bus associated with the power grid 302 and the DC bus through which the solar panels 308 and the battery module 310 may operate. The transfer switch 305 may coordinate transitions between the AC line 303 input from the power grid 302 and the DC bus distribution network of the microgrid system 300 during mode transitions between grid-connected and off-grid operation. The BMS 314 may monitor and manage the battery module 310 as the central energy storage element within the DC bus network of the hybrid DC microgrid system 300. The combined BMS 314 and battery module 310 may interface with both AC loads, through the inverter 306 and the AC line 303, and DC loads, through the DC bus of the microgrid system 300, thereby enabling the hybrid DC microgrid system 300 to accommodate multiple generation sources and both AC and DC load types within a single unified architecture.

The hybrid DC microgrid system 300 may be deployed in residential, commercial, or industrial settings where continuous power availability from multiple generation sources may be required. The solar panels 308 may be coupled to a photovoltaic array of any suitable capacity for the intended deployment. The battery module 310 may comprise one or more electrochemical cells or battery packs configured to store energy at a capacity appropriate for the scale of the microgrid system 300. The BMS 314 may be implemented as a hardware controller with integrated sensors and communication interfaces configured to monitor and manage the battery module 310 within the hybrid DC microgrid system 300. The inverter 306 may be implemented as a hybrid inverter capable of supporting both grid-connected and off-grid operating modes within the microgrid system 300. The transfer switch 305 may be implemented as a solid-state switching element configured to perform mode transitions between grid-connected and off-grid operation within milliseconds of detecting grid instability via the AC line 303.

The hybrid DC microgrid system 300 may further support integration with additional energy sources and loads beyond those depicted in FIG. 11. The DC bus of the microgrid system 300 may accommodate additional DC generation sources coupled to the DC line network of the system 300. The inverter 306 may interface with additional AC load circuits connected to the AC bus of the microgrid system 300. The BMS 314 may implement load prioritization protocols to ensure that designated critical loads may receive uninterrupted power during off-grid operation of the microgrid system 300. The battery module 310 may be configured in a modular arrangement, enabling the energy storage capacity of the hybrid DC microgrid system 300 to be scaled by adding additional battery modules without modifying the remaining components of the architecture. The IoT module 210 may interface with the BMS 314 to enable remote monitoring and control of the hybrid DC microgrid system 300 through the graphical user interface 260 as described with reference to FIG. 9.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

FIG. 12 illustrates a block diagram depicting the operating environment of the battery management system integrated into a broader smart home or remote energy environment. In this environment, solar panels (322) may be coupled via a DC line to a transfer switch (336), which may coordinate power routing among the solar panels (322), a generator (332), and a BMS (330). The generator (332) may supply AC power as a backup or supplementary source, and may be coupled to the transfer switch (336) via an AC line. The BMS (330) may manage energy storage and dispatch within this multi-source environment, receiving charge input from the solar panels (322) and the generator (332) and supplying power to a smart home load (302) as directed by the transfer switch (336) and the energy management algorithms. Additional solar panels may be coupled to the generator (332) via an AC line, providing a further renewable input pathway. A wireless network may enable remote monitoring and control of the system via a smartphone or personal computer, allowing a user to observe real-time energy flows, configure source priorities, and receive alerts regarding system status or grid conditions. This operating environment may represent a typical beyond-the-meter deployment in a residential or remote setting where multiple energy sources may be coordinated to maximize renewable utilization and ensure continuous power availability.

Referring now to FIG. 12, the smart home energy system 320 may be further described with respect to the wireless remote monitoring pathway that may be depicted as a distinct functional element of the architecture. As shown in FIG. 12, the smart home energy system 320 may comprise the solar panels 322, the generator 332, the BMS 330, the transfer switch 336, and a smart home load 302. The smart home energy system 320 may further comprise a wireless remote monitoring pathway 338. The wireless remote monitoring pathway 338 may be communicatively coupled to the BMS 330. The wireless remote monitoring pathway 338 may enable remote access to the smart home energy system 320 via a smartphone or a personal computer.

The solar panels 322 may supply direct current power to the smart home energy system 320. The solar panels 322 may be coupled to the transfer switch 336 via a DC line. The transfer switch 336 may receive direct current power from the solar panels 322 via the DC line. The transfer switch 336 may also receive alternating current power from the generator 332 via an AC line. The transfer switch 336 may coordinate power routing among the solar panels 322, the generator 332, and the BMS 330 within the smart home energy system 320.

The transfer switch 336 may serve as the coordinating element for managing transitions among the multiple energy sources of the smart home energy system 320. The transfer switch 336 may monitor the availability of power from the solar panels 322. The transfer switch 336 may also monitor the availability of power from the generator 332. Upon detecting a reduction or interruption in power from the solar panels 322, the transfer switch 336 may transition power routing to the generator 332. Upon detecting a restoration of solar power from the solar panels 322, the transfer switch 336 may transition power routing back to the solar panels 322. The transfer switch 336 may perform these mode transitions without interrupting power delivery to the smart home load 302. The transfer switch 336 may also perform synchronization checks prior to transitioning between energy sources to prevent phase mismatch or power quality disturbances within the smart home energy system 320.

Referring now to FIG. 8, the intelligent transfer switch 248 may be further described with respect to the synchronization checks that the intelligent transfer switch 248 may perform prior to reconnecting the local microgrid to the utility grid. As introduced above in the description of the energy management system architecture 240, the intelligent transfer switch 248 may be coupled to the dynamic signal conversion unit 246 and may receive mode-transition commands from the energy management module 242. The intelligent transfer switch 248 may transition the battery system between a grid-connected mode and an off-grid mode. Upon detection of restored grid stability, the intelligent transfer switch 248 may initiate a synchronization check sequence before restoring the grid connection. The synchronization check sequence may evaluate a plurality of electrical parameters of the local microgrid relative to corresponding parameters of the utility grid. The intelligent transfer switch 248 may withhold reconnection until each evaluated parameter may satisfy a predefined synchronization condition.

The synchronization check sequence performed by the intelligent transfer switch 248 may also evaluate frequency as a second synchronization parameter. The intelligent transfer switch 248 may measure the frequency of the alternating current waveform present on the local microgrid bus. The intelligent transfer switch 248 may also measure the frequency of the alternating current waveform present on the utility grid side of the switch. The intelligent transfer switch 248 may compare the local microgrid frequency to the utility grid frequency. A frequency deviation that may exceed a predefined frequency tolerance may cause the intelligent transfer switch 248 to withhold reconnection. The intelligent transfer switch 248 may continue to monitor frequency on both sides of the switch until the deviation may fall within the predefined frequency tolerance. When the frequency of the local microgrid bus may match the frequency of the utility grid within the predefined frequency tolerance, the intelligent transfer switch 248 may determine that the frequency synchronization condition may be satisfied.

The synchronization check sequence performed by the intelligent transfer switch 248 may further evaluate phase angle as a third synchronization parameter. The intelligent transfer switch 248 may measure the instantaneous phase angle of the alternating current waveform present on the local microgrid bus. The intelligent transfer switch 248 may also measure the instantaneous phase angle of the alternating current waveform present on the utility grid side of the switch. The intelligent transfer switch 248 may compare the local microgrid frequency to the utility grid frequency. A frequency deviation that may exceed a predefined frequency tolerance may cause the intelligent transfer switch 248 to withhold reconnection. The intelligent transfer switch 248 may continue to monitor frequency on both sides of the switch until the deviation may fall within the predefined frequency tolerance. When the frequency of the local microgrid bus may match the frequency of the utility grid within the predefined frequency tolerance, the intelligent transfer switch 248 may determine that the frequency synchronization condition may be satisfied.

The synchronization check sequence performed by the intelligent transfer switch 248 may further evaluate phase angle as a third synchronization parameter. The intelligent transfer switch 248 may measure the instantaneous phase angle of the alternating current waveform present on the local microgrid bus. The intelligent transfer switch 248 may also measure the instantaneous phase angle of the alternating current waveform present on the utility grid side of the switch. The intelligent transfer switch 248 may compare the local microgrid phase angle to the utility grid phase angle. A phase angle difference that may exceed a predefined phase angle tolerance may cause the intelligent transfer switch 248 to withhold reconnection. The intelligent transfer switch 248 may continue to monitor phase angle on both sides of the switch until the difference may fall within the predefined phase angle tolerance. When the phase angle of the local microgrid bus may align with the phase angle of the utility grid within the predefined phase angle tolerance, the intelligent transfer switch 248 may determine that the phase angle synchronization condition may be satisfied.

The intelligent transfer switch 248 may withhold reconnection until the voltage magnitude synchronization condition, the frequency synchronization condition, and the phase angle synchronization condition may each be simultaneously satisfied. The simultaneous satisfaction of all three synchronization conditions may constitute a synchronization state. The intelligent transfer switch 248 may monitor the voltage magnitude, frequency, and phase angle parameters on a continuous basis during the synchronization check sequence. The intelligent transfer switch 248 may not initiate reconnection if any one of the three synchronization conditions may remain unsatisfied at the time of evaluation. This multi-parameter evaluation approach may prevent the intelligent transfer switch 248 from reconnecting the local microgrid to the utility grid under conditions that may produce back-feeding, phase mismatch, or power quality disturbances.

The prevention of back-feeding may be a function of the voltage magnitude and phase angle synchronization conditions evaluated by the intelligent transfer switch 248. Back-feeding may occur when the local microgrid may supply electrical energy to the utility grid in an uncontrolled manner during or following a grid disturbance. Back-feeding may arise when the voltage magnitude of the local microgrid bus may exceed the voltage magnitude of the utility grid at the moment of reconnection. The voltage magnitude synchronization condition evaluated by the intelligent transfer switch 248 may prevent this condition by requiring that the voltage magnitudes on both sides of the switch may be within the predefined tolerance before reconnection may be permitted. The phase angle synchronization condition may further prevent back-feeding by ensuring that the instantaneous polarity of the local microgrid waveform may be aligned with the instantaneous polarity of the utility grid waveform at the moment of reconnection. A phase angle mismatch at the moment of reconnection may produce a transient current surge that may propagate from the local microgrid into the utility grid, which the phase angle synchronization condition may prevent.

The prevention of phase mismatch may be a function of the phase angle synchronization condition evaluated by the intelligent transfer switch 248. Phase mismatch may occur when the alternating current waveform of the local microgrid bus may be offset in phase from the alternating current waveform of the utility grid at the moment of reconnection. A phase mismatch at the moment of reconnection may produce voltage transients, current surges, and mechanical stresses on connected equipment. The intelligent transfer switch 248 may evaluate the phase angle difference between the local microgrid bus and the utility grid continuously during the synchronization check sequence. The intelligent transfer switch 248 may withhold reconnection until the phase angle difference may fall within the predefined phase angle tolerance. This continuous evaluation may allow the intelligent transfer switch 248 to identify the moment at which the phase angle difference may be minimized and may initiate reconnection at that moment, thereby reducing the magnitude of any transient disturbance that may accompany the reconnection event.

The energy management module 242 may coordinate with the intelligent transfer switch 248 during the synchronization check sequence. The energy management module 242 may receive synchronization status data from the intelligent transfer switch 248 indicating the current values of the voltage magnitude, frequency, and phase angle parameters on both sides of the switch. The energy management module 242 may transmit this synchronization status data to the external platform via the IoT module 210. The external platform may analyze the synchronization status data and may generate control signals that may be transmitted back to the energy management module 242 via the IoT module 210. The energy management module 242 may relay these control signals to the intelligent transfer switch 248 to adjust the synchronization check parameters or to modify the predefined tolerance thresholds based on real-time grid conditions.

The dynamic signal conversion unit 246 may support the synchronization check sequence performed by the intelligent transfer switch 248. The dynamic signal conversion unit 246 may adjust the voltage magnitude and frequency of the power output supplied by the battery system to the local microgrid bus during the synchronization check sequence. These adjustments may bring the voltage magnitude and frequency of the local microgrid bus into closer alignment with the corresponding parameters of the utility grid, thereby reducing the time required for the synchronization conditions to be satisfied. The dynamic signal conversion unit 246 may receive adjustment commands from the energy management module 242 during the synchronization check sequence. The dynamic signal conversion unit 246 may implement these adjustment commands by modifying its voltage conversion and frequency regulation parameters in real time.

The inverter 306, as described with reference to FIG. 11, may also participate in the synchronization process associated with the intelligent transfer switch 248. The inverter 306 may adjust the phase angle and frequency of the alternating current waveform it produces on the local microgrid bus in response to synchronization commands received from the transfer switch 305 or the energy management module 242. This phase angle and frequency adjustment by the inverter 306 may reduce the phase angle difference and frequency deviation between the local microgrid bus and the utility grid, thereby facilitating the satisfaction of the phase angle synchronization condition and the frequency synchronization condition evaluated by the intelligent transfer switch 248.

The synchronization check sequence performed by the intelligent transfer switch 248 may be applicable across the operating environments described with reference to FIGS. 4, 5, 11 and 12. In the grid monitoring and mode transition operating environment of FIG. 4, the synchronization check sequence may correspond to the process depicted at step 170, where the battery system may transition back to grid-connected mode following restoration of grid stability. In the multi-function operating environment of FIG. 5, the synchronization check sequence may be performed as part of the grid mode management function depicted at step 188. In the hybrid DC microgrid system 300 of FIG. 11, the synchronization check sequence may be performed by the transfer switch 305 prior to restoring the AC line 303 connection to the power grid 302. In the smart home energy system 320 of FIG. 12, the synchronization check sequence may be performed by the transfer switch 336 prior to transitioning between energy sources or returning to grid-connected operation.

The graphical user interface 260, as described with reference to FIG. 9, may display synchronization status information to a user during the synchronization check sequence. The graphical user interface 260 may present real-time values of the voltage magnitude, frequency, and phase angle parameters measured on both sides of the intelligent transfer switch 248. The graphical user interface 260 may also display an indication of whether each synchronization condition may currently be satisfied. A user may monitor the synchronization check sequence in real time through the graphical user interface 260 via the mobile application or web browser through which the graphical user interface 260 may be accessed. The external platform may transmit synchronization status data to the graphical user interface 260 via the communication network, enabling the user to observe the progression of the synchronization check sequence and the moment at which the intelligent transfer switch 248 may initiate reconnection.

The intelligent transfer switch 248 may be implemented using solid-state switching elements. The solid-state switching elements of the intelligent transfer switch 248 may include silicon carbide or gallium nitride semiconductor devices. These semiconductor devices may enable the intelligent transfer switch 248 to complete the reconnection event within milliseconds of determining that the synchronization state may be achieved. The rapid switching capability of the solid-state switching elements may minimize the duration of any transient disturbance that may accompany the reconnection event. The intelligent transfer switch 248 may thereby restore the grid connection with a level of speed and precision that may not be achievable with conventional electromechanical switching device

The synchronization check sequence performed by the intelligent transfer switch 248 may operate independently of the primary control loop and the parallel control loop described with reference to FIGS. 1 and 2, respectively. The intelligent transfer switch 248 may perform the synchronization check sequence using parameter measurements obtained directly from sensors coupled to the local microgrid bus and the utility grid side of the switch. These measurements may be obtained independently of the sensor data transmitted to the external platform via the IoT module 210. This independent measurement capability may allow the intelligent transfer switch 248 to continue performing the synchronization check sequence even when the communication channel between the battery system and the external platform may experience disruption or degradation. The fault- tolerant communication design described with reference to FIG. 2 may further support the synchronization check sequence by maintaining the transmission of synchronization status data to the external platform via the parallel control loop when the primary communication channel may be unavailable.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

The generator 332 may supply backup alternating current power to the smart home energy system 320. The generator bmay be coupled to the transfer switch 336 via the AC line. The generator 332 may supply power to the transfer switch 336 during periods of insufficient solar generation from the solar panels 322. The generator 332 may also supply power to the transfer switch 336 during periods of grid unavailability. The BMS 330 may receive power from the transfer switch 336 as directed by the coordinating function of the transfer switch 336. The BMS 330 may manage energy storage and dispatch within the smart home energy system 320. The BMS 330 may monitor the operating conditions of the battery energy storage system associated with the smart home energy system 320. The BMS 330 may optimize energy dispatch to the smart home load 302 based on real-time system conditions and the availability of power from the solar panels 322 and the generator 332.

The smart home load 302 may represent the residential loads within the smart home energy system 320. The smart home load 302 may receive power managed and dispatched by the BMS 330. The smart home load 302 may receive uninterrupted power during transitions between energy sources as coordinated by the transfer switch 336. The BMS 330 may implement load prioritization protocols to ensure that designated loads within the smart home load 302 may receive power during periods of limited energy availability from the solar panels 322 or the generator 332.

The wireless remote monitoring pathway 338 may constitute a distinct functional element of the smart home energy system 320. The wireless remote monitoring pathway 338 may be communicatively coupled to the BMS 330. The wireless remote monitoring pathway 338 may transmit operational data from the BMS 330 to a remote user device. The remote user device may comprise a smartphone or a personal computer. The wireless remote monitoring pathway 338 may enable a user to observe real-time energy flows within the smart home energy system 320 from a remote location. The wireless remote monitoring pathway 338 may also enable a user to configure source priorities within the smart home energy system 320 from a remote location. The wireless remote monitoring pathway 338 may further enable a user to receive alerts regarding system status, energy source availability, or operating conditions of the smart home energy system 320.

The wireless remote monitoring pathway 338 may communicate with the external platform via the IoT module 210. The IoT module 210 may transmit operational data received from the BMS 330 to the external platform via the wireless remote monitoring pathway 338. The external platform may process the received operational data using control algorithms and may generate control signals for transmission back to the BMS 330 via the wireless remote monitoring pathway 338 and the IoT module 210. The BMS 330 may receive the control signals and may adjust energy dispatch operations within the smart home energy system 320 in accordance with the received control signals.

The wireless remote monitoring pathway 338 may support at least one wireless communication protocol. The wireless communication protocol supported by the wireless remote monitoring pathway 338 may include Wi-Fi, cellular, Zigbee, Bluetooth, or low- power wide-area network connections. The wireless remote monitoring pathway 338 may maintain a continuous communication link between the BMS 330 and the remote user device during normal operation of the smart home energy system 320. The wireless remote monitoring pathway 338 may also maintain the communication link during mode transitions coordinated by the transfer switch 336, such that a user may observe real-time energy source transitions as they may occur within the smart home energy system 320.

The graphical user interface 260, as described with reference to FIG. 9, may be accessible to a user via the smartphone or personal computer connected to the wireless remote monitoring pathway 338. The graphical user interface 260 may display real-time metrics associated with the smart home energy system 320, including energy flow from the solar panels 322, operating status of the generator 332, state of charge of the battery energy storage system managed by the BMS 330, and power delivery status to the smart home load 302. The graphical user interface 260 may also display alerts generated by the BMS 330 or the transfer switch 336 regarding anomalous operating conditions within the smart home energy system 320.

The smart home energy system 320 may thereby represent a beyond-the-meter residential deployment of a multi-source energy management system. The solar panels 322 may supply renewable direct current power to the system 320 via the DC line to the transfer switch 336. The generator 332 may supply backup alternating current power to the system 320 via the AC line to the transfer switch 336. The transfer switch 336 may coordinate transitions among these multiple energy sources. The BMS 330 may manage energy storage and dispatch to the smart home load 302. The wireless remote monitoring pathway 338 may enable remote monitoring and control of the smart home energy system 320 via a smartphone or personal computer. These components may operate in a coordinated manner within the smart home energy system 320 to maximize renewable energy utilization and maintain continuous power availability to the smart home load 302 in a residential deployment context.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

FIG. 13a illustrates a front view of the outer front cover (352) of the battery system housing. The outer front cover (352) maybe configured as a rounded-rectangle panel forming the exterior face of the enclosure. The outer front cover (352) may include an inner recessed border that may define a protected interior region, and may further include two circular features that may correspond to port openings or indicator windows on the face of the housing. FIG. 13b illustrates a front view of the battery module (360) as assembled within the housing. The battery module (360) may include three internal, horizontally oriented rounded-rectangle features that may represent individual battery cell groups or battery management subassemblies arranged within the module. A dimension or bracket indicator (362) may be shown adjacent to the battery module (360) to indicate a relevant physical dimension of the assembly. FIG. 13c illustrates a front view of the inner battery cover (370), which may be positioned behind the outer front cover (352) and may serve to enclose and protect the battery module (360). The inner battery cover (370) may include a lightning-bolt symbol indicating the presence of high-voltage electrical components, a battery-indicator feature representing the charge state display, and circular or port features (362) that may align with the port openings of the outer front cover (352) to provide access for external cable connections. FIG. 13d illustrates a perspective view of a BMS assembly (380) comprising a base plate with corner mounting holes for wall or rack mounting, and an upper housing that may include a finned heat-sink section to dissipate thermal energy generated during battery charging and discharging operations. The BMS assembly (380) may house the BMS controller, the IoT module, the fast pulse charging module, and associated power electronics within a compact, thermally managed enclosure suitable for residential, commercial, or industrial installation environments.

The BMS assembly 380 depicted in FIG. 13d may comprise a base plate from which the upper housing structure may extend. As shown in FIG. 13d, the base plate of the BMS assembly 380 may be rectangular in form with rounded corners. The base plate may include a plurality of mounting holes 382 disposed near each corner of the base plate. Each mounting hole 382 may be formed as a small circular aperture passing through the thickness of the base plate material. The mounting holes 382 may be positioned proximate to the respective corners of the base plate such that each corner region of the base plate may include one mounting hole 382.

The mounting holes 382 may serve as attachment points for securing the BMS assembly 380 to a wall surface, a mounting panel, a rack structure, or another installation surface. A fastener, such as a screw or bolt, may be passed through each mounting hole 382 and engaged with a corresponding anchor or threaded receiver disposed in the installation surface. The mounting holes 382 may thereby allow the BMS assembly 380 to be affixed in a fixed positional relationship relative to the installation surface during deployment.

The corner placement of the mounting holes 382 may distribute the mechanical load imposed on the BMS assembly 380 across multiple fastening points. The distribution of the mounting holes 382 across the four corner regions of the base plate may provide a stable mounting configuration for the BMS assembly 380 when installed on a vertical wall surface or a horizontal mounting panel. The base plate incorporating the mounting holes 382 may thereby provide a structural foundation that may support the weight of the upper housing of the BMS assembly 380 and the internal components housed therein, including the BMS controller 204, the IoT module 210, the fast pulse charging module 208, and associated power electronics.

The mounting holes 382 may be sized to accommodate standard fastener diameters suitable for wall or surface installation in residential, commercial, or industrial environments. The base plate may be fabricated from a material having sufficient structural rigidity to maintain the positional integrity of the BMS assembly 380 under the mechanical stresses associated with wall-mounted operation. The mounting configuration provided by the mounting holes 382 may allow the BMS assembly 380 to be installed in a wall-mounted orientation such that the finned upper section of the BMS assembly 380 may be positioned to facilitate convective airflow across the fins during operation, supporting the thermal management function of the finned upper section as described with reference to FIG. 13d.

Referring now to FIG. 13c in greater detail, the inner battery cover 370 may include a plurality of graphical symbols disposed on its face that may serve as user-facing status indicators forming part of the physical human-machine interface of the housing. As shown in FIG. 13c, a lightning bolt symbol 372 maybe disposed near the upper center region of the inner face of the inner battery cover 370. A battery indicator symbol 374 may be disposed adjacent to the lightning bolt symbol 372, positioned to the right of the lightning bolt symbol 372 on the face of the inner battery cover 370.

The lightning bolt symbol 372 may be rendered as a downward-angled, angular chevron-shaped graphic element on the face of the inner battery cover 370. The lightning bolt symbol 372 may function as a visual warning indicator to a user that high-voltage electrical components may be present within the battery system housing. The lightning bolt symbol 372 may communicate to a user that caution may be exercised when accessing the interior of the housing during maintenance or installation operations. The lightning bolt symbol 372 may thereby serve as a physical, on-device safety indicator that may convey the presence of potentially hazardous electrical energy without requiring a user to consult a remote interface or external documentation.

The battery indicator symbol 374 may be rendered as a vertically oriented, rounded-rectangle icon with a smaller internal marking disposed near its upper end on the face of the inner battery cover 370. The battery indicator symbol 374 may represent the charge state of the battery module 360 to a user who may be physically present at the housing. The battery indicator symbol 374 may function as a visual representation of the current state of charge of the battery system, providing a user with an immediate, at-a-glance indication of available stored energy without requiring access to the graphical user interface 260 described with reference to FIG. 9. The battery indicator symbol 374 may thereby serve as a local, on-device charge status indicator that may supplement the remote monitoring capabilities provided by the IoT module 210.

Together, the lightning bolt symbol 372 and the battery indicator symbol 374 may constitute distinct labeled graphical elements of the physical human-machine interface of the housing. The lightning bolt symbol 372 and the battery indicator symbol 374 may be integrally formed on or applied to the face of the inner battery cover 370. The lightning bolt symbol 372 and the battery indicator symbol 374 may be positioned within the inner recessed region of the inner battery cover 370 such that they may remain visible to a user upon removal of the outer front cover 352. The inner battery cover 370 may further include circular port features 362 that may align with corresponding port openings of the outer front cover 352 to provide access for external cable connections, as described with reference to FIG. 13a. The lightning bolt symbol 372 and the battery indicator symbol 374 may be arranged on the face of the inner battery cover 370 in proximity to the circular port features 362 such that a user accessing the port features 362 may simultaneously observe both status indicators during connection or disconnection of external cables.

The physical placement of the lightning bolt symbol 372 and the battery indicator symbol 374 on the face of the inner battery cover 370 may provide a user-facing interface layer that may operate independently of the electronic display and communication systems of the battery management system. This physical human-machine interface layer may remain functional and visible to a user even in conditions where the graphical user interface 260, the IoT module 210, or the communication network may be unavailable or inactive. The lightning bolt symbol 372 and the battery indicator symbol 374 may thus provide a passive, always-present status indication capability at the physical housing level that may complement the active, electronic monitoring and control capabilities described throughout the present disclosure.

Referring now to FIG. 9, the graphical user interface 260 may be further described with respect to the real-time operational data fields that may be presented on the display in addition to the four selectable energy source mode regions. As depicted in FIG. 9, the display 260 may present four selectable energy source mode regions arranged in a vertically stacked configuration within the outer rectangular border of the display. The topmost selectable region may correspond to the SOLAR mode option 262. The second selectable region from the top may correspond to the EV mode option 264. The third selectable region from the top may correspond to the SUPPLY mode option 266. The fourth and lowermost selectable region may correspond to the CUSTOM mode option 268.

In addition to the four selectable energy source mode regions 262, 264, 266, and 268, the display 260 may present a plurality of real-time operational data fields. A voltage data field 272 may be disposed within the display 260. The voltage data field 272 may present the real-time terminal voltage of the battery module 202 as measured by the BMS controller 204. A current data field 273 may also be disposed within the display 260. The current data field 273 may present the real-time charge or discharge current flowing through the battery module 202. A state-of-charge data field 274 may be disposed within the display 260. The state-of-charge data field 274 may present the current state of charge of the battery module 202 as a percentage value computed by the BMS controller 204.

A bar-graph charge level indicator 275 may be disposed within the display 260. The bar-graph charge level indicator 275 may present a graphical representation of the state of charge of the battery module 202 as a segmented horizontal or vertical bar. The bar-graph charge level indicator 275 may provide a user with an at-a-glance visual indication of available stored energy without requiring interpretation of a numerical value. A delta voltage data field 276 may be disposed within the display 260. The delta voltage data field 276 may present the difference between the maximum cell voltage and the minimum cell voltage within the battery module 202 as measured by the BMS controller 204. An average voltage data field 277 may be disposed within the display 260. The average voltage data field 277 may present the mean cell voltage across all cells within the battery module 202.

A MOS temperature data field 278 may be disposed within the display 260. The MOS temperature data field 278 may present the real-time temperature of the metal-oxide- semiconductor switching components within the battery management system. An ambient temperature data field 279 may also be disposed within the display 260. The ambient temperature data field 279 may present the real-time ambient temperature measured by a thermal sensor associated with the battery system housing.

An alarm status indicator 281 may be disposed within the display 260. The alarm status indicator 281 may present a visual indication of whether an active alarm condition may be present within the battery system. A balance status indicator 283 may be disposed within the display 260. The balance status indicator 283 may present a visual indication of whether the cell balancing function of the BMS controller 204 may be actively operating. A charge status indicator 285 may be disposed within the display 260. The charge status indicator 285 may present a visual indication of whether the battery module 202 may be in an active charging state. A discharge status indicator 287 maybe disposed within the display 260. The discharge status indicator 287 may present a visual indication of whether the battery module 202 may be in an active discharging state.

The voltage data field 272, the current data field 273, the state-of-charge data field 274, the bar-graph charge level indicator 275, the delta voltage data field 276, the average voltage data field 277, the MOS temperature data field 278, the ambient temperature data field 279, the alarm status indicator 281, the balance status indicator 283, the charge status indicator 285, and the discharge status indicator 287 may each be updated in real time by the BMS controller 204. The BMS controller 204 may transmit the data populating each of these fields to the display 260 via the IoT module 210. The display 260 may refresh each data field at a rate sufficient to provide a user with a continuous and accurate representation of the current operating state of the battery system.

The real-time operational data fields 272 through 287 maybe arranged within the display 260 in a layout that may allow a user to simultaneously observe both the selected energy source mode and the current operational status of the battery system. The selectable energy source mode regions 262, 264, 266, and 268 may occupy a first portion of the display 260. The real-time operational data fields 272 through 287 may occupy a second portion of the display 260 distinct from the first portion. This spatial arrangement may allow a user to select an energy source mode and monitor real-time battery parameters from a single display interface without navigating between separate screens or menus.

The alarm status indicator 281 may change its visual state upon detection of an alarm condition by the BMS controller 204. Alarm conditions that may trigger a change in the alarm status indicator 281 may include overvoltage, undervoltage, overcurrent, overtemperature, and cell imbalance conditions. The balance status indicator 283 may change its visual state when the BMS controller 204 may activate a cell balancing routine to equalize the state of charge across individual cells within the battery module 202. The charge status indicator 285 may change its visual state when the fast pulse charger 208 may be actively applying charging pulses to the battery module 202. The discharge status indicator 287 may change its visual state when the battery module 202 may be supplying power to a connected load.

The display 260 may thereby serve as a unified human-machine interface that may consolidate energy source mode selection, real-time battery parameter monitoring, and system status indication within a single physical or software-rendered display surface. The display 260 may be rendered on a physical panel mounted on the battery system housing, on a mobile application accessible via a smartphone or tablet, or on a web application accessible via a browser-based interface. In each rendering context, the selectable energy source mode regions 262, 264, 266, and 268 and the real-time operational data fields 272 through 287 may be presented in a consistent layout that may allow a user to monitor and control the battery system from a single unified interface.

The mode selection control element 270 disposed within the CUSTOM region 268 may remain accessible within the display 260 regardless of which rendering context may be in use. The mode selection control element 270 may communicate a user-defined configuration selection to the BMS controller 204 and the energy management module 242. The BMS controller 204 and the energy management module 242 may update the source prioritization and power routing configuration of the battery system in accordance with the user-defined configuration received through the mode selection control element 270. The updated configuration may be reflected in the real-time operational data fields 272 through 287 as the battery system may adjust its operating state in response to the new configuration.

The display 260 may also communicate configuration inputs entered by a user through the selectable energy source mode regions 262, 264, 266, and 268 to the external platform via the IoT module 210. The external platform may process the configuration inputs and may generate corresponding control signals for transmission back to the battery system via the IoT module 210. The BMS controller 204 may execute the received control signals and may update the real-time operational data fields 272 through 287 on the display 260 to reflect the resulting changes in battery system operating state. The display 260 may thereby function as a bidirectional interface through which a user may both observe the current state of the battery system and direct changes to its operating configuration.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

Referring now to FIG. 13d, the BMS assembly 380 may be described in further detail with respect to its thermal management features. As depicted in FIG. 13d, the BMS assembly 380 may comprise a base plate having a generally rectangular form with rounded corners. The base plate may include a circular mounting hole disposed proximate each corner. The mounting holes may facilitate wall mounting, rack mounting, or panel mounting of the BMS assembly 380 in residential, commercial, or industrial installation environments.

Atop the base plate, the BMS assembly 380 may include a rectangular housing body having vertical side walls and a structured upper surface. The upper surface of the housing body may comprise a finned heat-sink structure 382 formed by a plurality of parallel fins extending across the upper surface of the housing. The parallel fins of the finned heat- sink structure 382 may be oriented longitudinally and may be spaced at uniform intervals across the upper surface of the housing body. Each fin of the finned heat-sink structure 382 may project upwardly from the upper surface of the housing body. The fins may extend in a direction generally parallel to one another, forming a ribbed profile when viewed from above or from the side.

The finned heat-sink structure 382 may be formed integrally with the housing body of the BMS assembly 380. The finned heat-sink structure 382 may be fabricated from a thermally conductive material. Thermally conductive materials suitable for the finned heat- sink structure 382 may include aluminum, aluminum alloys, copper, or other metallic materials having elevated thermal conductivity. The thermally conductive material of the finned heat-sink structure 382 may facilitate conductive heat transfer from the internal components of the BMS assembly 380 to the fin surfaces.

The finned heat-sink structure 382 may function as a passive thermal management feature of the BMS assembly 380. During charging operations, the BMS controller 204, the fast pulse charger 208, and associated power electronics housed within the BMS assembly 380 may generate thermal energy as a byproduct of electrical switching, current regulation, and power conversion activities. During discharging operations, similar thermal energy generation may occur within the power electronics of the BMS assembly 380. The finned heat-sink structure 382 may dissipate this thermal energy by conducting heat from the internal components of the BMS assembly 380 through the housing body and into the fins, from which the thermal energy may be transferred to the surrounding ambient air by convection.

The plurality of parallel fins of the finned heat-sink structure 382 may increase the total surface area of the upper surface of the BMS assembly 380 available for convective heat transfer. The increased surface area provided by the finned heat-sink structure 382 may enhance the rate at which thermal energy may be transferred from the BMS assembly 380 to the surrounding environment. The enhanced heat dissipation capacity of the finned heat- sink structure 382 may allow the BMS assembly 380 to sustain elevated power throughput levels during high-power charging and discharging operations without exceeding safe thermal operating limits.

The finned heat-sink structure 382 may operate in conjunction with the thermal monitoring subsystem of the BMS controller 204. The BMS controller 204 may monitor internal temperatures of the BMS assembly 380 via thermal sensors. The BMS controller 204 may adjust charging parameters, including pulse amplitude, pulse duration, and pulse frequency of the fast pulse charger 208, in response to monitored thermal conditions. The finned heat-sink structure 382 may thereby support the thermal management strategy of the BMS assembly 380 by providing a passive heat dissipation pathway that may reduce the thermal load experienced by the internal components during operation.

Adjacent to the finned heat-sink structure 382, at one corner of the upper surface of the housing body, the BMS assembly 380 may include a raised rectangular area. The raised rectangular area may house additional interface elements, connection ports, or indicator features associated with the BMS assembly 380. The raised rectangular area may be positioned proximate the finned heat-sink structure 382 such that thermal energy generated by components within the raised rectangular area may also be conducted into the finned heat-sink structure 382 for dissipation.

The finned heat-sink structure 382 may be particularly suited to high-power applications in which the BMS assembly 380 maybe required to manage elevated charge and discharge current levels over extended operational periods. In modular deployment configurations, multiple BMS assemblies 380 may be arranged in proximity to one another, with each BMS assembly 380 incorporating the finned heat-sink structure 382 to independently manage the thermal output of its respective power electronics. The finned heat-sink structure 382 may thereby contribute to the thermal performance of the BMS assembly 380 across the range of residential, commercial, and industrial installation environments depicted in FIG. 13.

Referring now to FIG. 13c in further detail, the inner battery cover 370 may be described as a discrete labeled component of the battery housing assembly. As depicted in FIG. 13c, the inner battery cover 370 may be formed as a rounded-corner rectangular panel having a double-line border that may define an outer perimeter and an inner recessed region. The inner battery cover 370 may be positioned behind the outer front cover 352 within the battery housing assembly and may serve to enclose and protect the battery module 360 from the interior side of the housing.

The inner battery cover 370 may include a plurality of graphical symbols and interface features disposed within its inner recessed region. As shown in FIG. 13c, a lightning bolt symbol may be disposed near the upper center region of the inner face of the inner battery cover 370. The lightning bolt symbol may be rendered as a downward-angled, angular graphic element on the face of the inner battery cover 370. The lightning bolt symbol may function as a visual warning indicator to a user that high-voltage electrical components may be present within the battery housing assembly. The lightning bolt symbol may communicate to a user that caution may be exercised when accessing the interior of the housing during maintenance or installation operations.

A battery indicator symbol may be disposed adjacent to the lightning bolt symbol on the face of the inner battery cover 370. The battery indicator symbol may be positioned to the right of the lightning bolt symbol within the inner recessed region of the inner battery cover 370. The battery indicator symbol may be rendered as a vertically oriented, rounded- rectangle icon with a smaller internal marking disposed near its upper end. The battery indicator symbol may represent the charge state of the battery module 360 to a user who may be physically present at the housing. The battery indicator symbol may function as a local, on-device charge status indicator that may provide a user with an at-a-glance indication of available stored energy.

As further shown in FIG. 13c, the inner battery cover 370 may include circular port features 362 disposed within the inner recessed region. The circular port features 362 may be arranged in a vertical column within the inner recessed region of the inner battery cover 370. The circular port features 362 may align with corresponding port openings of the outer front cover 352 to provide access for external cable connections when the battery housing assembly may be assembled. A leader line on the right side of the inner battery cover 370 may point to the right edge of the panel and may be labeled with reference numeral 370 near the upper right portion of the figure. A second leader line on the right side of the inner battery cover 370 may point toward the lower right region of the panel and may be labeled with reference numeral 362, designating the circular port features disposed in that region of the inner battery cover 370.

The inner battery cover 370 may thereby constitute a discrete, labeled component of the battery housing assembly that may be distinguished from the outer front cover 352 described with reference to FIG. 13a and from the battery module 360 described with reference to FIG. 13b. The inner battery cover 370 may be removable from the battery housing assembly to provide access to the battery module 360 and associated internal components during maintenance operations. The circular port features 362 of the inner battery cover 370 may be sized and positioned to correspond with the port openings of the outer front cover 352 such that external cable connections may pass through both the outer front cover 352 and the inner battery cover 370 when the battery housing assembly may be in an assembled configuration.

The lightning bolt symbol and the battery indicator symbol disposed on the face of the inner battery cover 370 may constitute user-facing status indicators that may form part of the physical human-machine interface of the battery housing assembly. These graphical elements may be integrally formed on or applied to the face of the inner battery cover 370. The lightning bolt symbol and the battery indicator symbol may remain visible to a user upon removal of the outer front cover 352, providing a physical, on-device interface layer that may operate independently of the electronic display and communication systems of the battery management system. The physical human-machine interface provided by the inner battery cover 370 may remain functional and visible to a user even in conditions where the graphical user interface 260, the IoT module 210, or the communication network may be unavailable or inactive.

The inner battery cover 370 may be fabricated from a material having sufficient structural rigidity to maintain the positional integrity of the circular port features 362 relative to the port openings of the outer front cover 352 during assembly and operation. The inner battery cover 370 may be fabricated from a material compatible with the thermal and electrical environment of the battery housing assembly interior. The inner battery cover 370 may thereby provide a structural and functional interface layer between the outer front cover 352 and the battery module 360 within the battery housing assembly, combining physical protection of internal components with user-facing status indication and external cable access through the circular port features 362.

Referring now to FIG. 13b in greater detail, the battery module 360 may be described as a discrete labeled component of the overall battery system. As depicted in FIG. 13b, the battery module 360 may be formed as a plain rectangular housing with straight edges. The battery module 360 may constitute the primary electrochemical energy storage element of the battery system. The battery module 360 may comprise a plurality of cell compartments arranged within the module housing. As shown in FIG. 13b, three horizontally oriented rounded-rectangle features may be arranged in a vertical stack within the interior of the battery module 360. The three horizontally oriented rounded-rectangle features may be evenly spaced within the rectangular housing of the battery module 360. Each horizontally oriented rounded-rectangle feature may represent an individual battery cell group or battery management subassembly disposed within the battery module 360.

As further shown in FIG. 13b, a vertical bracket or dimension indicator may be disposed on the right side of the battery module 360. The vertical bracket or dimension indicator may span substantially the full height of the battery module 360. The vertical bracket or dimension indicator may be labeled with reference numeral 360 near its upper end and reference numeral 362 near its lower end. Reference numeral 360 may designate the battery module as a whole, including its rectangular housing and the plurality of cell compartments arranged therein. Reference numeral 362 may designate a physical dimension of the battery module 360, as indicated by the lower terminus of the vertical bracket or dimension indicator disposed on the right side of the battery module 360.

The battery module 360 may interface with the BMS controller 204 for continuous condition monitoring during operation. The BMS controller 204 may receive sensor signals from the battery module 360 to compute battery state estimates, enforce safety limits, and generate control outputs. The battery module 360 may also interface with the fast pulse charger 208, which may apply high-frequency electrical pulses to the battery module 360 during charging operations. The battery module 360 may further interface with the dynamic signal conversion unit 206, which may adapt electrical characteristics to ensure compatibility between the battery module 360 and external power sources or loads connected to the battery system.

The battery module 360 may be deployed as a discrete, labeled component within the battery housing assembly described with reference to FIGS. 13a through 13d. The battery module 360 may be enclosed within the battery housing assembly by the outer front cover 352 described with reference to FIG. 13a and the inner battery cover 370 described with reference to FIG. 13c. The battery module 360 may be accessible for maintenance or replacement upon removal of the outer front cover 352 and the inner battery cover 370 from the battery housing assembly. The battery module 360 may be configured for modular deployment, enabling the battery system capacity to be scaled for residential, commercial, or industrial applications by adding or replacing battery modules 360 within the battery housing assembly.

The battery module 360 may communicate operational data to the IoT module 210 via the BMS controller 204. The IoT module 210 may transmit operational data from the battery module 360 to the external platform via the communication network. The external platform may analyze the transmitted operational data and generate control signals for transmission back to the battery module 360 via the IoT module 210 and the BMS controller 204. The battery module 360 may thereby participate in the closed-loop monitoring and control architecture described with reference to FIG. 6, enabling remote management of the battery module 360 from a centralized or distributed cloud platform through the graphical user interface 260 described with reference to FIG. 9.

Referring now to FIG. 13d in further detail, the BMS assembly 380 may be described with respect to the structural characteristics of its base edge. As depicted in FIG. 13d, the BMS assembly 380 may comprise a base plate that forms the lowermost structural boundary of the assembly. The base edge of the BMS assembly 380 may define the perimeter of the base plate at its outermost extent. The base edge may be formed as a continuous, generally rectangular boundary with rounded corners. The base edge of the BMS assembly 380 may constitute the structural interface between the BMS assembly 380 and the installation surface upon which the BMS assembly 380 may be mounted.

As shown in FIG. 13d, reference numeral 380 may be assigned to the BMS assembly housing or base edge as depicted in that figure. The base edge designated by reference numeral 380 may represent the outermost lower boundary of the BMS assembly 380 as viewed in the perspective view of FIG. 13d. A leader line in FIG. 13d may point to the side of the housing or base of the BMS assembly 380, with the reference numeral 380 positioned adjacent to that leader line to identify the assembly and its base edge as a discrete structural element within the overall battery system architecture.

Referring now to FIG. 13d, the BMS assembly 380 may be further described with respect to the relationship between reference numeral 380 as used in FIG. 13d and reference numeral 330 as it may appear in other figures within this disclosure. As depicted in FIG. 13d, the drawing label identifies the component as the BMS ASSEMBLY and assigns reference numeral 380 to that assembly. Reference numeral 380 may designate the BMS assembly as a complete structural unit, comprising the base plate, the rectangular housing body, the finned heat-sink structure, the raised rectangular area at the corner of the upper surface, and the mounting holes disposed proximate each corner of the base plate. The written description of FIG. 13d may use reference numeral 380 consistently to identify this assembly and its constituent structural elements.

It may be noted that FIG. 16, which appears elsewhere in this disclosure, depicts a component labeled "BMS HOUSING" and assigns reference numeral 330 to that component. The component designated by reference numeral 330 in FIG. 16 may represent the housing body portion of the BMS assembly 380 depicted in FIG. 13d. Reference numeral 330 may designate the housing body as a discrete structural sub-element of the BMS assembly 380. The housing body designated by reference numeral 330 may comprise the rectangular enclosure with vertical side walls and the finned upper surface that may be visible in the perspective view of FIG. 13d. The BMS assembly 380 may thereby be understood as the complete assembly that incorporates the housing body 330 as one of its structural sub- elements, together with the base plate and the mounting holes disposed at the corners of the base plate.

The relationship between reference numeral 330 and reference numeral 380 may be described as follows. Reference numeral 380 may designate the BMS assembly as a whole, including all structural elements depicted in FIG. 13d. Reference numeral 330 may designate the housing body sub-element of the BMS assembly 380, as depicted in FIG. 16. The housing body 330 maybe the portion of the BMS assembly 380 that encloses the BMS controller 204, the IoT module 210, the fast pulse charger 208, and associated power electronics. The base plate of the BMS assembly 380 may provide the structural foundation upon which the housing body 330 may be mounted. The mounting holes disposed proximate each corner of the base plate may secure the BMS assembly 380, including the housing body 330, to an installation surface. The finned heat-sink structure formed on the upper surface of the housing body 330 may dissipate thermal energy generated by the internal components of the BMS assembly 380 during charging and discharging operations, as described with reference to FIG. 13d.

For all purposes of this disclosure, reference numeral 380 may be the operative designation for the BMS assembly as a complete structural unit as depicted in FIG. 13d, and reference numeral 330 may be the operative designation for the housing body sub-element of the BMS assembly 380 as depicted in FIG. 16. These two reference numerals may designate structurally related but distinct elements within the overall battery system architecture. The BMS assembly 380 may encompass the housing body 330 as a component part. The housing body 330 may not encompass the base plate or the mounting holes of the BMS assembly 380, as those elements may constitute separate structural sub-elements of the BMS assembly 380 that may be distinct from the housing body 330.

The BMS assembly 380 may be deployed as a discrete, labeled structural unit within the battery system configurations described with reference to FIG. 13. The BMS assembly 380 may be installed in a wall-mounted orientation, a rack-mounted orientation, or a panel-mounted orientation using the mounting holes disposed proximate each corner of the base plate. The housing body 330 of the BMS assembly 380 may be fabricated from a thermally conductive material to facilitate heat transfer from the internal components to the finned heat-sink structure on the upper surface of the housing body 330. The BMS assembly 380 may thereby constitute a thermally managed, structurally integrated enclosure for the core electronic components of the battery management system, suitable for deployment across the residential, commercial, and industrial installation environments depicted in FIG. 13.

The BMS assembly 380 may interface with the battery module 360 described with reference to FIG. 13b. The BMS controller 204 housed within the BMS assembly 380 may receive sensor signals from the battery module 360 and may issue control commands to the fast pulse charger 208 and the dynamic signal conversion unit 206 housed within the BMS assembly 380. The IoT module 210 housed within the BMS assembly 380 may transmit operational data from the battery module 360 to the external platform via the communication network. The external platform may generate control signals in response to the transmitted data and may relay those control signals to the BMS controller 204 via the IoT module 210 within the BMS assembly 380. The BMS assembly 380 may thereby serve as the central hardware enclosure through which the monitoring, control, communication, and thermal management functions of the battery management system may be integrated and deployed.

The BMS assembly 380 may further support modular deployment configurations in which multiple BMS assemblies 380 may be installed in proximity to one another. Each BMS assembly 380 in a modular configuration may independently manage the thermal output of its respective power electronics via the finned heat-sink structure of its housing body 330. Each BMS assembly 380 in a modular configuration may also communicate with adjacent BMS assemblies 380 via the mesh network nodes described with reference to FIG. 7, enabling coordinated multi-unit operation within the secure mesh communication network 220. The mounting holes of each BMS assembly 380 may allow individual units to be added to or removed from a modular installation without disrupting the operation of the remaining BMS assemblies 380 in the configuration.

Referring now to FIG. 7, the secure mesh communication network 220 may be further described with respect to the cloud synchronization module depicted within the lower composite block of the network architecture. As shown in FIG. 7, the lower composite block of the network architecture 220 maybe divided into three horizontal sub-sections. The topmost sub-section of the composite block may be designated by reference numeral 228 and may correspond to the encryption module 228 as described above. The middle sub- section of the composite block may be designated by reference numeral 230 and may correspond to the anomaly detection module 230 as described above. The bottom sub- section of the composite block may contain the text "CLOUD SYNC" and may be assigned reference numeral 232 for purposes of this disclosure. The cloud synchronization module 232 may thereby constitute a discrete structural element within the lower composite block of the secure mesh communication network architecture 220, positioned below the anomaly detection module 230 within the composite processing block.

The cloud synchronization module 232 may function as the dedicated interface element through which the secure mesh communication network 220 may exchange data with a remote cloud-based system. The cloud synchronization module 232 may aggregate operational data collected from the first mesh node 222 and the second mesh node 224. The cloud synchronization module 232 may transmit the aggregated operational data to a remote cloud-based platform for fleet-level monitoring and analysis. The cloud synchronization module 232 may also receive data, configuration updates, and control signals from the remote cloud-based platform and may distribute those inputs to the appropriate components within the mesh network 220.

The cloud synchronization module 232 may operate in a coordinated relationship with the encryption module 228 within the composite processing block. The encryption module 228 may apply cryptographic protocols to data prior to transmission by the cloud synchronization module 232 to the remote cloud-based platform. The encryption module 228 may apply protocols including, but not limited to, AES-256 and TLS to data packets prepared for cloud transmission by the cloud synchronization module 232. The cloud synchronization module 232 may receive cryptographically secured data packets from the encryption module 228 and may transmit those packets to the remote cloud-based platform via the communication network. The cloud synchronization module 232 may thereby ensure that all data exchanged between the local mesh network 220 and the remote cloud-based platform may be transmitted in an encrypted state consistent with the cryptographic protections applied by the encryption module 228.

The cloud synchronization module 232 may also operate in a coordinated relationship with the anomaly detection module 230 within the composite processing block. The anomaly detection module 230 may generate security alerts upon detecting network traffic patterns indicative of cybersecurity threats, unauthorized access attempts, or data integrity violations within the mesh network 220. The cloud synchronization module 232 may receive security alerts generated by the anomaly detection module 230. The cloud synchronization module 232 may transmit those security alerts to the remote cloud-based platform for further analysis and response. The remote cloud-based platform may receive the security alerts transmitted by the cloud synchronization module 232 and may generate responsive control signals for relay back to the mesh network 220 via the cloud synchronization module 232.

The cloud synchronization module 232 may further operate in a coordinated relationship with the encryption conversion component 226. The encryption conversion component 226 may process outbound data packets prior to their application of cryptographic protocols by the encryption module 228. The cloud synchronization module 232 may receive data that has been processed by the encryption conversion component 226 and encrypted by the encryption module 228 before initiating transmission to the remote cloud-based platform. This sequential processing pathway through the encryption conversion component 226, the encryption module 228, and the cloud synchronization module 232 may constitute the outbound data transmission pathway of the secure mesh communication network 220.

The cloud synchronization module 232 may aggregate operational data from the first mesh node 222 and the second mesh node 224 on a continuous or periodic basis. The aggregated operational data may include battery system parameters, energy flow metrics, state-of-charge values, temperature readings, and network status information collected at each mesh node. The cloud synchronization module 232 may organize the aggregated data into structured data packets prior to transmission to the remote cloud-based platform. The remote cloud-based platform may receive the structured data packets transmitted by the cloud synchronization module 232 and may apply control algorithms, including machine learning models and energy optimization routines, to the received data. The remote cloud- based platform may generate control signals based on the analysis of the received data and may transmit those control signals back to the mesh network 220 via the cloud synchronization module 232.

The cloud synchronization module 232 may support bidirectional data exchange between the local mesh network 220 and the remote cloud-based platform. In the outbound direction, the cloud synchronization module 232 may transmit aggregated operational data from the mesh nodes to the remote cloud-based platform. In the inbound direction, the cloud synchronization module 232 may receive control signals, configuration updates, firmware updates, and analytical outputs from the remote cloud-based platform and may distribute those inputs to the first mesh node 222, the second mesh node 224, and the other components of the composite processing block as appropriate. The bidirectional data exchange supported by the cloud synchronization module 232 may enable the remote cloud- based platform to exercise supervisory control over the distributed battery systems represented by the mesh nodes of the network 220.

The cloud synchronization module 232 may maintain a synchronization state between the local mesh network 220 and the remote cloud-based platform. The synchronization state may reflect the consistency of operational data stored locally within the mesh network 220 and the corresponding data stored on the remote cloud-based platform. The cloud synchronization module 232 may detect discrepancies between locally stored data and remotely stored data and may initiate a synchronization process to reconcile those discrepancies. The synchronization process performed by the cloud synchronization module 232 may ensure that the remote cloud-based platform may have access to a current and accurate representation of the operational state of each battery system node within the mesh network 220.

The cloud synchronization module 232 may interface with the IoT module 210 described with reference to FIG. 6. The IoT module 210 may provide the communication pathway through which the cloud synchronization module 232 may transmit data to and receive data from the remote cloud-based platform. The IoT module 210 may support the communication protocols used by the cloud synchronization module 232 for cloud data exchange, which may include MQTT, cellular, Wi-Fi, or other IoT-compatible communication protocols. The cloud synchronization module 232 may thereby leverage the communication infrastructure of the IoT module 210 to maintain the data exchange pathway between the local mesh network 220 and the remote cloud-based platform.

The cloud synchronization module 232 may support fleet-level monitoring of multiple battery system installations represented by the nodes of the mesh network 220. The cloud synchronization module 232 may aggregate operational data from each mesh node within the network 220 and may transmit the aggregated multi-node data to the remote cloud-based platform as a unified data set. The remote cloud-based platform may analyze the unified data set to generate fleet-level performance metrics, predictive maintenance recommendations, and energy optimization strategies applicable across all battery system installations represented within the mesh network 220. The cloud synchronization module 232 may receive the fleet-level outputs generated by the remote cloud-based platform and may distribute those outputs to the appropriate mesh nodes within the network 220 for local implementation.

The cloud synchronization module 232 may operate independently of the anomaly detection module 230 and the encryption module 228 in the sense that a disruption in the operation of one sub-section of the composite processing block may not necessarily prevent the cloud synchronization module 232 from performing its data aggregation and transmission functions. The cloud synchronization module 232 may continue to aggregate operational data from the mesh nodes and may queue that data for transmission to the remote cloud-based platform during periods when the encryption module 228 or the anomaly detection module 230 may be temporarily unavailable. The cloud synchronization module 232 may resume encrypted transmission of queued data to the remote cloud-based platform upon restoration of the encryption module 228 to an operational state.

The cloud synchronization module 232 may also support the graphical user interface 260 described with reference to FIG. 9. The cloud synchronization module 232 may transmit operational data from the mesh network 220 to the remote cloud-based platform, which may relay that data to the graphical user interface 260 via the communication network. The graphical user interface 260 may display real-time metrics derived from the operational data transmitted by the cloud synchronization module 232, including energy flow, battery state-of-charge, system alerts, and charging status associated with each battery system node within the mesh network 220. A user may thereby access fleet-level operational data aggregated by the cloud synchronization module 232 through the graphical user interface 260 via a mobile application or web browser.

The cloud synchronization module 232 may be implemented as a hardware component, a firmware module, or a software process executing on a processor associated with the composite processing block of the secure mesh communication network 220. The cloud synchronization module 232 may include a communication interface configured to establish and maintain a data exchange connection with the remote cloud-based platform. The cloud synchronization module 232 may also include a data buffer configured to store aggregated operational data pending transmission to the remote cloud-based platform. The data buffer of the cloud synchronization module 232 may retain aggregated operational data during periods of communication disruption and may transmit the retained data to the remote cloud-based platform upon restoration of the communication connection.

The cloud synchronization module 232 may thereby constitute a discrete functional component of the secure mesh communication network architecture 220, positioned within the lower composite block of the network architecture alongside the encryption module 228 and the anomaly detection module 230. The cloud synchronization module 232 may perform the distinct function of synchronizing data between the local mesh network 220 and the remote cloud-based platform, operating in coordination with the encryption module 228 to secure all transmitted data and in coordination with the anomaly detection module 230 to relay security alerts to the remote cloud-based platform. The cloud synchronization module 232 may enable the secure mesh communication network 220 to participate in a broader cloud-connected monitoring and control architecture that may extend the supervisory capabilities of the remote cloud-based platform to each battery system node within the distributed mesh network 220.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

The base edge of the BMS assembly 380 may be formed from a structurally rigid material. The base edge may be fabricated from a metallic material, which may include aluminum, aluminum alloy, steel, or another material having sufficient mechanical strength to support the weight of the upper housing structure and the internal components of the BMS assembly 380. The base edge may be formed integrally with the base plate of the BMS assembly 380 such that the base edge and the base plate may constitute a unitary structural element. The base edge may define the footprint of the BMS assembly 380 as installed on a mounting surface.

The base edge of the BMS assembly 380 may serve multiple structural functions within the BMS assembly. The base edge may provide a stable lower boundary that may distribute the mechanical load of the BMS assembly 380 across the installation surface. The base edge may also define the positional relationship between the base plate and the upper housing body of the BMS assembly 380. The upper housing body, which may include the finned heat-sink structure 382 described with reference to FIG. 13d, may extend upwardly from the base plate bounded by the base edge. The base edge may thereby provide the structural foundation from which the upper housing body of the BMS assembly 380 may project.

The base edge of the BMS assembly 380 may further define the mounting plane of the assembly. When the BMS assembly 380 may be installed in a wall-mounted configuration, the base edge may lie in a plane generally parallel to the mounting surface. The mounting holes disposed proximate each corner of the base plate, as described with reference to FIG. 13d, maybe positioned within the area bounded by the base edge. The base edge may thereby define the outer boundary within which the mounting holes may be located, establishing the spatial relationship between the fastening points and the perimeter of the BMS assembly 380.

The rounded corner geometry of the base edge of the BMS assembly 380 may reduce stress concentrations at the corner regions of the base plate during wall-mounted operation. The rounded corners of the base edge may also facilitate handling and installation of the BMS assembly 380 by reducing sharp edges that may otherwise present a handling hazard during deployment in residential, commercial, or industrial installation environments.

The base edge of the BMS assembly 380 may be dimensioned to accommodate the internal components housed within the BMS assembly 380, including the BMS controller 204, the IoT module 210, the fast pulse charger 208, and associated power electronics. The footprint defined by the base edge may be sized such that the internal components may be arranged within the housing body in a configuration that may support the thermal management function of the finned heat-sink structure 382. The base edge may thereby define the spatial envelope within which the internal components of the BMS assembly 380 may be arranged.

The BMS assembly 380, as identified by reference numeral 380 in FIG. 13d, may thus constitute a discrete structural element of the battery system that may integrate the base plate, the base edge, the upper housing body, and the finned heat-sink structure 382 into a compact, thermally managed enclosure. The base edge of the BMS assembly 380 may serve as the structural boundary element that may define the mounting footprint, support the upper housing structure, and establish the spatial relationship between the mounting holes and the perimeter of the assembly. The BMS assembly 380 may be deployed as a standalone unit or in modular configurations comprising multiple BMS assemblies 380 arranged in proximity to one another, with each BMS assembly 380 incorporating the base edge structure to provide a stable mounting interface with the installation surface in each of the residential, commercial, and industrial deployment environments depicted in FIG. 13.

Referring now to FIG. 13d, the BMS assembly 380 may be further described with respect to the finned heat-sink section disposed on the upper surface of the housing body. As depicted in FIG. 13d, the upper surface of the rectangular housing body of the BMS assembly 380 may comprise a finned heat-sink section 384. The finned heat-sink section 384 may be formed by a plurality of parallel fins extending across the upper surface of the housing body in a longitudinal direction. Each fin of the finned heat-sink section 384 may project upwardly from the upper surface of the housing body. The fins may be oriented generally parallel to one another and may be spaced at substantially uniform intervals across the upper surface of the housing body, forming a ribbed profile when the BMS assembly 380 may be viewed from above or from the side.

The finned heat-sink section 384 may be fabricated from a thermally conductive material. Thermally conductive materials suitable for the finned heat-sink section 384 may include aluminum, aluminum alloys, copper, or other metallic materials having elevated thermal conductivity values. The thermally conductive material of the finned heat-sink section 384 may facilitate conductive heat transfer from the internal components of the BMS assembly 380 through the housing body and into the fin surfaces. The finned heat-sink section 384 may be formed integrally with the housing body of the BMS assembly 380 such that the fins and the housing body may constitute a unitary thermally conductive structure.

The finned heat-sink section 384 may function as a passive thermal management feature of the BMS assembly 380. During charging operations, the BMS controller 204, the fast pulse charger 208, and associated power electronics housed within the BMS assembly 380 may generate thermal energy as a byproduct of electrical switching, current regulation, and power conversion activities. During discharging operations, similar thermal energy generation may occur within the power electronics of the BMS assembly 380. The finned heat-sink section 384 may dissipate this thermal energy by conducting heat from the internal components of the BMS assembly 380 through the housing body and into the individual fins, from which the thermal energy may be transferred to the surrounding ambient air by convection.

The plurality of parallel fins of the finned heat-sink section 384 may increase the total surface area of the upper surface of the BMS assembly 380 that may be available for convective heat transfer relative to an unfinned upper surface of equivalent plan dimensions. The increased surface area provided by the finned heat-sink section 384 may enhance the rate at which thermal energy may be transferred from the BMS assembly 380 to the surrounding environment during both charging and discharging operations. The enhanced heat dissipation capacity of the finned heat-sink section 384 may allow the BMS assembly 380 to sustain elevated power throughput levels during high-power charging and discharging operations without exceeding safe thermal operating limits for the internal components housed within the BMS assembly 380.

The uniform spacing of the fins of the finned heat-sink section 384 may define a plurality of inter-fin channels between adjacent fins. Each inter-fin channel may allow ambient air to flow between adjacent fins along the longitudinal direction of the fins. The flow of ambient air through the inter-fin channels may carry thermal energy away from the fin surfaces by convection. The inter-fin channels defined by the uniformly spaced fins of the finned heat-sink section 384 may thereby constitute the primary convective heat transfer pathways through which thermal energy generated during charging and discharging operations may be dissipated to the surrounding environment.

The finned heat-sink section 384 may operate in conjunction with the thermal monitoring subsystem of the BMS controller 204. The BMS controller 204 may monitor internal temperatures of the BMS assembly 380 via thermal sensors disposed within the housing body. The BMS controller 204 may adjust charging parameters, including pulse amplitude, pulse duration, and pulse frequency of the fast pulse charger 208, in response to monitored thermal conditions within the BMS assembly 380. The finned heat-sink section 384 may thereby support the thermal management strategy of the BMS assembly 380 by providing a passive heat dissipation pathway that may reduce the thermal load experienced by the internal components during operation, complementing the active parameter adjustment performed by the BMS controller 204 in response to thermal sensor data.

The finned heat-sink section 384 may be positioned on the upper surface of the housing body of the BMS assembly 380 such that the fins may be oriented to promote natural convective airflow across the fin surfaces when the BMS assembly 380 may be installed in a wall-mounted orientation. In a wall-mounted orientation, the fins of the finned heat-sink section 384 may extend in a direction that may allow buoyancy-driven convective airflow to pass through the inter-fin channels, carrying thermal energy away from the fin surfaces without requiring forced air movement from a fan or blower. The wall-mounted installation configuration supported by the mounting holes disposed proximate each corner of the base plate of the BMS assembly 380 may thereby position the finned heat-sink section 384 in an orientation conducive to passive convective heat dissipation during operation.

The finned heat-sink section 384 maybe particularly suited to high-power battery management applications in which the BMS assembly 380 may be required to manage elevated charge and discharge current levels over extended operational periods. The thermal energy generated by the BMS controller 204, the fast pulse charger 208, and associated power electronics during high-power charging and discharging operations may be conducted through the housing body to the finned heat-sink section 384 and dissipated to the surrounding environment via the convective heat transfer mechanism described above. The finned heat-sink section 384 may thereby constitute a distinct structural thermal management element of the BMS assembly 380 that maybe adapted to the thermal demands of high-power battery management applications across the residential, commercial, and industrial installation environments depicted in FIG. 13.

In modular deployment configurations, multiple BMS assemblies 380 may be arranged in proximity to one another. Each BMS assembly 380 in a modular configuration may incorporate the finned heat-sink section 384 to independently manage the thermal output of its respective power electronics. The finned heat-sink section 384 of each BMS assembly 380 in a modular configuration may dissipate thermal energy generated by that assembly independently of the thermal management function performed by the finned heat- sink sections 384 of adjacent BMS assemblies 380. The independent thermal management capability provided by the finned heat-sink section 384 of each BMS assembly 380 may allow modular configurations comprising multiple BMS assemblies 380 to be scaled for residential, commercial, or industrial applications without requiring a centralized thermal management system shared among the assemblies.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.)

### Technical Problem

Beyond-the-meter (BTM) battery systems, installed on the consumer side of the electricity meter, may serve as a central component in residential, commercial, industrial, and remote energy management. FIG. 12 illustrates how a BTM battery management system may integrate into a broader energy environment, including solar panels, a wind turbine, a transfer switch, a grid connection, a generator, and a remote home, all communicating through a wireless network accessible via smartphone or personal computer. Despite the growing deployment of such systems, conventional BTM battery technologies may present a range of technical problems that limit their effectiveness.

Conventional BTM battery systems may lack interoperability with diverse power sources and inverters. A BTM battery system may be required to interface with grid power, solar photovoltaic (PV) panels, wind turbines, geothermal systems, hydrothermal systems, electric vehicles (EVs), and standalone generators. Without a standardized and adaptive signal conversion architecture, such a system may be unable to accommodate the variable output characteristics of these diverse sources, including fluctuating AC voltage from the grid, variable DC output from solar panels, and variable-frequency output from wind turbines.

Conventional BTM battery systems may also lack intelligent real-time monitoring and management. Without an Internet of Things (IoT)-enabled control module, a BTM battery system may be unable to transmit operational data to a cloud-based platform for analysis, unable to receive optimized control signals in response, and unable to provide users with actionable insights through mobile or web-based interfaces. This absence of intelligent monitoring may result in suboptimal charging and discharging cycles, undetected battery degradation, and increased maintenance costs.

Conventional BTM battery systems may further suffer from inefficient charging methods. Traditional constant-current or constant-voltage charging approaches may generate excessive heat, accelerate battery degradation, and reduce overall battery lifespan. The absence of fast pulse charging technology in conventional systems may result in longer charging times and greater thermal stress on battery cells.

Conventional BTM battery systems may be vulnerable to grid instability. Without a real-time grid monitoring module and an intelligent transfer switch capable of millisecond- level mode transitions, a BTM battery system may be unable to seamlessly transition between grid-connected and off-grid operation during voltage sags, frequency deviations, or complete grid failures. This vulnerability may result in interruptions to critical loads, including medical equipment, security systems, and essential appliances.

Conventional BTM battery systems may also present inadequate cybersecurity measures. IoT-connected energy systems may be vulnerable to unauthorized access, data breaches, and denial-of-service (DoS) attacks. Without end-to-end encryption, multi-factor authentication, intrusion detection, and mesh network security architecture, a BTM battery system may be susceptible to cyberattacks that compromise operational data and control integrity.

The devices, systems, and methods described herein may address each of these technical problems through an integrated, IoT-enabled battery management system (BMS) architecture. This architecture may incorporate IoT controls, Programmable Logic Controllers (PLCs), fast pulse charging technology, open architecture interoperability, grid and off-grid dual-mode operation, artificial intelligence (AI), machine learning (ML), mesh network security, and optional Decentralized Autonomous Organization (DAO) governance into a unified energy storage and management platform.

Referring now to the optional integration of a Decentralized Autonomous Organization (DAO) governance framework within the unified energy storage and management platform, this integration may constitute a distinct optional feature of the platform architecture. The DAO governance framework may be layered atop the communication and energy management architecture described with reference to FIGS. 7 and 8. The DAO governance framework may interface with the cloud synchronization module 232, the energy management module 242, and the IoT module 210 to enable decentralized control and decision-making across distributed battery system nodes within the mesh network 220.

The DAO governance framework may encode governance rules as smart contracts deployed on a blockchain network. Each smart contract may define a discrete governance rule or operational policy applicable to the distributed energy management platform. Governance rules that may be encoded within smart contracts may include energy trading parameters, resource allocation thresholds, load prioritization policies, revenue distribution formulas, and system configuration update procedures. The smart contracts may be stored on a distributed ledger that may be accessible to each participating node within the mesh network 220. The distributed ledger may maintain an immutable record of all governance rules, governance decisions, and transactions executed within the DAO governance framework. The immutability of the distributed ledger may prevent unauthorized modification of governance rules after those rules may have been ratified by the participating nodes.

The DAO governance framework may enable participants to interact with the governance layer through a governance interface. The governance interface may be accessible to participants via the graphical user interface 260 described with reference to FIG. 9. A participant may access the governance interface through the mobile application or web browser through which the graphical user interface 260 may be rendered. The governance interface may present governance proposals, active voting sessions, historical governance decisions, and the current state of deployed smart contracts to a participant. A participant may submit a governance proposal through the governance interface. A governance proposal may specify a proposed modification to an existing governance rule, a proposed new governance rule, or a proposed operational policy change applicable to the distributed energy management platform. The governance interface may transmit the submitted governance proposal to the blockchain network via the IoT module 210 and the cloud synchronization module 232.

Upon submission, a governance proposal may be recorded on the distributed ledger as a pending proposal. Participating nodes within the mesh network 220 may receive notification of the pending proposal via the cloud synchronization module 232. Each participating node may be associated with a governance participant who may hold voting rights within the DAO governance framework. Voting rights may be allocated among governance participants according to a weighting scheme encoded within the smart contracts of the DAO governance framework. The weighting scheme may allocate voting rights based on factors including energy contribution, battery storage capacity, duration of participation in the platform, or other criteria defined within the smart contracts. A governance participant may cast a vote on a pending proposal through the governance interface accessible via the graphical user interface 260. The vote cast by a governance participant may be transmitted to the blockchain network via the IoT module 210 and the cloud synchronization module 232 and may be recorded on the distributed ledger.

The smart contracts of the DAO governance framework may automatically tally votes cast by governance participants upon the conclusion of a voting period. The voting period may be defined within the smart contract governing the proposal type. Upon conclusion of the voting period, the smart contract may evaluate whether the votes cast in favor of the proposal may satisfy a predefined approval threshold. The approval threshold may be encoded within the smart contract and may specify a minimum proportion of affirmative votes required for a proposal to be ratified. If the votes cast in favor of the proposal may satisfy the approval threshold, the smart contract may automatically execute the governance decision encoded in the ratified proposal. The automatic execution of the governance decision may update the relevant operational parameters of the distributed energy management platform without requiring manual intervention by a system administrator.

The execution of a ratified governance decision by the smart contract may propagate updated operational parameters to the energy management module 242 via the cloud synchronization module 232 and the IoT module 210. The energy management module 242 may receive the updated operational parameters and may adjust the behavior of the external device detection module 244, the dynamic signal conversion unit 246, and the intelligent transfer switch 248 in accordance with the ratified governance decision. The BMS controller 204 may also receive updated operational parameters derived from ratified governance decisions via the IoT module 210 and may adjust the operating behavior of the battery module 202, the dynamic signal conversion unit 206, and the fast pulse charger 208 accordingly. The propagation of ratified governance decisions through the energy management architecture may thereby allow the DAO governance framework to exercise decentralized control over the operational behavior of the distributed battery system nodes within the mesh network 220.

The DAO governance framework may further support energy trading among participating nodes within the mesh network 220. Energy trading transactions may be executed through smart contracts deployed on the blockchain network. A participating node that may have surplus stored energy may submit an energy trading offer through the governance interface. The energy trading offer may specify the quantity of energy available for trade, the proposed exchange rate, and any conditions applicable to the transaction.

The DAO governance framework may interface with the anomaly detection module 230 within the secure mesh communication network 220. The anomaly detection module 230 may generate security alerts upon detecting network traffic patterns indicative of cybersecurity threats or unauthorized access attempts within the mesh network 220. The DAO governance framework may receive security alerts transmitted by the anomaly detection module 230 via the cloud synchronization module 232. The smart contracts of the DAO governance framework may define automated response protocols applicable to specific categories of security alerts. Upon receipt of a security alert, the smart contract associated with the applicable response protocol may automatically execute a protective action, which may include isolating a compromised node, suspending energy trading transactions associated with the compromised node, or initiating a governance vote to determine the appropriate remediation action. The execution of automated response protocols by the smart contracts may allow the DAO governance framework to contribute to the cybersecurity posture of the distributed energy management platform without requiring centralized administrative intervention.

The DAO governance framework may also support resource pooling among participating nodes within the mesh network 220. Resource pooling may allow participating nodes to aggregate their stored energy capacity and to coordinate energy dispatch across the pooled resource in accordance with governance rules encoded within the smart contracts. The energy management module 242 may receive resource pooling parameters from the DAO governance framework via the cloud synchronization module 232 and may coordinate energy dispatch among the pooled nodes in accordance with those parameters. The intelligent transfer switch 248 may receive mode-transition commands derived from resource pooling decisions executed by the smart contracts and may route power among the pooled nodes in accordance with those commands. The resource pooling capability of the DAO governance framework may allow the distributed energy management platform to function as a coordinated virtual energy storage asset across multiple geographically distributed battery system installations.

The DAO governance framework may be implemented as an optional component of the unified energy storage and management platform. The platform may operate without the DAO governance framework in deployments where decentralized governance may not be required. In deployments where the DAO governance framework may be activated, the framework may be integrated with the existing communication architecture of the platform through the cloud synchronization module 232 and the IoT module 210 without requiring modification to the local hardware components of the battery management system architecture 200 described with reference to FIG. 6. The DAO governance framework may thereby constitute a software-layer optional feature that may be enabled or disabled at the platform level without affecting the hardware-level operation of the BMS controller 204, the dynamic signal conversion unit 206, the fast pulse charger 208, or the battery module 202.

The encryption module 228 within the secure mesh communication network 220 may apply cryptographic protocols to all data exchanged between the DAO governance framework and the participating nodes of the mesh network 220. The cryptographic protocols applied by the encryption module 228 may include AES-256 for data at rest and TLS for data in transit, consistent with the encryption protocols described with reference to FIG. 7. The application of these cryptographic protocols to DAO governance communications may ensure that governance proposals, votes, smart contract executions, and energy trading transactions may be transmitted between the blockchain network and the participating nodes in a cryptographically secured state. The encryption conversion component 226 may process outbound governance data packets prior to the application of cryptographic protocols by the encryption module 228, consistent with the outbound data transmission pathway described with reference to FIG. 7.

The graphical user interface 260 described with reference to FIG. 9 may present DAO governance information to a participant alongside the real-time operational data fields described in that context. The governance interface accessible through the graphical user interface 260 may display pending governance proposals, active voting sessions, the participant's current voting rights allocation, and the transaction history recorded on the distributed ledger. A participant may interact with the governance interface through the same mobile application or web browser through which the graphical user interface 260 may be accessed. The governance interface may thereby provide a unified access point through which a participant may both monitor the operational state of the battery system and participate in the decentralized governance of the distributed energy management platform.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

IoT, In one embodiment, the devices, systems, and methods described herein may pertain to integrating Internet of Things (IoT) controls to optimize the operation, monitoring, and management of BTM battery systems. Modern energy storage systems may face increasing demands for intelligent, real-time monitoring and management to enhance efficiency, reliability, and user experience. The integration of IoT-enabled controls into BTM battery systems may provide features such as remote monitoring, predictive maintenance, dynamic energy optimization, and integration with broader energy networks and smart grids. Achieving these functionalities may require hardware and software solutions that address challenges such as secure data communication, real-time processing, and cross-platform compatibility.

FIG. 1 illustrates a flowchart of a method for monitoring and controlling a BTM battery system using an IoT module. As shown in FIG. 1, the method may include monitoring battery system parameters, including state of charge (SOC), temperature, and power flow, using an IoT module integrated with the battery system. The method may further include transmitting the monitored parameters to an external platform via a communication network. The method may further include analyzing the transmitted parameters using control algorithms on the external platform. The method may further include generating control signals based on the analysis to optimize battery system performance. The method may further include implementing the control signals on the battery system via the IoT module.

FIG. 8 illustrates a schematic of a battery management system embodiment. As shown in FIG. 8, the system may include a central electronic module communicatively coupled to a smartphone-like user interface device and to a plurality of battery cells arranged in a row along the bottom of the assembly. The central module may include an antenna element suggesting wireless communication capability. The plurality of battery cells may each be individually connected to the central module, enabling per-cell monitoring and control.

In one embodiment, the IoT-enabled control module maybe a dedicated hardware component integrated into the BTM battery system. The IoT-enabled control module may include sensors, processors, and communication interfaces. The IoT-enabled control module may continuously monitor parameters such as SOC, temperature, voltage, and current. The IoT-enabled control module may transmit this data to a centralized or distributed IoT platform. Communication interfaces within the IoT-enabled control module may support multiple protocols, including Wi-Fi, Bluetooth, Zigbee, and cellular connectivity. These communication interfaces may enable seamless integration with other IoT devices and smart grids. A data encryption unit may ensure the secure transmission of information between the battery system and cloud-based platforms. The data encryption unit may protect against unauthorized access and data breaches.

FIG. 9 illustrates a visual display of battery options including voltage, current, temperature, and charging and discharging status. As shown in FIG. 9, the display may present a voltage reading, a current reading, a state of charge percentage, a horizontal bar- graph indicator representing charge level, and a set of operational status fields including delta voltage, average voltage, metal-oxide-semiconductor (MOS) temperature, ambient temperature, alarm status, balance status, charge status, and discharge status. This display may serve as a human-machine interface (HMI) providing on-site operational insights to a user or maintenance technician.

In various embodiments, the IoT-enabled control module may also include a cloud-based IoT platform. The cloud-based IoT platform may aggregate data from multiple BTM battery systems. The cloud-based IoT platform may process aggregated data using machine learning (ML) algorithms. The cloud-based IoT platform may provide actionable insights to users. The cloud-based IoT platform may support real-time data visualization, system diagnostics, and predictive analytics. Mobile and web applications may serve as user interfaces accessible via smartphones or computers. These user interfaces may allow users to monitor battery performance, configure settings, and receive alerts regarding system status or maintenance needs.

In one embodiment, the IoT-enabled control module may further include an edge computing node. The edge computing node may be a local processing unit. The edge computing node may minimize latency by performing real-time analytics and decision- making at the battery system site. The edge computing node may ensure uninterrupted operation in scenarios with limited or no internet connectivity.

The methods associated with IoT integration may include data acquisition and processing. Sensors embedded in the IoT-enabled control module may collect real-time data on the battery's operational status. This data may be transmitted to the edge computing node or cloud platform for processing. Predictive maintenance may be enabled through ML algorithms that analyze historical and real-time data to predict potential failures or maintenance needs. These ML algorithms may send alerts to users or service providers. Dynamic energy optimization may be achieved through continuous monitoring of energy demand, grid conditions, and renewable energy availability. This continuous monitoring may optimize charge and discharge cycles to reduce costs and maximize efficiency. The IoT- enabled control module may also allow for remote configuration. Authorized users may adjust system parameters through mobile or web applications. Robust cybersecurity measures, including multi-factor authentication, data encryption, and intrusion detection, may ensure secure operation and protection of user data.

In various embodiments, the IoT-enabled control module may provide enhanced energy efficiency through intelligent optimization and real-time management. The IoT- enabled control module may provide increased reliability and lifespan of BTM battery systems via predictive maintenance. The IoT-enabled control module may provide an improved user experience through intuitive applications. The IoT-enabled control module may incorporate robust cybersecurity measures to protect sensitive data. The IoT-enabled control module may enable seamless integration with smart grids and other IoT devices for broader energy network interoperability.

### Fast Pulse Charging

In one embodiment, the devices, systems, and methods described herein may pertain to implementing fast pulse charging techniques to enhance battery performance, reduce charging times, and enable seamless integration with IoT-based control and monitoring systems. Efficient energy storage may be particularly relevant in applications requiring rapid energy replenishment, such as backup power systems, load balancing, and renewable energy storage. Fast pulse charging, a technique that delivers high-frequency pulses of electrical current to a battery, may accelerate the charging process, minimize heat generation, and mitigate battery degradation, thereby improving both efficiency and lifespan. Implementing fast pulse charging in BTM battery systems may introduce challenges in control, safety, and integration with existing IoT-based platforms.

FIG. 5 illustrates a flowchart of a method for implementing fast pulse charging using high-frequency electrical pulses, adapting power inputs from multiple sources, detecting grid instability, transitioning between grid-connected and off-grid modes, optimizing energy flow through an IoT platform, and providing real-time data and system control to users. As shown in FIG. 5, the method may include monitoring system parameters, including SOC, temperature, and voltage, using an IoT-enabled device. The method may further include implementing fast pulse charging by generating high-frequency electrical pulses with adjustable characteristics. The method may further include adapting power inputs from multiple sources using a dynamic signal conversion unit. The method may further include detecting grid instability and transitioning between grid-connected and off- grid modes using an intelligent transfer switch. The method may further include optimizing energy flow and system performance through an IoT platform. The method may further include providing real-time data and system control to users through a mobile or web application.

FIG. 10 illustrates how faradaic charging may operate. As shown in FIG. 10, the left-hand diagram may depict charge transfer, wherein ions represented by positive and negative charge symbols may move toward an electrode boundary under the influence of an applied electrical pulse. The right-hand diagram may depict charge storage, wherein a column of charge symbols may accumulate at an electrode surface, representing the stored energy resulting from the faradaic charging process. This illustration may provide context for understanding the electrochemical basis of fast pulse charging as implemented in embodiments described herein.

In one embodiment, the fast pulse charging module may include a high-frequency switching circuit, a current regulation unit, and a thermal monitoring subsystem. The high- frequency switching circuit may generate high-frequency pulses with adjustable amplitudes and durations. These pulses may be tailored to the battery's SOC and chemistry. The current regulation unit may ensure consistent delivery of energy within safe operational limits. The thermal monitoring subsystem may prevent overheating by dynamically adjusting charging parameters based on real-time temperature data.

Integration with IoT systems may be achieved through an intelligent charging controller embedded within the fast pulse charging module. This intelligent charging controller may interface with the BTM system's IoT platform via communication protocols such as Wi-Fi, Zigbee, or cellular networks. The intelligent charging controller may gather real-time battery data, including SOC, voltage, current, and temperature. The intelligent charging controller may transmit this information to the IoT platform. Advanced algorithms running on the IoT platform may analyze the data to optimize charging profiles dynamically. These advanced algorithms may ensure maximum efficiency and minimal stress on the battery. The IoT platform may also enable remote monitoring and configuration of charging parameters. Users may receive detailed insights and control over the charging process through mobile and web applications.

In various embodiments, the fast pulse charging module may further incorporate predictive maintenance capabilities. The IoT platform may use historical and real-time data to identify potential issues, such as capacity fade or abnormal thermal behavior. Alerts and maintenance recommendations may be generated and communicated to users or service providers. Cybersecurity measures, including data encryption, multi-factor authentication, and secure firmware updates, may safeguard the integrity of the charging system and its IoT integration.

The methods associated with fast pulse charging may include the initiation of fast pulse charging based on predefined conditions, such as a low SOC or time-sensitive energy needs. The intelligent charging controller may configure the pulse characteristics dynamically, using data received from the IoT platform. During the charging process, real- time data acquisition and analysis may be performed to adjust the pulse parameters and ensure safe and efficient operation. Upon completion of the charging cycle, a final diagnostic may be conducted to verify the battery's readiness for use. The results of this final diagnostic may be communicated to the user through the IoT interface.

In one embodiment, PLCs may provide pulse charging capabilities. Some PLCs may provide pulse output capabilities in 9VDC, 12VDC, and 24VDC. These pulse outputs may be used to charge and balance battery cells within the IoT-enabled BMS. The PLC pulse charging approach may utilize peer-to-peer mesh input/output (I/0) sharing architecture. This approach may support secure IoT communication, data logging, and sensor integration within the BMS. Maximum current output may reach up to 2.5A. Pulsed relay nodes may offer DC charging to maintain battery cell charge levels. In one example embodiment involving a whole-house battery pack with sixteen batteries, two PLC units may be employed to manage the pulse charging and balancing functions across the battery array.

Embodiments incorporating fast pulse charging may provide advantages including faster charging times, reduced heat generation, extended battery lifespan, and enhanced user control through IoT integration. By combining fast pulse charging technology with IoT-enabled monitoring and control systems, the technical challenges in BTM battery systems associated with charging efficiency and thermal management may be addressed. Open Architecture Compatibility with Other Devices

In one embodiment, the devices, systems, and methods described herein may pertain to implementing fast pulse charging with an open architecture to enable compatibility with a wide range of inverters and power sources, including grid power, solar generators, wind turbines, geothermal systems, hydrothermal systems, other batteries, and electric vehicles. Modern energy storage systems may accommodate diverse power sources and operational scenarios to maximize efficiency, flexibility, and usability. Integrating fast pulse charging with an open-architecture system capable of interfacing with various power sources and inverters may present technical challenges, including power signal compatibility, safety concerns, and real-time control.

FIG. 2 illustrates a flowchart of a method for detecting and identifying external devices connected to the battery system, adapting power characteristics using a dynamic signal conversion unit, transmitting compatibility and energy flow data to an external platform, processing the data to generate optimized energy management strategies, and adjusting energy flow in real time. As shown in FIG. 2, the method may include monitoring battery system parameters, including SOC, temperature, and power flow, using an IoT module integrated with the battery system. The method may further include transmitting the monitored parameters to an external platform via a communication network. The method may further include analyzing the transmitted parameters using control algorithms on the external platform. The method may further include generating control signals based on the analysis to optimize battery system performance. The method may further include implementing the control signals on the battery system via the IoT module.

FIG. 3 illustrates a flowchart of a method for detecting and identifying external devices connected to the battery system. As shown in FIG. 3, the method may include detecting and identifying external devices connected to the battery system using an external device detection module. The method may further include adapting input and output power characteristics using a dynamic signal conversion unit to match the requirements of the connected devices. The method may further include transmitting compatibility and energy flow data to an external platform via a communication network. The method may further include processing the compatibility data to generate optimized energy management strategies. The method may further include adjusting energy flow between the battery system and the connected devices based on real-time operational parameters.

In one embodiment, the open architecture may be achieved through a fast pulse charging module designed for broad interoperability. The fast pulse charging module may include a high-frequency switching circuit, a power conditioning unit, and a dynamic signal conversion system. The high-frequency switching circuit may generate precise electrical pulses optimized for the battery's chemistry and SOC. The power conditioning unit may ensure compatibility with input power characteristics. The power conditioning unit may stabilize voltage and current to maintain charging efficiency. The dynamic signal conversion system may adapt the input from diverse power sources into a standardized format suitable for fast pulse charging.

To address interoperability challenges, the open architecture embodiment may incorporate advanced power source recognition algorithms. These algorithms may be embedded within the charging controller. These algorithms may automatically detect and adapt to the characteristics of the connected power source, whether AC from grid power, DC from solar panels, or variable input from wind or hydrothermal systems. The charging controller may dynamically adjust charging profiles to ensure optimal performance across all scenarios. The system may include safety mechanisms, such as voltage clamping, thermal monitoring, and isolation circuits, to protect against overvoltage, overheating, and cross- system interference.

The open architecture may be further achieved through a modular design and standardized communication protocols. The system may use industry-standard interfaces, such as Modbus, CAN, or IEEE 2030.5, to facilitate seamless integration with inverters, power sources, and IoT platforms. This modular approach may allow the battery system to connect directly to diverse devices, including other batteries and electric vehicles, enabling bi- directional energy transfer and advanced energy management.

Integration with electric vehicles (EVs) may present a challenge due to varying charging standards and power requirements across manufacturers. To address this, the open architecture embodiment may include a configurable power handshake protocol. This configurable power handshake protocol may automatically negotiate voltage and current levels with the connected EV. For renewable energy sources like wind and solar, the system may incorporate maximum power point tracking (MPPT) to optimize energy transfer efficiency.

Referring now to FIGS. 8 and 9, the configurable power handshake protocol may be described as a distinct interoperability feature of the energy management system architecture 240. The configurable power handshake protocol may be implemented within the external device detection module 244 and the dynamic signal conversion unit 246. The configurable power handshake protocol may enable the energy management system architecture 240 to interface with electric vehicles (EVs) of diverse makes, models, and charging standards without requiring manual configuration by a user.

The configurable power handshake protocol may be initiated upon detection of an EV connected to the battery system by the external device detection module 244. The external device detection module 244 may detect the presence of a connected EV by monitoring the electrical characteristics present at the connection interface. Upon detecting a connected EV, the external device detection module 244 may initiate a parameter exchange sequence. The parameter exchange sequence may constitute the first phase of the configurable power handshake protocol.

During the parameter exchange sequence, the external device detection module 244 may transmit a query signal to the connected EV. The query signal may request identification data from the connected EV. The identification data returned by the connected EV may include the EV's maximum charge voltage, maximum charge current, minimum charge voltage, minimum charge current, battery chemistry type, state of charge, and communication protocol identifier. The external device detection module 244 may receive the identification data returned by the connected EV and may forward that data to the dynamic signal conversion unit 246. The dynamic signal conversion unit 246 may also receive the identification data from the external device detection module 244 for use in adapting its electrical output parameters.

The configurable power handshake protocol may accommodate a plurality of EV charging standards. EV charging standards that the configurable power handshake protocol may accommodate include, but are not limited to, the Combined Charging System (CCS), the CHAdeMO protocol, the GB/T standard, and the North American Charging Standard (NACS). Each of these charging standards may define a distinct set of communication parameters, voltage ranges, current limits, and handshake sequences. The configurable power handshake protocol may identify the charging standard associated with the connected EV based on the communication protocol identifier included in the identification data returned during the parameter exchange sequence. Upon identifying the applicable charging standard, the configurable power handshake protocol may select a corresponding communication profile from a device compatibility profile library stored in the memory of the IoT module 210. The selected communication profile may define the specific message formats, timing sequences, and parameter ranges applicable to the identified charging standard.

The negotiation process performed by the configurable power handshake protocol may proceed in a plurality of stages following the initial parameter exchange sequence. In a first negotiation stage, the energy management system architecture 240 may transmit a capability advertisement to the connected EV. The capability advertisement may specify the voltage range, current range, and power delivery capacity available from the battery system. The connected EV may receive the capability advertisement and may respond with a charge request message. The charge request message may specify the voltage setpoint, current setpoint, and maximum power level requested by the connected EV for the charging session.

In a second negotiation stage, the dynamic signal conversion unit 246 may evaluate the voltage setpoint and current setpoint specified in the charge request message. The dynamic signal conversion unit 246 may compare the requested voltage setpoint and current setpoint against the operating limits of the battery system. If the requested parameters may fall within the operating limits of the battery system, the dynamic signal conversion unit 246 may transmit an acknowledgment message to the connected EV confirming the negotiated voltage and current levels. If the requested parameters may exceed the operating limits of the battery system, the dynamic signal conversion unit 246 may transmit a counter-offer message to the connected EV specifying revised voltage and current levels within the operating limits of the battery system. The connected EV may receive the counter-offer message and may respond with either an acceptance message or a revised charge request message. This iterative exchange may continue until both the battery system and the connected EV may reach a mutually acceptable set of voltage and current parameters.

Upon completion of the negotiation process, the dynamic signal conversion unit 246 may adapt its output to match the negotiated voltage and current levels. The dynamic signal conversion unit 246 may adjust its voltage conversion parameters to deliver the negotiated voltage setpoint to the connected EV. The dynamic signal conversion unit 246 may also adjust its current regulation parameters to deliver the negotiated current setpoint to the connected EV. These adjustments may be performed dynamically by the dynamic signal conversion unit 246 in real time as the charging session progresses. The dynamic signal conversion unit 246 may continuously monitor the voltage and current delivered to the connected EV during the charging session. If the monitored voltage or current may deviate from the negotiated setpoints, the dynamic signal conversion unit 246 may adjust its conversion parameters to restore the delivered values to the negotiated levels.

The configurable power handshake protocol may also support bidirectional energy transfer between the battery system and the connected EV. In a vehicle-to-grid (V2G) or vehicle-to-home (V2H) operating mode, the connected EV may supply electrical energy to the battery system rather than receiving it. The configurable power handshake protocol may accommodate this bidirectional energy transfer by including a direction parameter in the parameter exchange sequence. The direction parameter may specify whether the connected EV may be operating in a charge-receiving mode or an energy-supplying mode. The dynamic signal conversion unit 246 may adapt its conversion parameters in response to the direction parameter to support energy flow in the appropriate direction between the battery system and the connected EV.

The energy management module 242 may coordinate the configurable power handshake protocol with the overall energy dispatch strategy of the energy management system architecture 240. The energy management module 242 may receive the negotiated voltage and current parameters from the dynamic signal conversion unit 246 following completion of the negotiation process. The energy management module 242 may incorporate the negotiated parameters into its energy dispatch calculations to determine the appropriate power routing configuration for the charging session. The energy management module 242 may direct the intelligent transfer switch 248 to route power between the battery system and the connected EV in accordance with the negotiated parameters and the energy dispatch strategy.

The IoT module 210 may transmit data associated with the configurable power handshake protocol to the external platform via the communication network. The data transmitted by the IoT module 210 may include the identification data received from the connected EV, the negotiated voltage and current parameters, the identified charging standard, and the real-time voltage and current values monitored by the dynamic signal conversion unit 246 during the charging session. The external platform may analyze the transmitted data using control algorithms and may generate control signals for transmission back to the energy management system architecture 240 via the IoT module 210. The energy management module 242 may receive these control signals and may adjust the energy dispatch strategy or the negotiated parameters in response.

The graphical user interface 260, as described with reference to FIG. 9, may display information associated with the configurable power handshake protocol to a user. The EV region 264 of the graphical user interface 260 may be selectable by a user to initiate or monitor an EV charging session. Upon selection of the EV region 264, the graphical user interface 260 may display the identified charging standard, the negotiated voltage and current parameters, the real-time state of charge of the connected EV as reported during the parameter exchange sequence, and the current power delivery status of the charging session. The graphical user interface 260 may also display an indication of whether the configurable power handshake protocol may be in progress, whether the negotiation process may have been completed, or whether a counter-offer exchange may be underway between the battery system and the connected EV.

The configurable power handshake protocol may operate in conjunction with the maximum power point tracking (MPPT) function of the dynamic signal conversion unit 246 when the battery system may be simultaneously receiving power from a solar generation source. The dynamic signal conversion unit 246 may manage the MPPT function for the solar input pathway concurrently with the configurable power handshake protocol for the EV connection pathway. The energy management module 242 may coordinate the power allocation between the solar input pathway and the EV charging pathway based on the negotiated parameters and the real-time power availability from the solar generation source.

The configurable power handshake protocol may further support the detection of anomalous conditions during the EV charging session. The dynamic signal conversion unit 246 may monitor the voltage and current delivered to the connected EV on a continuous basis during the charging session. If the monitored values may deviate from the negotiated setpoints by an amount exceeding a predefined tolerance threshold, the dynamic signal conversion unit 246 may generate an anomaly alert. The anomaly alert may be transmitted to the energy management module 242. The energy management module 242 may respond to the anomaly alert by suspending the charging session, transmitting a revised counter-offer message to the connected EV, or directing the intelligent transfer switch 248 to interrupt the power pathway between the battery system and the connected EV. The anomaly alert may also be transmitted to the external platform via the IoT module 210 and may be displayed to a user through the graphical user interface 260.

The configurable power handshake protocol may be applicable across the operating environments described with reference to FIGS. 3, 5, and 8. In the external device detection and adaptive power management operating environment of FIG. 3, the configurable power handshake protocol may correspond to the process depicted at step 142, where the external device detection module may detect and identify the connected EV, and at step 144, where the dynamic signal conversion unit may adapt the power characteristics to match the requirements of the connected EV. In the multi-function operating environment of FIG. 5, the configurable power handshake protocol may be performed as part of the dynamic signal conversion function depicted at the process block labeled 144 in FIG. 5. In the energy management system architecture 240 of FIG. 8, the configurable power handshake protocol may be performed through the coordinated operation of the external device detection module 244, the dynamic signal conversion unit 246, and the energy management module 242.

The device compatibility profile library stored in the memory of the IoT module 210 maybe updated remotely via the external platform. The external platform may transmit updated device compatibility profiles to the IoT module 210 via the communication network. The IoT module 210 may store the updated profiles in its memory. The updated profiles may include compatibility data for newly released EV models or newly adopted charging standards. This remote update capability may allow the configurable power handshake protocol to accommodate EV makes and models that may not have been available at the time of initial deployment of the energy management system architecture 240, thereby extending the interoperability of the battery system over its operational lifetime without requiring physical modification of the hardware.

The configurable power handshake protocol may thereby constitute a distinct interoperability feature of the energy management system architecture 240 that may enable the battery system to automatically negotiate voltage and current levels with connected EVs, accommodate varying EV charging standards, and adapt its output in real time to match the requirements of the connected EV across a diverse range of EV makes and models.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

Power sources may have inconsistent output characteristics, such as variable frequency or voltage fluctuations. Real-time communication and control between the battery system and external devices may be relevant to maintaining efficiency and safety, particularly when switching between sources or operating in hybrid configurations. To address these challenges, the open architecture embodiment may provide adaptive power conditioning to ensure stable input characteristics regardless of fluctuations in the source. Real-time control algorithms may manage charging parameters dynamically, using data from sensors and IoT platforms to adjust for changing conditions. Advanced isolation techniques, such as galvanic isolation and noise suppression, may prevent cross-system interference and protect sensitive components.

The open architecture embodiment may also leverage IoT integration to enhance its capabilities. The IoT platform may collect data from the battery system and connected power sources. ML algorithms may predict energy demands and optimize charging strategies. Through mobile and web applications, users may monitor system performance, configure settings, and receive alerts about maintenance or potential issues.

A device compatibility profile library may be stored in memory. This library may enable automatic recognition and adaptation to newly connected devices. An external device detection module may automatically identify connected devices and adapt system operation accordingly. The system may support simultaneous connections to multiple power sources and may prioritize renewable energy input when available.

In various embodiments, the open architecture may provide advantages including compatibility with a broad range of power sources and inverters, reduced deployment costs, and enhanced flexibility for residential, commercial, and industrial applications. The open architecture may also enable the battery system to be retrofitted into existing residential electrical panels, solar arrays, all inverters, and generator systems in most cases, eliminating the need for costly infrastructure changes.

### Grid and Off-Grid Options

In one embodiment, the devices, systems, and methods described herein may pertain to enabling seamless operation of battery systems both on-grid and off-grid, with the ability to transition between grid-connected and off-grid modes in response to grid instability, power brownouts, or failures. Modern energy systems, particularly in areas with unstable grids, may require robust and adaptive solutions to ensure uninterrupted power supply. BTM battery systems may play a role in this by providing backup power, load balancing, and energy storage. Existing systems may suffer from delays or disruptions during transitions between grid-connected and off-grid operation, leading to interruptions in critical loads.

FIG. 4 illustrates a flowchart of a method for monitoring grid conditions, detecting grid instability, transitioning the battery system between grid-connected and off-grid modes using an intelligent transfer switch, prioritizing power delivery to critical loads, and transmitting operational data to an external platform for user monitoring. As shown in FIG. 4, the method may include monitoring grid conditions in real time using a grid monitoring module. The method may further include detecting grid instability, including voltage or frequency fluctuations. The method may further include transitioning the battery system from grid-connected mode to off-grid mode using an intelligent transfer switch. The method may further include prioritizing power delivery to critical loads during off-grid operation. The method may further include transitioning the battery system back to grid-connected mode when stability is restored. The method may further include transmitting operational data to an external platform for analysis and user monitoring.

In one embodiment, the grid and off-grid compatibility embodiment may feature a dual-mode battery system designed for seamless operation in both grid-connected and off- grid configurations. The system may include a real-time grid monitoring module, an intelligent transfer switch, and a hybrid inverter. The real-time grid monitoring module may continuously assess grid conditions by analyzing voltage, frequency, and power quality. Upon detecting instability, such as voltage sags, frequency deviations, or a complete grid failure, the real-time grid monitoring module may send a signal to the intelligent transfer switch.

The intelligent transfer switch may be a fast-acting device. The intelligent transfer switch may be capable of transitioning the battery system from grid-connected to off-grid operation within milliseconds. The intelligent transfer switch may be designed with advanced solid-state relay technology to minimize transition delays and ensure a smooth handover without power interruptions. The hybrid inverter may manage the conversion of DC power from the battery to AC power for off-grid loads. The hybrid inverter may ensure stable and reliable power delivery.

To enable rapid transitions, the system may incorporate advanced energy management algorithms. These algorithms may predict grid instability by analyzing historical data, real-time sensor inputs, and patterns of grid behavior. This predictive capability may allow the system to preemptively prepare for transitions. The system may ensure that critical loads are prioritized and that the battery is optimally charged and ready for off-grid operation. During brownouts or grid outages, the system may activate a load prioritization protocol. This load prioritization protocol may ensure that devices and circuits designated as critical receive uninterrupted power.

In various embodiments, the grid and off-grid compatibility embodiment may also support bi-directional energy flow. The battery system may supply power to the grid during stable conditions. The battery system may isolate itself when grid instability is detected. This may be achieved through a power electronics module equipped with advanced synchronization and anti-islanding capabilities. The synchronization function may ensure that the battery system operates in phase with the grid during normal conditions. The anti- islanding function may prevent back-feeding during grid outages, enhancing safety.

One challenge in designing such a system may be achieving the speed and reliability required for rapid switching. Conventional mechanical switches may be too slow for this application. Solid-state switches may be carefully designed to handle high power levels without overheating or introducing electrical noise. The grid and off-grid compatibility embodiment may address these challenges by using high-performance semiconductors, such as silicon carbide (SiC) or gallium nitride (GaN), in the intelligent transfer switch. These semiconductors may ensure rapid and efficient operation. The hybrid inverter may be designed with advanced cooling systems and robust power electronics to maintain performance under varying load conditions.

Another challenge may be maintaining stable operation during transitions, particularly in regions with highly fluctuating grid voltages. The grid and off-grid compatibility embodiment may overcome this by integrating a dynamic voltage restorer (DVR) within the system. The DVR may smooth out voltage fluctuations and provide a stable output to critical loads during switching events.

Integration with IoT systems may provide additional functionality and user control. The IoT platform may collect data from the real-time grid monitoring module, intelligent transfer switch, and hybrid inverter. Users may monitor system status, configure operational settings, and receive alerts about grid conditions or system performance. Through ML algorithms, the IoT platform may optimize energy usage and provide insights into battery health and grid reliability.

FIG. 11 illustrates a schematic of how a hybrid DC microgrid may operate, incorporating both DC and AC inputs and outputs. As shown in FIG. 11, the schematic may depict a block diagram with multiple interconnected components representing power generation, energy storage, load-side integration, and control and protection systems, arranged around a central cluster of panels. This schematic may illustrate the broader system context within which the grid and off-grid compatibility embodiment may operate.

In various embodiments, the grid and off-grid compatibility embodiment may provide advantages including uninterrupted power delivery in areas with unstable grids, enhanced user confidence in renewable energy systems, and reduced dependency on external backup systems such as diesel generators. The rapid switching capability may minimize disruptions to critical applications, making the system suitable for residential, commercial, and industrial use.

### Comprehensive Battery System

In various embodiments, the battery system described herein may integrate IoT integration, fast pulse charging, open architecture, and grid and off-grid compatibility to deliver a seamless energy management solution. FIGS. 13a, 13b, 13c, and 13d, illustrate the BMS housing, the BMS connected to a residential meter, the BMS connected to a home generator, and the battery pack being assembled, respectively. As shown in FIG. 13a, the battery system housing may include a rounded rectangular outer front cover, an inner battery cover, a battery array of eighteen batteries arranged in a grid, a display, control buttons, and a set of ports. The battery pack may be assembled with individual battery cells connected to a central BMS module, as illustrated in FIG. 13a.

Each component of the comprehensive battery system may interact dynamically. IoT integration may provide real-time monitoring and control, enabling predictive maintenance and system optimization. Fast pulse charging may ensure rapid energy replenishment while preserving battery health. Open architecture may support compatibility with diverse power sources and external devices. Grid and off-grid compatibility may ensure uninterrupted power delivery, even in unstable grid conditions. The external IoT platform may collect data from all components, process it using ML algorithms, and generate actionable insights. The system may operate autonomously, with user oversight enabled through intuitive mobile and web interfaces.

In one embodiment, the battery system may feature an IoT-enabled control module that includes a communication interface supporting protocols such as Wi-Fi, Zigbee, Modbus, and IEEE 2030.5. This IoT-enabled control module may monitor parameters such as SOC, voltage, temperature, and power flow. The IoT-enabled control module may transmit data to an external IoT platform, where ML algorithms may analyze historical and real-time data to predict maintenance needs, optimize energy flow, and provide actionable insights. The IoT platform may be accessible via a mobile or web-based user interface. Users may monitor battery performance, configure system settings, and receive notifications of abnormal conditions or required maintenance. To ensure secure data transmission, the communication interface may incorporate encryption protocols, multi-factor authentication, and intrusion detection systems.

In various embodiments, the comprehensive battery system may incorporate a fast pulse charging module. A high-frequency switching circuit may generate pulses with adjustable amplitude, frequency, and duration to optimize charging efficiency. A pulse control module may dynamically adjust the pulse characteristics based on battery chemistry, SOC, and temperature. A thermal management system, including active cooling such as fans or liquid cooling, may dissipate heat generated during charging. An overcurrent protection circuit may protect against damage during high-speed charging cycles.

The comprehensive battery system may feature open architecture enabled by a dynamic signal conversion unit and universal communication protocols. This design may ensure compatibility with grid power for charging and energy supply, renewable energy sources including solar, wind, and geothermal systems, electric vehicles for bi-directional energy transfer, and other batteries for modular or distributed energy systems. The dynamic signal conversion unit may stabilize and standardize input and output power, ensuring seamless integration. The system may support simultaneous connections to multiple power sources and may prioritize renewable input when available. A library of device compatibility profiles stored in memory may allow the system to recognize and adapt to newly connected devices.

In various embodiments, the comprehensive battery system may provide grid and off-grid compatibility through a hybrid inverter, a real-time grid monitoring module, an intelligent transfer switch, and a load prioritization module. The hybrid inverter may support bi-directional energy flow in grid-connected and off-grid modes. The real-time grid monitoring module may detect grid instability, such as voltage sags or frequency deviations. The intelligent transfer switch may transition the system between grid-connected and off- grid modes within milliseconds. The load prioritization module may ensure uninterrupted power to critical devices during off-grid operation. The anti-islanding functionality of the hybrid inverter may prevent back-feeding into the grid, enhancing safety.

Achieving such integration may present several technical challenges. Power sources may have variable output characteristics, such as fluctuating voltage or frequency. This may be addressed by incorporating a dynamic power conditioning unit that stabilizes inputs and protects the battery system from damage. Real-time control and communication may require low-latency processing, which may be achieved through edge computing nodes that offload critical tasks from the cloud platform. Ensuring cybersecurity in an open architecture system may be addressed through robust encryption, secure authentication mechanisms, and intrusion detection to safeguard data and operational integrity.

Another challenge may be maintaining efficient operation while supporting diverse power sources and modes. Adaptive algorithms within the PLCs and IoT platform may enable dynamic reconfiguration of charging and discharging profiles based on input and load conditions. When multiple power sources are connected, the system may prioritize renewable energy inputs, such as solar or wind, while maintaining a stable power supply to critical loads.

Scalability and modularity may be addressed through the system's modular design. Components may be added or replaced without disrupting the overall system, ensuring flexibility and ease of maintenance. The system may be deployed in residential, commercial, and industrial settings. The battery system may be scalable up to 320 kW. In one embodiment, the battery system may operate at 48V nominal voltage, with a 51.2V actual operating voltage, using lithium iron phosphate (LiFePO4) chemistry. The system may provide 15 kW of continuous power and 20 kW of peak power. The system may maintain approximately 79% capacity retention at ten years of operation.

The following table may illustrate a comparison of the commercial capabilities of an embodiment of the battery system described herein versus existing battery systems:

| Feature | Proposed Embodiment | Tesla Powerwall 3 | Franklin 15kWh | Enphase IQ Battery 10T | Generac PWRcell 18kWh |

|---|---|---|---|---|---|

| Price Per kW | Q10 | $779.70 | $1,333.33 | $2,833.33 | $3,428.57 |

| Chemistry | LiFePO4 | LiFePO4 | LiFePO4 | Lithium | Lithium NMC |

| Inverter Onboard | No / Works with any 48V inverter | Yes, limited to solar controller | Yes, Generator and Grid only | No | Yes, Bi-Directional including solar |

| Continuous Power / Peak Power | 15 kW / 20 kW | 13.5 kW / — | 15 kW / — | 10.3 kW / — | 18 kW / 20 kW |

BMS with Remote Access | Yes, IoT app-driven and remote access included | Yes, app-driven | Yes, app-driven | No, optional | Yes |

| Battery Charger | Yes, 48V + 3x transfer switch | No | No | No | No |

| Warranty | 10 Years | 10 Years | 12 Years | 10 Years | 10 Years |

| AC/DC Coupling | AC or DC | AC or DC | AC only | AC or DC | DC |

| Capacity at 10 Years | 79% | 70% | 73% | 68% | 74% |

| Scalable Up To | 320 kW | 60 kW | 204.1 kW | 100 kW | 38 kW |

This comparison may illustrate that embodiments of the battery system described herein may provide a broader range of inverter compatibility, higher scalability, greater capacity retention, and more comprehensive IoT-enabled remote access than competing commercial systems.

### Inverter-Less System

In one embodiment, the devices, systems, and methods described herein may pertain to a battery management system (BMS) that eliminates the need for an inverter, thereby enhancing efficiency, reducing energy conversion losses, and streamlining power delivery. The system may be controlled via a Programmable Logic Controller (PLC) to optimize battery operation and power distribution in various applications, such as industrial energy storage, electric vehicles, and renewable energy integration. Traditional battery management systems may rely on inverters to convert DC power stored in batteries into alternating current (AC) before usage. This conversion process may lead to energy losses, system complexity, and increased maintenance requirements. By eliminating the inverter and directly managing DC power, the inverter-less embodiment may improve overall system performance and reliability.

In one embodiment, the inverter-less BMS may include a battery module, a PLC- controlled switching system, a direct DC power distribution network, and a communication and control interface. The battery module may serve as the core energy storage component of the system. The battery module may consist of a modular battery pack designed to operate within a wide range of voltage and current specifications, depending on application needs. Integrated battery monitoring sensors may continuously track voltage, current, temperature, and SOC to provide real-time feedback to the PLC. These sensors may ensure precise control over the energy storage process, enabling adaptive load distribution and protection against overcharging or excessive discharge.

The PLC-controlled switching system may feature a high-speed PLC that dynamically regulates power distribution. The PLC may govern solid-state relays and contactors to control energy flow based on real-time data. Embedded control algorithms may facilitate real-time power balancing, load prioritization, and fault detection, ensuring seamless operation and preventing energy waste.

The direct DC power distribution network may eliminate the need for intermediate AC conversion. The direct DC power distribution network may directly supply power to DC-compatible loads. This network may include voltage regulation components such as buck-boost converters and charge controllers, which may maintain stable power delivery across various operating conditions. The elimination of AC conversion stages may significantly reduce energy loss and enhance system efficiency.

The communication and control interface may enable real-time system monitoring and user interaction. The communication and control interface may feature an HMI that provides operational insights, status updates, and manual control options. The system may support industrial communication protocols such as MODBUS and CAN bus for seamless integration with external energy management systems. Remote monitoring capabilities may allow for predictive maintenance and historical data logging, further enhancing system reliability.

The operational workflow of the inverter-less BMS may begin with battery monitoring, where the PLC may continuously receive data from integrated battery sensors to assess SOC, temperature, and voltage. If a battery reaches critical charge thresholds, the system may dynamically redistribute power or activate charge regulation mechanisms to maintain safe operating conditions.

Load prioritization and power allocation may be managed by the PLC. The PLC may evaluate power demand from connected loads and optimize energy distribution accordingly. Critical loads may receive priority based on predefined algorithms, ensuring uninterrupted operation of designated components while maximizing overall energy efficiency.

Voltage regulation and stability may be maintained through dynamic adjustments to DC output via electronic regulators. These electronic regulators may eliminate voltage fluctuations that could impact connected devices and may ensure stable power supply to all components. Adaptive power routing may further enhance efficiency by directing energy where it may be needed most.

Fault detection and safety mechanisms may be incorporated into the PLC. The PLC may continuously monitor the system for anomalies such as overvoltage, overcurrent, and thermal deviations. In the event of potential failures, automated shutdown or rerouting mechanisms may activate to prevent damage and ensure operational safety.

Integration with renewable energy sources may be a fundamental aspect of the inverter-less BMS. The system may allow seamless connection with solar panels, wind turbines, and other alternative energy sources. Direct DC charging mechanisms may improve energy efficiency by eliminating unnecessary AC conversions, facilitating more effective utilization of renewable power.

The role of the inverter-less BMS in microgrids may be particularly significant. The inverter-less BMS may offer a grid-agnostic solution that may operate independently within a microgrid, integrate with a main grid, and function at the interface between microgrids and the main grid. Within a microgrid, the inverter-less BMS may enhance operational efficiency by ensuring direct and optimized power distribution, reducing energy losses, and improving system reliability. The PLC-controlled switching mechanism may enable dynamic load management, allowing for prioritized power allocation to critical infrastructure while maintaining stable microgrid operations.

When operating within the main grid, the inverter-less BMS may contribute to grid stability by providing a highly efficient energy storage and distribution solution that may respond in real time to fluctuations in demand. The ability to bypass AC conversion may further reduce transmission losses and ensure more efficient power utilization across the grid. By eliminating inverters, the system may simplify grid integration and reduce the risk of inverter-based synchronization issues that may arise in complex grid environments.

At the interface between microgrids and the main grid, the inverter-less BMS may provide a highly adaptive energy transfer solution. The PLC may continuously monitor power flow between the microgrid and the main grid, optimizing charge and discharge cycles to maximize energy efficiency. This may allow for better load balancing, improved grid resilience, and enhanced response to peak demand scenarios. The direct DC power architecture may also facilitate smoother integration with renewable energy sources, ensuring seamless power exchange between interconnected grid segments.

In various embodiments, the inverter-less BMS may provide advantages including higher efficiency by eliminating energy losses associated with DC-AC conversion, increased reliability through the reduction of system complexity and failure points, and cost reduction by removing the need for inverters and their associated maintenance costs. The system may be highly scalable, making it suitable for industrial, automotive, and residential applications. The system may seamlessly integrate with modern industrial communication protocols and renewable energy sources. Solar-Powered Microgrid Integration

In various embodiments, the devices, systems, and methods described herein may enable the creation of a solar-powered microgrid using an inverter-less BMS. A solar microgrid powered by this system may integrate direct DC energy from solar photovoltaic (PV) panels with modular energy storage, thereby eliminating unnecessary AC-DC-AC conversions that may contribute to energy losses. The use of a multi-bus DC framework with optimized energy distribution may improve reliability, making it particularly suited for off- grid, disaster-prone, and rural applications.

In such a system, solar panels may generate DC electricity, which may be directly stored in modular battery units managed by the PLC. The battery storage system may intelligently distribute energy based on real-time demand and SOC levels. This architecture may increase efficiency by reducing the energy losses that may occur with AC power conversion. The microgrid may operate independently from the main grid, reducing risks associated with grid failures. Solar PV panels and batteries may both operate in DC, eliminating the need for additional conversion steps. The system may be scalable for both residential and commercial energy applications, allowing modular expansions for increased storage and generation capacity.

The solar-powered microgrid system may incorporate MPPT controllers for optimizing solar energy capture, adaptive DC-DC converters for voltage regulation, and an IoT-enabled BMS for predictive load management and fault detection.

Referring now to the energy management system architecture 240 of FIG. 8, maximum power point tracking (MPPT) may be incorporated as a renewable energy optimization feature within the open architecture energy management system. MPPT may be implemented within the dynamic signal conversion unit 246 as a functional capability that may operate in conjunction with the external device detection module 244, the energy management module 242, and the BMS controller 204. The MPPT function may apply to renewable energy sources including solar photovoltaic panels and wind turbines that may be connected to the battery system as external devices detected by the external device detection module 244.

The dynamic signal conversion unit 246 may incorporate MPPT algorithms that may continuously adjust the operating point of a connected renewable energy source to maximize power transfer efficiency under varying environmental conditions. For a solar photovoltaic source, the operating point may be defined by the voltage and current at which the solar panel may operate at any given instant. The power output of a solar panel may vary as a function of incident solar irradiance, cell temperature, and shading conditions. The MPPT algorithm executing within the dynamic signal conversion unit 246 may continuously sample the voltage and current output of the connected solar panel and may compute the instantaneous power at the operating point. The dynamic signal conversion unit 246 may then adjust the impedance presented to the solar panel by modifying its input conversion parameters, thereby shifting the operating point along the current-voltage characteristic curve of the solar panel toward the maximum power point.

For a wind turbine source, the operating point may be defined by the rotational speed and electrical output characteristics of the turbine generator at any given wind speed. Wind turbine output may vary as a function of wind speed, rotor blade pitch, and generator loading. The MPPT algorithm executing within the dynamic signal conversion unit 246 may continuously monitor the electrical output of the connected wind turbine and may adjust the loading presented to the turbine generator to maintain operation at or near the maximum power point across a range of wind speeds. The dynamic signal conversion unit 246 may implement this adjustment by modifying its input voltage conversion parameters in real time as wind speed conditions change.

The MPPT function within the dynamic signal conversion unit 246 may employ a perturbation and observation algorithm. The perturbation and observation algorithm may operate by incrementally adjusting the operating voltage of the renewable energy source and observing the resulting change in output power. If the power may increase following a voltage perturbation, the dynamic signal conversion unit 246 may continue perturbing the operating voltage in the same direction. If the power may decrease following a perturbation, the dynamic signal conversion unit 246 may reverse the direction of the voltage perturbation. This iterative process may allow the dynamic signal conversion unit 246 to track the maximum power point continuously as environmental conditions change. In alternative embodiments, the dynamic signal conversion unit 246 may employ an incremental conductance algorithm or a constant voltage algorithm as the MPPT tracking method, depending on the characteristics of the connected renewable energy source and the rate of change of environmental conditions.

The MPPT function may interact with the BMS controller 204 through the energy management module 242. The dynamic signal conversion unit 246 may transmit real-time power output data from the connected renewable energy source to the energy management module 242. The energy management module 242 may relay this data to the BMS controller 204. The BMS controller 204 may use the received power output data to adjust the charge acceptance parameters of the battery module 202, ensuring that the battery module 202 may receive the maximum available power from the renewable energy source as tracked by the MPPT algorithm. The BMS controller 204 may also transmit the MPPT power output data to the IoT module 210 for relay to the external platform, enabling the external platform to monitor the efficiency of the MPPT function and to generate control signals that may further optimize the operating parameters of the dynamic signal conversion unit 246.

The interaction between the MPPT function and the BMS controller 204 may also include a coordination mechanism for managing the state of charge of the battery module 202 in relation to the available renewable energy input. When the state of charge of the battery module 202 may approach a fully charged condition, the BMS controller 204 may transmit a charge regulation signal to the energy management module 242. The energy management module 242 may relay this signal to the dynamic signal conversion unit 246, which may adjust the MPPT operating point to reduce the power drawn from the renewable energy source to a level consistent with the charge regulation requirements of the battery module 202. This coordination may prevent overcharging of the battery module 202 while maintaining the MPPT function in an active tracking state.

The MPPT function may further interact with the intelligent transfer switch 248 within the energy management system architecture 240. When the intelligent transfer switch 248 may transition the battery system between grid-connected and off-grid operating modes, the dynamic signal conversion unit 246 may adjust the MPPT tracking parameters to account for the change in load conditions presented to the renewable energy source. In grid- connected mode, the renewable energy source may supply power to both the battery module 202 and the utility grid, and the MPPT algorithm may track the maximum power point under the combined loading condition. In off-grid mode, the renewable energy source may supply power exclusively to the battery module 202 and connected loads, and the MPPT algorithm may adjust its tracking parameters to reflect the modified loading condition. The dynamic signal conversion unit 246 may perform this adjustment in real time as the intelligent transfer switch 248 may execute the mode transition, such that the MPPT function may remain active and tracking throughout the transition.

The MPPT function may be accessible to a user through the graphical user interface 260 described with reference to FIG. 9. When a user may select the solar power source option 262 within the graphical user interface 260, the energy management module 242 may activate the MPPT function within the dynamic signal conversion unit 246 for the connected solar panel source. The graphical user interface 260 may display real-time MPPT performance data, including the current operating voltage, current, and power output of the connected renewable energy source, alongside the battery system parameters described with reference to the data fields 272 through 287 of the display 260. A user may thereby monitor the efficiency of the MPPT function in real time through the graphical user interface 260 via the mobile application or web browser through which the display 260 may be accessed.

The MPPT function may also be applicable within the hybrid DC microgrid system 300 described with reference to FIG. 11. In the hybrid DC microgrid system 300, the solar panels 308 may be coupled to the inverter 306 via a DC line. The MPPT function may be implemented within the dynamic signal conversion unit 246 to continuously adjust the operating point of the solar panels 308 as solar irradiance conditions change throughout the day. The BMS 314 may receive real-time power output data from the MPPT function and may coordinate the charge and discharge operations of the battery module 310 based on the available solar power as tracked by the MPPT algorithm. The inverter 306 may receive the MPPT-optimized DC power from the solar panels 308 via the DC line and may convert that power for delivery to connected loads or for export to the power grid 302 via the transfer switch 305.

The MPPT function may similarly be applicable within the smart home energy system 320 described with reference to FIG. 12. In the smart home energy system 320, the solar panels 322 may supply DC power to the transfer switch 336 via a DC line. The MPPT function maybe implemented within the dynamic signal conversion unit 246 to continuously track the maximum power point of the solar panels 322 as incident solar irradiance and cell temperature conditions vary throughout the day. The BMS 330 may receive MPPT power output data from the dynamic signal conversion unit 246 and may optimize energy dispatch to the smart home load 302 based on the available solar power as tracked by the MPPT algorithm. The wireless remote monitoring pathway 338 may transmit real-time MPPT performance data from the BMS 330 to a remote user device, enabling a user to observe the efficiency of the MPPT function within the smart home energy system 320 from a remote location via the graphical user interface 260.

The MPPT function may be further described with respect to the solar microgrid architecture depicted in FIG. 10. In the four-block vertical arrangement of FIG. 10, the solar panel 280 may supply DC power to the battery module 222. The MPPT function may be implemented between the solar panel 280 and the battery module 222 to continuously adjust the operating point of the solar panel 280 toward the maximum power point as solar irradiance conditions change. The BMS 284 may monitor the power output of the solar panel 280 as tracked by the MPPT function and may coordinate the charging of the battery module 222 based on the available MPPT-optimized power. The inverter 286 may receive DC power from the battery module 222 as managed by the BMS 284 and may convert that power for delivery to connected loads following the completion of a charging cycle in which the MPPT function may have maximized the energy harvested from the solar panel 280.

The MPPT function may operate continuously and independently of the fast pulse charging operations performed by the fast pulse charger 208. The dynamic signal conversion unit 246 may execute the MPPT algorithm on the input side of the conversion unit, tracking the maximum power point of the connected renewable energy source, while simultaneously supplying conditioned electrical energy to the fast pulse charger 208 on the output side. The fast pulse charger 208 may apply high-frequency electrical pulses to the battery module 202 using the MPPT-optimized power supplied by the dynamic signal conversion unit 246. The BMS controller 204 may coordinate the MPPT function and the fast pulse charging function by monitoring the power available from the renewable energy source and adjusting the pulse amplitude, duration, and frequency of the fast pulse charger 208 to match the available MPPT power output. This coordination may allow the battery system to maximize the rate of energy harvesting from the renewable energy source while maintaining the electrochemical operating conditions of the battery module 202 within safe limits.

The MPPT function may be implemented within the device compatibility profile library stored in the memory of the IoT module 210. The device compatibility profile library may include MPPT tracking profiles associated with specific solar panel models and wind turbine models. When the external device detection module 244 may identify a connected renewable energy source, the energy management module 242 may retrieve the corresponding MPPT tracking profile from the device compatibility profile library and may configure the dynamic signal conversion unit 246 with the MPPT parameters specified in that profile. The MPPT tracking profile may specify the initial operating voltage, the perturbation step size, and the tracking algorithm to be used for the identified renewable energy source. The dynamic signal conversion unit 246 may apply these parameters when initiating the MPPT tracking function for the connected renewable energy source.

The IoT module 210 may transmit real-time MPPT performance data to the external platform via the communication network. The external platform may analyze the transmitted MPPT performance data using control algorithms and may generate control signals that may be transmitted back to the dynamic signal conversion unit 246 via the IoT module 210 and the BMS controller 204. The dynamic signal conversion unit 246 may receive these control signals and may adjust its MPPT tracking parameters in response, enabling the external platform to optimize the MPPT function based on historical performance data and real-time environmental conditions. Machine learning algorithms executing on the external platform may analyze patterns in the MPPT performance data to identify operating conditions under which the MPPT tracking efficiency may be improved, and may generate updated MPPT tracking parameters for transmission to the dynamic signal conversion unit 246.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

In the event of excess solar generation, the PLC may direct surplus energy towards auxiliary loads, charge additional battery modules, or, if grid-connected, transfer energy back to the main grid through a bidirectional interface. This may enhance energy resilience and provide flexibility for grid-tied and off-grid scenarios.

The solar microgrid may prioritize energy allocation through dynamic load balancing strategies. Loads designated as critical, such as medical equipment, security systems, and communication devices, may receive uninterrupted power. Lower-priority loads may be dynamically managed based on battery availability and forecasted solar input.

The energy management strategy for the solar-powered microgrid may encompass multiple methods. A first method may involve load prioritization and scheduling. Critical loads, such as LED lights, medical equipment, and security systems, may always receive power. Priority loads, such as washing machines, water pumps, and heavy appliances, may receive power during periods of solar availability. Non-essential loads, such as entertainment systems and water heaters, may be subject to limited usage. Automatic load shedding may disconnect non-essential loads during low battery conditions.

A second method may involve smart battery charging and discharging. During daytime periods of high solar output, direct solar power may supply loads and excess energy may charge the battery. During evening periods of low solar output, the battery may supply loads and the inverter may handle AC loads. During nighttime periods of no solar input, the battery may provide power until the following day, with optional grid backup or generator support for hybrid systems.

A third method may involve demand response and peak shaving. Load may be reduced during peak hours, such as morning and evening. Battery-stored energy may be used instead of drawing from the grid in grid-tied configurations. IoT-based automation may shift loads dynamically based on solar availability.

A fourth method may involve grid-tied optimization where applicable. If net metering may be available, extra solar energy may be exported to the grid. Grid power may be drawn only when solar and battery power may be insufficient. Peak shaving may be implemented by the BMS to ensure battery availability during periods of zero solar input. In the event of a grid failure, the microgrid may run independently in grid isolation mode. Liquid Battery Storage System for Grid-Scale Utilities

In various embodiments, the BMS described herein may also be applied to liquid battery storage systems designed for grid-scale energy storage. These systems, also known as flow batteries, may store energy in liquid electrolyte solutions that may be pumped through electrochemical cells to generate and store electricity. Flow batteries may offer advantages over traditional solid-state battery technologies, including scalable energy capacity, long cycle life, and rapid response times.

In this application, the BMS may integrate with liquid battery storage systems by controlling the pumping mechanisms responsible for circulating electrolytes between storage tanks and electrochemical cells. The PLC may govern pump operation based on real- time demand, ensuring optimized energy efficiency and system longevity. The PLC may modulate the speed and flow rate of electrolyte pumps to match the required energy output, reducing unnecessary power consumption. Sensors integrated into the electrolyte tanks may measure ion concentration, voltage, and temperature, allowing the BMS to assess battery charge levels. The BMS may adjust power output to stabilize voltage and frequency fluctuations, ensuring seamless integration with grid-scale applications. Continuous monitoring of pump efficiency, pressure levels, and electrolyte health may allow the system to detect and address potential failures before they occur. Automated shutdown procedures and backup pump activation in the event of pump failure may enhance overall system reliability.

### Artificial Intelligence

Artificial Intelligence (AI) may significantly enhance the efficiency, reliability, and adaptability of the battery system by enabling advanced data analysis, predictive modeling, and dynamic control of the system's components. Al may interact with the system in multiple ways, optimizing each subsystem's functionality.

The Al algorithms integrated within the IoT platform may analyze real-time and historical data collected by the IoT-enabled control module. These algorithms may identify patterns in battery usage, grid conditions, and energy flow, enabling the system to predict maintenance needs, optimize charging cycles, and recommend energy management strategies. For example, Al may predict when a battery cell may degrade and may alert the user or initiate preemptive adjustments to prevent further damage.

Al may enhance the fast pulse charging module by dynamically adjusting the high- frequency electrical pulses. By analyzing real-time temperature, SOC, and power input, Al algorithms may fine-tune pulse characteristics to ensure efficient charging while minimizing heat and wear. This may reduce energy waste and extend the battery's operational lifespan.

The open architecture of the system may benefit from AI's ability to adapt to new devices and power sources. ML models stored in memory may automatically generate compatibility profiles for newly connected devices, such as electric vehicles or renewable energy sources. These models may facilitate seamless integration and efficient energy flow management between the battery system and external devices.

In grid and off-grid operations, Al may enable intelligent decision-making by processing data from the real-time grid monitoring module and predicting grid instability. Al algorithms may preemptively initiate a transition to off-grid mode before a grid failure occurs, ensuring uninterrupted power delivery. During off-grid operation, Al may prioritize critical loads, dynamically adjust energy flow, and monitor power source variability to maintain stability.

The user experience may be enhanced through AI-driven insights and recommendations provided via the mobile and web-based interfaces. These insights may help users optimize energy usage, reduce costs, and maintain system health. Al may also enable voice commands and natural language interactions, further simplifying system management.

In one embodiment, the BMS may be equipped with a network of sensors and an AI-driven monitoring module to provide advanced, real-time oversight of battery conditions. The sensor suite may continuously measure voltage, current, temperature, SOC, state of health (SOH), and internal impedance. These real-time data streams may be analyzed by integrated Al algorithms to detect patterns and anomalies. By leveraging ML on historical and live sensor data, the BMS may optimize charge and discharge cycles and energy allocation dynamically, ensuring the battery operates at peak efficiency while avoiding conditions that may accelerate degradation.

This AI-enhanced monitoring may balance charge more intelligently, preventing overcharging or deep discharging. The AI-enhanced monitoring may also adjust power delivery in response to the load's needs, resulting in improved energy efficiency and performance across various operating conditions. The integration of sensor data with Al may allow the system to maintain optimal battery performance in real time and adapt to changing demand.

### Machine Learning

Machine learning (ML) may provide transformative capabilities to the BMS by enabling data-driven predictions, adaptive controls, and continuous optimization. ML algorithms may process vast amounts of real-time and historical data collected from the battery system, including SOC, temperature, voltage, current, and environmental conditions. These insights may drive enhancements in performance, reliability, and energy efficiency.

ML may improve predictive maintenance by identifying subtle patterns in battery behavior that may signal impending issues. For instance, algorithms may detect deviations in charging efficiency or temperature trends that may indicate cell imbalance or degradation. These predictions may enable proactive maintenance, reducing downtime and extending the overall life of the battery system.

In the fast pulse charging module, ML algorithms may analyze charging behavior and environmental conditions to optimize pulse characteristics dynamically. By adjusting the amplitude, frequency, and duration of charging pulses in real time, ML may minimize heat generation and maximize energy transfer efficiency. This level of adaptability may ensure that charging remains efficient under varying conditions, such as changes in ambient temperature or fluctuations in power input.

ML may enhance the open architecture by enabling seamless integration with diverse power sources and external devices. Through self-learning models, the system may recognize and adapt to new devices without manual configuration. For example, when an electric vehicle may be connected, ML algorithms may analyze its charging profile and optimize energy flow for bi-directional energy transfer. Similarly, ML may adjust energy management strategies for variable renewable energy sources, ensuring stable operation even with fluctuating inputs.

In grid and off-grid scenarios, ML algorithms may process grid condition data to optimize transitions between modes. By predicting grid instability based on historical patterns and real-time inputs, ML may ensure that the system preemptively switches to off- grid mode, avoiding disruptions. During off-grid operation, ML may dynamically prioritize power distribution to critical loads and adjust energy flow to balance supply and demand efficiently.

The BMS may also benefit from ML-driven optimization of energy storage and usage strategies. By analyzing usage patterns, ML algorithms may recommend optimal charging and discharging schedules to maximize efficiency and reduce costs. These recommendations may be communicated to users via the system's IoT-enabled interface, providing actionable insights in an intuitive format.

One advantage of the AI-integrated BMS may be its capability for predictive maintenance. The Al monitoring system may continuously evaluate trends in the sensor data, such as a gradual rise in cell impedance or a decline in capacity retention, which may indicate early signs of battery wear or potential failure. Based on these indicators, the BMS may predict when maintenance or cell replacement may be required before a fault occurs. The system may detect a subtle drop in performance of a battery module and may flag it for service before it may trigger an alarm in a traditional system. By scheduling maintenance proactively and balancing the load to reduce stress on aging cells, the AI-driven BMS may improve battery lifespan and reliability.

This predictive approach may minimize unplanned downtime by addressing issues during planned maintenance windows rather than after a failure. The BMS may provide real-time diagnostics to operators. The BMS may automatically report the health status of the battery pack and any impending service needs via dashboards or alerts. These diagnostics may be accessible through on-board interfaces or remotely through secure network connections, enabling maintenance crews or system managers to remotely monitor battery conditions. By combining sensor-driven data collection with machine intelligence, the BMS may transform maintenance from a reactive process into a preventative one, thereby enhancing safety and ensuring that the energy storage system remains reliable even in demanding applications.

### Decentralized Autonomous Organizations DAO

Decentralized Autonomous Organizations (DAO) may further enhance the functionality and user capabilities of the battery system by enabling decentralized decision- making, community-driven optimizations, and blockchain-based energy transactions. A DAO-powered framework may interact with the battery system to provide transparency, efficiency, and new opportunities for user engagement and resource management.

DAO integration may allow the battery system to participate in decentralized energy marketplaces. The open architecture and IoT platform may facilitate secure blockchain-based communication, enabling users to buy, sell, or trade stored energy with other participants in the DAO. This may promote the efficient distribution of renewable energy across communities, especially during periods of peak demand or surplus generation. Users may vote on energy pricing policies or community-specific optimizations, ensuring that the system may align with collective priorities.

The DAO framework may also provide an immutable ledger for energy transactions, maintenance schedules, and system upgrades. This immutable ledger may enhance trust and transparency among users, energy providers, and maintenance operators. All energy exchanges, pricing agreements, and system changes may be securely recorded, ensuring accountability and traceability.

In terms of battery system performance, DAOs may facilitate resource pooling and collaborative optimization. Multiple users or stakeholders may collectively manage a distributed network of battery systems, ensuring optimal utilization of energy storage resources. The DAO may coordinate with the IoT platform and ML algorithms to optimize energy flows between connected systems, reducing waste and improving efficiency.

DAO governance mechanisms may enhance user capabilities by enabling stakeholders to propose and vote on system upgrades or new features. These decisions may be executed transparently and efficiently through smart contracts, reducing the need for centralized control. The interaction between DAO and the battery system may be further strengthened by its ability to incentivize sustainable energy practices. Users contributing surplus renewable energy or adhering to energy-saving recommendations may earn tokens or credits, fostering engagement and environmentally responsible behavior.

### Integration of Environmental Sensors for Remote Situational Awareness

The battery system may be equipped with advanced sensors to monitor environmental properties such as air quality, water quality, temperature, humidity, and other situational parameters. FIG. 6 illustrates a flowchart of a method for deploying sensors to monitor environmental and operational parameters, transmitting data to an IoT-enabled platform, analyzing data using AI algorithms, adjusting system operations dynamically, and providing actionable recommendations to users. As shown in FIG. 6, the method may include deploying sensors to monitor environmental and operational parameters, including air quality, water quality and quantity, battery health, and equipment performance. The method may further include transmitting data from the sensors to an IoT-enabled platform. The method may further include analyzing the sensor data using AI algorithms to detect trends and anomalies. The method may further include adjusting system operations dynamically based on insights generated from the analysis. The method may further include providing actionable feedback and recommendations to users via a connected interface.

These sensors may provide real-time data to users, enabling them to monitor their surroundings remotely through the system's IoT-enabled platform. The data may be displayed directly to users via mobile and web-based interfaces or processed through integrated AI, ML, and DAO systems for advanced insights and decision-making.

By connecting to Al systems, these sensors may enable intelligent analysis of environmental conditions. For instance, Al algorithms may detect trends in air quality or water contamination and may issue alerts or recommendations. When integrated with ML, the system may continuously learn from historical and real-time data to refine its predictions and enhance its monitoring capabilities. The DAO framework may further utilize this environmental data to create decentralized decision-making processes, enabling communities or stakeholders to respond collectively to environmental changes.

### Energy Trading for Homes and Businesses

The battery system's open architecture and IoT-enabled platform may facilitate advanced energy trading capabilities for both residential and commercial users. In a home setting, the system may integrate with grid power, solar panels, and other renewable energy sources, allowing homeowners to store energy during periods of low demand or when energy prices may be low. Through real-time monitoring and data analytics, the system may identify optimal times to discharge stored energy back to the grid during peak demand or high energy price periods. This arbitrage capability may enable homeowners to sell excess energy, offsetting their electricity costs and potentially generating additional income.

For businesses, particularly those in commercial and industrial sectors, the battery system may provide a robust platform for participating in energy markets. Businesses may leverage the system to store energy from multiple sources, including solar, wind, hydrothermal, geothermal, and generator power. During periods of high grid demand or price spikes, the stored energy may be sold back to the grid, providing financial benefits through energy arbitrage. The system's IoT-enabled platform may track energy market trends, predict optimal trading opportunities using AI and ML, and automate the process of buying and selling energy through secure, blockchain-based transactions enabled by DAO governance.

In addition to financial benefits, these trading capabilities may contribute to grid stability. By discharging stored energy during peak demand, users may help alleviate stress on the grid, reducing the risk of brownouts or blackouts. Businesses may also use the system to ensure uninterrupted operations during grid instability by prioritizing critical loads and leveraging their stored energy.

### Commercial and Industrial Applications

The battery system may be integrated into commercial and industrial environments to manage energy from diverse sources, including grid power, solar, wind, hydrothermal, geothermal, and generator power. The system's dynamic signal conversion unit may ensure compatibility with these sources, enabling businesses to optimize energy use based on availability and cost. Solar and wind energy may be prioritized during peak generation periods, while the system may seamlessly switch to grid or generator power during low renewable output.

For industrial users, the system's high-capacity energy storage and rapid switching capabilities may ensure uninterrupted power supply, protecting critical operations from grid instability. This resilience may be particularly relevant in manufacturing, healthcare, and data center environments, where power disruptions may result in significant operational and financial losses.

The energy trading capabilities of the system may further enhance its value for commercial and industrial users. By participating in energy arbitrage, businesses may sell excess stored energy during periods of high demand, maximizing profitability. The system's integration with AI and ML may ensure that trading decisions are optimized based on real-time market data, energy availability, and predicted demand. DAO governance may enable decentralized management of energy resources, allowing businesses to collaborate in shared energy markets and align their operations with broader sustainability goals.

### Predictive Maintenance Through Sensors, Computers, and Machinery Controls

The battery system may integrate sensors, computers, and machinery controls to enable predictive maintenance, ensuring optimal performance and reducing downtime. These components may work together to provide real-time monitoring, data analysis, and actionable insights, creating a robust framework for proactive system management.

The system's sensors may continuously monitor parameters such as voltage, current, temperature, vibration, and system load. These sensors may detect anomalies and record operational data, which may be transmitted to the IoT-enabled control module. The IoT-enabled control module may process this data and identify patterns indicative of wear, inefficiency, or impending failures. For instance, temperature sensors may detectoverheating in specific components, while vibration sensors may identify misalignments or mechanical degradation.

Computers within the system may utilize ML algorithms to analyze historical and real-time data from the sensors. By recognizing trends and deviations from normal operating conditions, these algorithms may predict potential failures before they occur. For example, the system may detect gradual declines in battery charge retention or may identify irregular charging cycles that may signal degradation. The integration of AI may further enhance this capability by providing dynamic models that adapt to changing conditions, ensuring accurate and timely predictions.

Machinery controls may contribute to predictive maintenance by enabling automated responses to detected anomalies. For instance, if the system identifies overheating in a component, the IoT-enabled control module may automatically reduce the load on that component or may activate cooling systems. Similarly, if a battery cell shows signs of degradation, the system may adjust charging parameters to extend its lifespan while notifying the user of the issue.

The benefits of predictive maintenance may be further amplified by integrating these capabilities with DAO and ML frameworks. DAO governance may enable decentralized decision-making, allowing multiple stakeholders to coordinate maintenance schedules and resource allocation. ML may continuously refine maintenance strategies, ensuring that the system's predictive models remain accurate and effective.

### Mesh Network for Enhanced Security and Robustness

The integration of a mesh network within the battery system may provide a robust framework for enhanced network security and protection against attacks, including denial-of-service (DoS) attacks. A mesh network architecture may ensure that each node within the system may communicate with multiple other nodes, creating a decentralized communication structure that may be inherently resistant to single points of failure. This decentralized approach may mitigate the risk of network disruptions caused by targeted attacks on specific nodes, ensuring continued operation even in adverse conditions.

FIG. 7 illustrates a flowchart of a method for encrypting data transmissions between nodes, monitoring network traffic for anomalies, rerouting data through alternativenodes in response to network disruptions, and integrating network security with cloud-based remote management. As shown in FIG. 7, the mesh network may establish communication between a plurality of nodes within a mesh topology. The mesh network may encrypt all data transmissions between nodes using end-to-end encryption protocols. The mesh network may monitor network traffic for anomalies using an intrusion detection system. The mesh network may dynamically reroute data through alternative nodes in response to network disruptions. The mesh network may integrate network operations with a cloud platform for secure data synchronization and remote management.

The mesh network may improve robustness by dynamically rerouting data through alternative nodes if one or more nodes may be compromised or may experience connectivity issues. This self-healing capability may ensure continuous data flow, maintaining system integrity and performance. By employing redundant communication pathways, the mesh network may prevent attackers from isolating specific devices or disrupting overall system functionality.

Referring now to FIG. 7, the self-healing capability of the secure mesh communication network 220 may be further described with respect to the manner in which the network 220 may maintain control and communication when individual nodes may be compromised or may experience connectivity failures.

The mesh topology of the network 220 may provide an inherently decentralized communication structure. Each node within the network 220 may communicate with multiple adjacent nodes simultaneously. This multi-path communication architecture may allow the network 220 to sustain data flow between nodes even when one or more individual nodes may become unavailable. When a node within the network 220 may experience a connectivity disruption, the remaining nodes may automatically reroute data through alternative communication pathways within the network 220. This automatic rerouting may occur without interrupting the overall operation of the battery management system. The self-healing capability of the mesh topology may thereby allow the network 220 to maintain continuous data transmission and system control across the distributed battery system installations represented by the first mesh node 222 and the second mesh node 224.

The self-healing rerouting function of the network 220 may be managed by a routing module associated with the mesh network architecture. The routing module may continuously monitor the availability and responsiveness of each node within the network 220. Upon detecting that a node may have become unresponsive or may have lost connectivity, the routing module may identify one or more alternative communication pathways through the remaining active nodes of the network 220. The routing module may redirect data traffic through the identified alternative pathways within milliseconds of detecting the node failure. This rapid redirection may preserve the continuity of data transmission between the battery system installations and the external platform, ensuring that operational data may continue to flow to the cloud synchronization module and that control signals may continue to reach the BMS controller 204 via the IoT module 210 without interruption.

The self-healing capability of the network 220 may extend to scenarios in which a node may be compromised by a cybersecurity threat rather than a physical connectivity failure. The anomaly detection module 230 may operate continuously to monitor network traffic patterns within the mesh network 220. The anomaly detection module 230 may analyze traffic patterns for deviations that may be indicative of unauthorized access attempts, data integrity violations, or other cybersecurity threats directed at individual nodes. Upon detecting anomalous traffic patterns associated with a particular node, the anomaly detection module 230 may generate a security alert. The security alert may be transmitted to the cloud synchronization module for relay to the external platform. The external platform may receive the security alert and may initiate a protective response directed at the compromised node.

Node isolation may constitute one such protective response mechanism that may be available within the network 220. Node isolation may involve the removal of a compromised node from active participation in the mesh network 220. Upon a determination that a node may have been compromised, the routing module may cease routing data through that node. The compromised node may be logically disconnected from the communication pathways of the network 220. This logical disconnection may prevent the compromised node from transmitting or receiving data within the network 220. Node isolation may thereby contain the potential impact of a compromised node by preventing it from introducing corrupted data, unauthorized commands, or malicious traffic into the communication pathways of the network 220. The remaining active nodes of the network 220 may continue to operate normally following the isolation of the compromised node. The self-healing rerouting function of the routing module may redirect data traffic through the remaining active nodes to maintain continuous communication across the network 220 after the compromised node may have been isolated.

Node isolation may be performed without disrupting the overall operation of the battery management system. The battery system installations associated with the non-isolated nodes may continue to transmit operational data to the external platform and to receive control signals from the external platform via the remaining active communication pathways of the network 220. The BMS controller 204 associated with each non-isolated node may continue to execute control signals and to manage the operating conditions of its respective battery module 202 without interruption. The isolation of a compromised node may thereby constitute a targeted protective response that may remove the compromised node from the network 220 while preserving the operational continuity of all other nodes and battery system installations within the network 220.

The anomaly detection module 230 may employ machine learning algorithms to enhance the accuracy and responsiveness of its anomaly detection function. The machine learning algorithms may be trained on historical network traffic data to establish baseline traffic patterns for the mesh network 220. The anomaly detection module 230 may compare real-time traffic patterns against the established baseline to identify deviations that may be indicative of cybersecurity threats. The machine learning algorithms may adapt the baseline over time as normal traffic patterns within the network 220 may evolve, ensuring that the anomaly detection function may remain accurate as the operational characteristics of the network 220 may change. Upon detecting a deviation that may exceed a predefined anomaly threshold, the anomaly detection module 230 may generate a security alert and may initiate the node isolation response for the node associated with the anomalous traffic.

Traffic rate limiting may constitute an additional protective measure that may be implemented within the network 220 to prevent network congestion or denial-of-service conditions. Traffic rate limiting may involve the enforcement of maximum data transmission rates for individual nodes or for the network 220 as a whole. The routing module may monitor the volume of data traffic transmitted by each node within the network 220. When the data transmission rate of a node may exceed a predefined threshold, the routing module may apply rate limiting controls to that node. The rate limiting controls may reduce the data transmission rate of the affected node to a level within the predefined threshold. This reduction may prevent a single node from consuming a disproportionate share of the available communication bandwidth of the network 220.

Traffic rate limiting may provide protection against denial-of-service conditions that may arise when a node within the network 220 may be caused to transmit data at an abnormally high rate. A denial-of-service condition may occur when excessive data traffic from one or more nodes may saturate the communication bandwidth of the network 220, preventing other nodes from transmitting operational data or receiving control signals. The anomaly detection module 230 may detect traffic patterns consistent with a denial-of-service condition by identifying nodes whose transmission rates may significantly exceed the established baseline. Upon detecting such a condition, the anomaly detection module 230 may generate a security alert and may coordinate with the routing module to apply traffic rate limiting controls to the affected node or nodes. The application of traffic rate limiting controls may reduce the data transmission rate of the affected nodes to within acceptable limits, restoring available communication bandwidth for the remaining nodes of the network 220.

Traffic rate limiting may operate in conjunction with node isolation as complementary protective measures within the network 220. In circumstances where anomalous traffic from a node may be detected but may not yet meet the threshold for node isolation, traffic rate limiting may be applied as an intermediate protective measure. Traffic rate limiting may reduce the potential impact of the anomalous node on the communication bandwidth of the network 220 while the anomaly detection module 230 may continue to monitor the node for further anomalous behavior. If the anomalous behavior of the node may persist or may escalate, the anomaly detection module 230 may subsequently initiate node isolation to remove the node from the network 220. The combination of traffic ratelimiting and node isolation may thereby provide a graduated protective response capability within the network 220 that may address a range of cybersecurity threat conditions from network congestion to full node compromise.

The encryption module 228 may operate in conjunction with the anomaly detection module 230 and the routing module to support the self-healing and protective response capabilities of the network 220. The encryption module 228 may apply cryptographic protocols including AES-256 and TLS to all data transmitted between the first mesh node 222 and the second mesh node 224. The encryption of inter-node communications may prevent unauthorized parties from intercepting or modifying data transmitted within the network 220. The encryption conversion component 226 may process outbound data packets prior to the application of cryptographic protocols by the encryption module 228. The anomaly detection module 230 may analyze the metadata and traffic patterns of encrypted communications to detect anomalies without requiring access to the decrypted content of the transmitted data. This capability may allow the anomaly detection module 230 to identify potential cybersecurity threats based on traffic behavior patterns while preserving the confidentiality of the encrypted data transmitted between nodes.

The cloud synchronization module of the network 220 may transmit security alerts generated by the anomaly detection module 230 to the external platform for further action. The external platform may receive the security alerts and may generate control signals directing the routing module to apply traffic rate limiting, initiate node isolation, or take other protective actions within the network 220. The external platform may also transmit notifications of detected security events to the user interface accessible through the mobile application and the web application communicatively coupled to the external platform. A user or system administrator may receive these notifications and may review the security event data transmitted by the cloud synchronization module to assess the nature and extent of the detected threat. The user or system administrator may also transmit configuration commands to the network 220 via the external platform to adjust anomaly detection thresholds, modify traffic rate limiting parameters, or authorize the reintegration of an isolated node following remediation.

The self-healing mesh network topology, node isolation, and traffic rate limiting capabilities of the network 220 may collectively provide a resilient and secure communication infrastructure for the distributed battery management system. The self-healing topology may maintain continuous data flow and system control across the network 220 when individual nodes may fail or may be compromised. Node isolation may remove compromised nodes from the network 220 without disrupting the operation of the remaining nodes or the battery system installations associated with those nodes. Traffic rate limiting may prevent network congestion and denial-of-service conditions by enforcing maximum data transmission rates for individual nodes within the network 220. These three capabilities may operate in a coordinated manner within the network 220 to maintain the integrity, availability, and security of communications among the distributed battery system installations, the external platform, and the user interface throughout the operational life of the battery management system.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

Enhanced security may be further achieved through the use of advanced encryption protocols. Locally, within the mesh network, end-to-end encryption may secure communication between nodes, ensuring that intercepted data may not be read or altered by unauthorized parties. This local encryption may safeguard sensitive operational data, including sensor readings, battery status, and control commands, from being accessed or manipulated by malicious actors.

In the cloud, data transmitted from the mesh network may be encrypted using industry-standard encryption protocols such as AES-256. Secure sockets layer (SSL) or transport layer security (TLS) protocols may be implemented to protect data during transmission, ensuring that communications between the mesh network and cloud-based services may remain confidential and tamper-proof. This dual-layer encryption strategy may enhance overall system security by addressing vulnerabilities both within the local network and during external communications.

To further bolster security, the system may include intrusion detection mechanisms that may monitor network traffic for unusual patterns indicative of potential attacks. If an anomaly may be detected, the mesh network may isolate affected nodes and may alert the system administrator, minimizing the impact of the attack. These proactive measures, combined with the inherent resilience of the mesh architecture, may provide a robust defense against hacking attempts, including DoS attacks and unauthorized access. Autonomous Precision Timing Device

Modern communication, navigation, and synchronization systems may rely on the Global Positioning System (GPS) for precision timing. However, GPS signals may be vulnerable to jamming, spoofing, hacking, and degradation, especially in contested or congested radio frequency (RF) environments. This may create a need for an autonomous precision timing device that may function independently of GPS and may maintain microsecond-level accuracy in such challenging conditions. The device described herein may integrate compact atomic clock technology with secure IoT-based communication networks, providing a resilient and scalable timing solution.

In one embodiment, the autonomous precision timing device may deliver precise, autonomous timing for various applications, including military, telecommunications, finance, and autonomous systems. The device may leverage a miniature atomic clock, such as the MAC-SA53, integrated with an IoT controller and a secure LoRaWAN mesh network. The device may be deployed with or without significant battery backup, depending on operational requirements. The device may maintain timing accuracy within 1 microsecond over 24 hours. The device may provide a GPS-independent precision timing source capable of supporting mission-critical systems even in GPS-denied environments.

In one embodiment, the autonomous precision timing device may be designed using the MAC-SA53 atomic clock, known for its compact size and accuracy. Other atomic clocks may be used. The atomic clock may be integrated with a FireBeetle 2 IoT controller, which may facilitate system management and timing signal distribution. To ensure robust communication, the device may utilize a LoRaWAN mesh network. This configuration may allow for secure, long-range, low-power communication over distances up to 15 kilometers. The mesh network may ensure redundancy by enabling data transmission through multiple nodes, mitigating the risks of signal degradation and jamming.

The construction of the autonomous precision timing device may emphasize durability and portability. The components may be enclosed in a ruggedized housing that may protect against environmental extremes, including temperature fluctuations and physical shocks. The system may support modular assembly, enabling customization for specific applications. Battery options may include rechargeable lithium-ion cells, allowing for extended field use without requiring frequent recharging or maintenance. The system's lightweight and compact design may make it suitable for deployment across various platforms, from handheld devices to vehicle-mounted systems.

Operationally, the autonomous precision timing device may maintain precise synchronization by leveraging the atomic clock's minimal drift rate of 1 microsecond over 24 hours. The IoT controller may ensure seamless integration with existing systems, providing interfaces for Ethernet, RS-232, and pulse-per-second (PPS) output. The LoRaWAN network may not only support timing signal dissemination but may also ensure secure data transmission through advanced encryption protocols like WPA2-AES and IPSec 3DES. Additional blockchain-based security features may be integrated for enhanced data integrity.

The autonomous precision timing device may support diverse field applications. For military users, the device may ensure uninterrupted Position, Navigation, and Timing (PNT) services in GPS-denied or contested environments. In telecommunications, the device may support network synchronization in urban canyons or remote locations where GPS signals may be unreliable. The finance industry may benefit from its ability to synchronize transactions without relying on GPS, ensuring continuity during outages or disruptions. Autonomous systems, such as drones and self-driving vehicles, may rely on the device for maintaining coordination and safety in challenging RF environments.

### Military and Dual-Purpose Applications

The BMS described in embodiments herein may also be adapted for military applications, improving economies of scale while ensuring reliability in mission-critical scenarios. The system may be deployed for energy storage in military microgrids, field operations, and mobile energy platforms for directed energy weapons (DEWs), forward operating bases, and autonomous systems.

The military version of the BMS may incorporate ruggedized components, enhanced cybersecurity protections, and adaptive load management tailored for high-energy-demand applications. The PLC-based control system may allow seamless integration with modular battery packs, enabling rapid energy discharge for high-power systems. The predictive maintenance and fault detection features may enhance operational uptime and system reliability in extreme environments.

In one implementation, the system may be deployed in support of DEWs, which may require rapid, high-power discharges. The BMS may manage these extreme load conditions by actively monitoring each cell during a pulse discharge and redistributing load or triggering backup modules as needed to maintain stable voltage. The AI algorithms may optimize energy allocation for such mission-critical operations. Adaptive load balancing may ensure that no single module may be overstressed during the high-energy pulse, and the system may recuperate energy efficiently between shots.

The BMS's predictive maintenance capabilities may directly contribute to fleet readiness for military power systems. By continuously checking the health of batteries in vehicles, naval vessels, or remote installations, the system may alert technicians to service or replace a battery before it may fail in the field. For remote energy storage installations such as those at forward operating bases or remote radar stations, the BMS may enable a high degree of autonomous operation. The BMS may integrate with generators, solar panels, or other power sources common in deployed microgrids, regulating charge input and discharge output to ensure continuous power availability in isolated environments.

The system's real-time diagnostics and remote monitoring features may allow command centers to monitor the status of remote batteries from afar, using satellite or secure radio links to receive health reports and send control commands. This may reduce the need to send personnel into remote or hazardous locations for routine monitoring.

By integrating the BMS into military-grade applications, the system may support rapid deployment, resilience against cyber threats, and compatibility with multiple energy storage technologies, including LiFePO4, sodium-ion, and solid-state batteries. The standardized design may also allow for integration into civilian energy grids and industrial storage, increasing production volume and lowering overall costs.

A notable feature of the BMS design may be its modular and scalable architecture, which may facilitate both mass production and flexible deployment across diverse use cases. The hardware and software components may be designed to be battery-agnostic and modular. Multiple BMS units may operate in parallel or series to manage larger battery arrays. The same core system may be configured for different battery chemistries or capacities. Additional sensor modules and control nodes may be added to accommodate a higher number of cells in a grid-scale storage farm, or conversely a minimal configuration may be used for a small standalone power pack, all using the same BMS platform.

This modularity may not only simplify scaling up or down, but may also streamline manufacturing. A single standardized BMS unit may be produced in volume and then tailored via software settings or minor hardware add-ons to suit a particular application, whether it may be a high-power military laser system or a commercial solar storage battery. By embracing such dual-use adaptability, the BMS may leverage economies of scale between military and civilian markets. Technologies initially developed to meet rigorous military specifications, such as extreme environmental tolerance and secure communications, may be directly transitioned into commercial products, offering superior reliability and safety in everyday industrial use.

### Hypothetical Examples

The following hypothetical examples are meant to be informative and help the reader understand embodiments of the disclosure and how these embodiments work. These examples are not meant to be limiting.

### Hypothetical Example: Homeowner Use of the Battery System

Consider a homeowner, Jane, who may have installed the battery system in her suburban home, integrated with solar panels and connected to the local grid. Jane's system may be equipped with the IoT-enabled platform, predictive maintenance capabilities, and energy trading features.

During the day, Jane's solar panels may generate more energy than her home may consume. The excess energy may be stored in the battery system. Using the IoT platform, Jane may monitor her energy production and consumption in real time via a mobile app. The app may notify her that the energy stored in her battery may have reached its maximum capacity.

In the evening, when grid electricity prices may peak, the system may automatically discharge stored energy to power Jane's home, reducing her reliance on expensive grid electricity. Additionally, the system may sell any remaining excess energy back to the grid during these high-demand periods. Through energy arbitrage, Jane may earn credits on her utility bill, offsetting her costs and potentially generating extra income.

One summer afternoon, Jane may receive a notification from the system's predictive maintenance module, alerting her to a potential issue with one of the battery cells. The system's sensors may have detected a slight overheating trend. Using ML, the system may predict that the battery cell may degrade within two months if no action may be taken. Jane may schedule a maintenance check through the app, and the system may automatically adjust its charging cycles to minimize further strain on the affected cell.

During a storm that may cause a grid outage, the battery system may seamlessly transition to off-grid mode using the intelligent transfer switch. The load prioritization module may ensure that designated appliances, such as her refrigerator and home security system, may continue running. Jane's system may also alert her neighbor, who may be part of a local DAO network, that surplus energy may be available for trade. Jane may agree to share energy with her neighbor through a blockchain-enabled transaction, earning additional credits.

This system may not only provide Jane with reliable and resilient power but may also save her money through energy trading and predictive maintenance. The intuitive app interface, combined with AI and ML, may empower her to optimize energy use while maintaining confidence in her home's energy infrastructure.

### Hypothetical Example: Business Use of the Battery System

A mid-sized manufacturing company, Apex Components, may have implemented a battery system to manage energy needs across its facilities. Operating in an area with high energy costs and occasional grid instability, Apex may rely on the system to enhance reliability and efficiency.

The battery system may integrate seamlessly with Apex's solar arrays and wind turbines. The battery system may store excess energy generated during production hours and may automatically discharge this stored energy to power critical machinery during peak pricing periods. This process may reduce the company's dependence on costly grid electricity and may minimize energy expenses. The IoT platform may track real-time market trends and may schedule charging from the grid when prices may be at their lowest, further optimizing energy costs.

During grid instability, the hybrid inverter and intelligent transfer switch may ensure uninterrupted power to operations, such as automated assembly lines and temperature-sensitive storage facilities. The load management module may prioritize critical equipment, ensuring no disruption to the production process.

Apex may also benefit from the system's energy trading features. Surplus energy stored in the system may be sold back to the grid during periods of high demand, generating additional revenue. Using AI algorithms, the system may identify optimal trading opportunities, ensuring maximum profitability through energy arbitrage.

Predictive maintenance capabilities may further enhance operational efficiency. Sensors embedded in machinery may monitor parameters, including motor temperatures, vibration levels, and energy draw. When the system may detect deviations indicating potential wear, ML algorithms may forecast the likelihood of failure, enabling proactive scheduling of repairs. This may prevent costly downtime and may extend the lifespan of both the battery system and connected machinery.

Apex may also use the system to achieve its sustainability goals. The system may generate detailed reports on energy usage and greenhouse gas reductions, supporting compliance with environmental regulations. Participation in a DAO energy network may allow the company to collaborate with local businesses in stabilizing the grid and promoting renewable energy initiatives.

### Integration for Military and Remote Foreign Aid Operations

The battery system may be suited for use in military and remote foreign aid operations. Its integration with IoT, AI, ML, and DAO technologies may provide a robust platform for managing energy needs, monitoring equipment health, and ensuring mission-critical operations in challenging and isolated environments.

The system may enable real-time situational awareness for military vehicles, command centers, and field equipment. Equipped with sensors, the system may continuously monitor parameters such as battery status, equipment functionality, fuel levels, and ammunition supplies. This data may be transmitted to a centralized IoT platform, where it may be analyzed using AI and ML algorithms to predict potential issues, recommend adjustments, and optimize resource allocation.

DAO governance may further enhance the system's utility by facilitating decentralized decision-making and resource management. In a battlefield scenario, this may mean dynamically reallocating power, fuel, or personnel based on mission priorities. Remote command structures may benefit from a complete, real-time overview of the operational landscape, enabling them to make informed decisions and improve mission outcomes.

### Hypothetical Example: Military and Remote Aid Use Case

Consider a military unit deployed in a remote area with limited access to infrastructure. The unit may employ the battery system to manage energy resources, monitor vehicle health, and maintain situational awareness. Sensors integrated into their vehicles may continuously monitor battery performance, fuel levels, and equipment status. This data may be sent to a central command center via the IoT platform.

At the command center, AI algorithms may analyze the incoming data to identify trends and anomalies. For example, one vehicle may show a gradual decline in battery efficiency, while another may exhibit higher-than-normal fuel consumption. The system may predict that the affected vehicle may require maintenance within the next 48 hours and may recommend a resupply of fuel to prevent mission disruption.

In addition to predictive maintenance, the system may leverage ML to suggest adjustments to force composition and deployment strategies. Based on fuel and ammunition levels, terrain data, and mission objectives, the system may propose reallocating certain vehicles to specific units, ensuring optimal resource distribution and mission success.

During the mission, DAO governance may enable the unit to adapt dynamically to unforeseen challenges. For instance, if one vehicle may become inoperable, the system may reallocate power from nearby units equipped with surplus capacity. Blockchain-enabled transactions may ensure secure and transparent resource sharing.

After the mission, the system may compile a detailed debriefing report. This report may include insights on energy usage, equipment performance, and logistical efficiency. ML algorithms may highlight areas for improvement, such as optimizing fuel distribution or enhancing battery charging protocols. These learnings may be stored in the DAO framework, allowing future missions to benefit from past experiences.

Enhanced situational awareness may be achieved through real-time monitoring of vehicles and equipment. Sensors embedded in the system may provide continuous feedback on operational metrics such as battery levels, fuel reserves, and equipment health. This data may be centralized on an IoT platform that may deliver accurate, up-to-the-minute information to command structures, ensuring operational readiness and informed decision-making.

Predictive maintenance may be enabled by the system's integration of sensors and AI algorithms. These tools may work together to identify potential issues before they may escalate into equipment failures. For instance, a vehicle with decreasing battery efficiency or irregular fuel consumption patterns may be flagged for preemptive servicing. This proactive approach may reduce downtime, maintain mission continuity, and extend the lifespan of assets.

Dynamic resource allocation may be facilitated by ML-driven insights that may optimize the deployment of power, fuel, and personnel. By analyzing current conditions and mission objectives, the system may dynamically suggest adjustments to resource distribution. Vehicles with surplus energy or fuel may be reassigned to support units with greater operational needs, ensuring maximum efficiency and effectiveness.

Resilience in challenging environments may be supported by the system's ability to operate off-grid and integrate with renewable energy sources such as solar or wind. This capability may ensure a reliable energy supply even in remote locations where traditional infrastructure may be unavailable or unreliable. The hybrid inverter and intelligent transfer switch may enable seamless transitions between power sources, minimizing disruptions.

Learning and improvement may be integral to the system's design, with post-mission debriefings providing actionable insights for future operations. Detailed reports on energy usage, equipment performance, and logistical outcomes may be generated using ML algorithms. These insights may enable continuous refinement of strategies, enhancing operational efficiency and mission success over time.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

### Technical Solution

### Scalability, Modularity, and Battery Chemistry

In various embodiments, the beyond-the-meter battery management system (BMS) may be configured as a modular and scalable architecture. This architecture may allow the same core BMS platform to serve applications ranging from small standalone residential power packs to large-scale grid storage farms. The modular design may be understood as a system in which individual BMS units may be added, removed, or reconfigured without requiring a fundamental redesign of the underlying hardware or software platform. This characteristic may allow the system to grow with the energy demands of the user or the deployment environment.

Multiple BMS units may be configured to operate in parallel or in series to manage larger battery arrays. When configured in parallel, multiple BMS units may share current load across a common voltage bus, thereby increasing the total current capacity and power output of the assembled system. When configured in series, multiple BMS units may be arranged to increase the total system voltage, which may be appropriate for high-voltage grid-scale storage applications. In either configuration, the individual BMS units may communicate with one another through the multi-protocol communication network described in preceding sections, allowing coordinated monitoring, charge balancing, and fault detection across the entire array. The same core control algorithms stored in the memory of each BMS unit may govern these inter-unit communications, so that no specialized firmware may be required for multi-unit deployments.

The scalability of the system may extend from a minimal configuration suitable for a single residential installation to a maximum scalable capacity of up to 320 kilowatts (kW). This range may encompass residential whole-house battery systems, commercial energy storage installations, industrial microgrid deployments, and grid-scale storage farms. In each case, the same standardized BMS platform may be employed, with the scale of the deployment determined by the number of BMS units and battery modules that are interconnected. This approach may allow a single manufacturing line to produce a common BMS unit in volume, with application-specific tailoring achieved through software configuration and minor hardware additions rather than through separate product designs.

The hardware and software components of the BMS may be designed to be battery-agnostic. In practical terms, battery-agnostic design may mean that the BMS platform may be compatible with multiple battery chemistries without requiring a redesign of the core hardware. The system may accommodate different battery chemistries by adjusting voltage thresholds, charge and discharge profiles, thermal management parameters, and cell balancing algorithms through software settings. This may allow a single BMS unit to be reconfigured for a different battery chemistry by updating the control algorithms stored in memory, or by adding minor hardware components such as chemistry-specific sensor modules or interface boards.

Among the battery chemistries with which the system may be compatible, lithium iron phosphate (LiFePO4) may represent a preferred chemistry in certain embodiments. Lithium iron phosphate chemistry may be characterized by a nominal cell voltage of approximately 3.2 volts, a flat discharge curve, high thermal stability, and a long cycle life relative to other lithium-ion chemistries. These electrochemical characteristics may make lithium iron phosphate well-suited for stationary energy storage applications where safety, longevity, and predictable discharge behavior may be valued. In a preferred embodiment, the battery system may operate at a nominal voltage of 48 volts, with an actual operating voltage of approximately 51.2 volts, consistent with a sixteen-cell series arrangement of lithium iron phosphate prismatic cells.

The system may also be compatible with sodium-ion battery chemistries. Sodium-ion batteries may be distinguished from lithium-ion chemistries by their use of sodium ions as the charge carrier rather than lithium ions. Sodium-ion cells may exhibit a somewhat lower energy density than lithium iron phosphate cells, but may offer advantages in terms of raw material availability, cost, and low-temperature performance. The BMS may accommodate sodium-ion chemistries by adjusting the voltage window parameters and charge termination thresholds within the control algorithms, as sodium-ion cells may operate across a different voltage range than lithium iron phosphate cells. The thermal monitoring subsystem may also be reconfigured to reflect the distinct thermal behavior of sodium-ion chemistry.

Solid-state battery chemistries may represent a further category of compatibility for the BMS platform. Solid-state batteries may replace the liquid electrolyte found in conventional lithium-ion cells with a solid electrolyte material, which may offer improvements in energy density, safety, and cycle life. Solid-state cells may operate at higher voltages and may exhibit different impedance characteristics than liquid-electrolyte cells. The BMS may accommodate solid-state chemistries through software-configurable impedance measurement parameters and charge pulse profiles, allowing the fast pulse charging module to be tuned for the distinct electrochemical response of solid-state cells. The platform may be described as future-proof in this respect, as it may be configured to integrate solid-state battery technology as it becomes commercially viable, without requiring a redesign of the core BMS hardware.

Reconfiguration of the BMS for a different battery chemistry or capacity may be accomplished through software settings accessible via the IoT platform, or through the addition of minor hardware components such as supplementary sensor modules or chemistry-specific interface boards. A technician or system administrator may access the configuration interface through the mobile or web application described in preceding sections, and may select from a library of chemistry profiles stored in the memory of the BMS unit. The selected profile may automatically adjust the relevant operating parameters, including charge voltage limits, discharge cutoff voltages, thermal alarm thresholds, and cell balancing strategies, to match the characteristics of the installed battery chemistry.

Referring now to FIGS. 13a, 13b, 13c and 13d, these figures illustrate the physical housing of the battery system, real-world installation configurations, and the physical assembly of the battery pack. As shown in FIG. 13a, the housing of the battery system may be configured as a rounded-rectangle enclosure suitable for wall mounting in residential or commercial settings. The schematic views presented in FIG. 13a identify several labeled components of the housing. The outer front cover may form the exterior face of the enclosure and may provide a protective surface for the internal components. The inner battery cover may be positioned behind the outer front cover and may serve to enclose and protect the battery array within the housing. The battery array, which may comprise eighteen individual battery cells in one embodiment as labeled in FIG. 13a, may be arranged within the inner battery cover in a grid configuration. The display may be positioned on the outer front cover and may provide a visual interface for monitoring system status, including voltage, current, state of charge, and charge or discharge status, as further illustrated in FIG. 9. The control buttons may be located adjacent to the display and may allow a user to interact with the system locally. The ports may be located on the outer surface of the housing and may provide connection points for external cables, including power input and output connections, communication interfaces, and ground connections.

As illustrated in the photographic views in FIG. 13a, the housing may be mounted on an exterior wall surface adjacent to a utility meter or similar infrastructure. A cable may extend from the bottom of the housing to connect the battery system to the residential or commercial electrical infrastructure. FIG. 13b may illustrate the BMS connected to a residential utility meter, showing how the housing may be installed in proximity to the meter and connected via conduit or cable runs. FIG. 13c may illustrate the BMS connected to a home generator, showing how the transfer switch and power source interface may accommodate generator input as an alternative or supplementary power source. FIG. 13d may illustrate the physical assembly of the battery pack, showing the open-topped rectangular battery assembly with individual battery cells arranged in a grid, with cables and connectors extending from the assembly to the central BMS module.

In the physical assembly of the battery pack, individual battery cells may be connected to the central BMS module through a wiring harness that routes voltage sensing leads, temperature sensor leads, and main power conductors from each cell or cell group to the BMS module. The BMS module may monitor each cell individually through these connections, enabling cell-level voltage balancing and thermal monitoring. The assembled battery pack may be mounted within the inner battery cover of the housing, and the housing may then be secured to a wall surface using mounting hardware appropriate for the installation environment. The ports on the outer front cover may then be connected to the residential or commercial electrical panel, the solar charge controller, the inverter, or other system components as required by the specific installation.

In a preferred embodiment, the battery system may exhibit a nominal voltage of 48 volts, with an actual operating voltage of approximately 51.2 volts. The system may provide a continuous power output of 15 kilowatts and a peak power output of 20 kilowatts. The capacity of the system at ten years of operation may be retained at approximately 79 percent of the original rated capacity, which may compare favorably with competing commercial battery systems. The system may be scaled to a maximum capacity of 320 kW through the addition of parallel BMS units and battery modules, as described above.

The modular design of the BMS may streamline manufacturing by enabling a single standardized BMS unit to be produced in volume on a common manufacturing line. Each unit may then be tailored to a specific application through software configuration and, where necessary, through minor hardware additions such as supplementary sensor modules or chemistry-specific interface boards. This approach may reduce the per-unit manufacturing cost by concentrating production volume on a single hardware platform, while preserving the flexibility to serve a wide range of applications. The same BMS unit that may be configured for a residential lithium iron phosphate installation may also be reconfigured, through software settings, for a commercial sodium-ion deployment or a military solid-state battery application, without requiring a separate hardware design for each use case. This cross-application adaptability may allow economies of scale to be realized across both civilian and military markets, as described in preceding sections, and may reduce the duplication of research and development effort associated with maintaining separate product lines for different applications.

### Technical Advantages

The devices, systems, and methods described herein may provide a range of technical advantages over conventional beyond-the-meter (BTM) battery systems. These advantages may arise from the integration of IoT-enabled monitoring and control, fast pulse charging, open architecture compatibility, grid and off-grid dual-mode operation, secure mesh networking, artificial intelligence, machine learning, and modular scalable design into a unified battery management platform. Each of these functional elements may contribute distinct technical benefits that may address the limitations of prior art BTM battery systems described in the Technical Problem section above.

A first technical advantage may relate to enhanced real-time monitoring and remote control capability. Conventional BTM battery systems may lack the ability to transmit operational data to an external platform and receive optimized control signals in response. The IoT module (210), as illustrated in FIG. 6, may provide bidirectional communication between the battery system and a cloud-based or supervisory platform, enabling continuous transmission of battery parameters including state of charge (SOC), temperature, voltage, current, and power flow. This capability may allow system operators and end users to monitor battery conditions and issue control commands from any location via the mobile or web application described in connection with FIG. 9. Conventional systems may require on-site inspection to assess battery status, whereas the IoT-enabled architecture described herein may eliminate this requirement, reducing operational costs and enabling faster response to abnormal conditions.

A second technical advantage may relate to predictive maintenance and extended battery lifespan. Conventional BTM battery systems may rely on reactive maintenance practices, in which components may be serviced or replaced only after a failure has occurred. The machine learning algorithms executing on the external platform may analyze historical and real-time sensor data to identify trends indicative of impending degradation, such as gradual increases in cell impedance, declining capacity retention, or irregular thermal behavior. By detecting these trends before they may result in failure, the system may enable proactive maintenance scheduling, reducing unplanned downtime and extending the operational lifespan of the battery system. The AI-driven monitoring module may continuously evaluate sensor data streams from the battery module (202) and may generate maintenance alerts communicated to users through the mobile and web application interfaces. This predictive capability may represent a substantial improvement over conventional systems that may lack the sensor integration, data transmission infrastructure, and analytical algorithms required to support predictive maintenance.

A third technical advantage may relate to improved charging efficiency and reduced thermal stress through fast pulse charging. Conventional BTM battery systems may employ constant-current or constant-voltage charging strategies that may generate excessive heat, accelerate electrochemical degradation, and extend charging times. The fast pulse charger (208), as illustrated in FIG. 6, may apply high-frequency electrical pulses with dynamically adjustable amplitude, duration, and frequency to the battery module (202). As illustrated in FIG. 10, the faradaic charging process enabled by pulse charging may promote more efficient ion migration toward electrode boundaries during each active pulse interval, followed by a rest interval during which the electrochemical state of the battery cells may be assessed. This alternating pulse-and-rest waveform may reduce heat generation relative to continuous charging strategies, may improve charge acceptance across a range of SOC levels, and may reduce cumulative electrochemical stress on battery cells over repeated charging cycles. The result may be a battery system that may charge more rapidly, may operate at lower temperatures during charging, and may retain a greater proportion of its rated capacity over its service life. The capacity retention advantage of embodiments described herein, approximately 79 percent at ten years of operation as compared to 68 to 74 percent for competing commercial systems as shown in the comparison table presented in the Comprehensive Battery System section above, may be attributable in part to the reduced degradation associated with fast pulse charging.

Referring now to the PLC-based pulse charging implementation, programmable logic controllers (PLCs) may provide pulse charging capabilities within the battery management and charging system architecture as a distinct implementation approach. In one embodiment, PLCs may deliver pulse output at voltage levels of 9VDC, 12VDC, and 24VDC. These pulse outputs may be applied to charge and balance battery cells within the IoT-enabled BMS. The PLC pulse charging approach may thereby constitute an alternative implementation pathway for the fast pulse charging function described with reference to the fast pulse charger 208 of FIG. 6, wherein the PLC may serve as the pulse generation element in place of or in conjunction with the dedicated fast pulse charging module.

The PLC-based pulse charging implementation may utilize a peer-to-peer mesh input/output (I/O) sharing architecture. In this architecture, individual PLC units may share input and output data with one another directly, without requiring a centralized controller to mediate the exchange. Each PLC unit may expose its input and output data to peer PLC units within the mesh, enabling coordinated pulse charging and balancing operations across a distributed battery array. This peer-to-peer mesh I/O sharing architecture may operate in conjunction with the secure mesh communication network 220 described with reference to FIG. 7, such that the I/O data exchanged among PLC units may be transmitted through the encrypted mesh topology established by the first mesh node 222 and the second node 224. The peer-to-peer mesh I/O sharing architecture may thereby support the secure IoT communication, data logging, and sensor integration functions of the BMS without requiring a dedicated centralized switching fabric.

The output current capacity of the PLC-based pulse charging implementation may reach up to 2.5A per output channel. This current capacity may be sufficient to deliver pulse charging current to individual battery cells or cell groups within the battery array managed by the BMS. The PLC may regulate the amplitude, duration, and frequency of each pulse output to maintain the battery cells within safe electrochemical operating limits, consistent with the dynamic pulse parameter adjustment described with reference to the fast pulse charger 208 and the pulse charging waveform 280 of FIG. 10. The current regulation function of the PLC may operate in conjunction with the thermal monitoring subsystem of the BMS controller 204, such that the PLC may reduce pulse amplitude or increase rest interval duration in response to elevated temperature readings received from the battery module 202.

Pulsed relay nodes may be incorporated within the PLC-based pulse charging implementation. Each pulsed relay node may provide DC charging current to one or more battery cells within the battery array. The pulsed relay nodes may operate by switching a DC charging source on and off at a controlled frequency, thereby generating a pulsed DC charging waveform analogous to the charging pulses 282 depicted in FIG. 10. The pulsed relay nodes may maintain battery cell charge levels within a target state-of-charge range by activating and deactivating the DC charging source in response to cell voltage measurements received by the PLC from the battery monitoring sensors. The pulsed relay node operation may thereby implement the charge maintenance function of the BMS at the individual cell level, enabling per-cell charge balancing across the battery array.

A specific implementation example may be described with reference to a whole-house battery configuration comprising sixteen batteries. In this implementation example, two PLC units may be employed to manage the pulse charging and balancing functions across the sixteen-battery array. Each PLC unit may be assigned responsibility for a subset of the sixteen batteries within the array. The two PLC units may communicate with one another via the peer-to-peer mesh I/O sharing architecture, exchanging cell voltage data, charge status data, and pulse parameter data to coordinate the charging and balancing operations across the full sixteen-battery array. The first PLC unit may manage pulse charging for a first subset of batteries within the array, and the second PLC unit may manage pulse charging for a second subset of batteries within the array. The peer-to-peer mesh I/O sharing between the two PLC units may allow each unit to monitor the charge status of the batteries managed by the other unit, enabling coordinated load balancing and charge equalization across the complete sixteen-battery whole-house configuration.

The two-PLC implementation for the sixteen-battery whole-house configuration may interface with the BMS controller 204 of FIG. 6. The BMS controller 204 may receive aggregated cell voltage and charge status data from both PLC units via the IoT module 210. The IoT module 210 may transmit this aggregated data to the external platform for analysis using the control algorithms described with reference to FIGS. 1 and 2. The external platform may generate control signals specifying pulse parameter adjustments for individual cells or cell groups within the sixteen-battery array. These control signals may be transmitted back to the BMS controller 204 via the IoT module 210 and may be relayed to the respective PLC units for execution. The two PLC units may thereby operate as distributed pulse charging controllers within the broader IoT-enabled BMS architecture, with the BMS controller 204 and the external platform providing supervisory oversight of the pulse charging operations performed by each PLC unit across the sixteen-battery whole-house configuration.

The PLC-based pulse charging implementation may support the data logging function of the BMS by recording pulse output parameters, cell voltage measurements, and charge status data at each PLC unit. The logged data may be transmitted to the external platform via the IoT module 210 for storage and analysis. The external platform may apply machine learning algorithms to the logged data to identify trends in cell charge acceptance, detect early indicators of cell degradation, and generate predictive maintenance recommendations for the sixteen-battery array. The sensor integration function of the PLC-based implementation may allow each PLC unit to receive temperature sensor data, voltage sensor data, and current sensor data from the battery cells within its assigned subset of the array. The PLC may use this sensor data to dynamically adjust the pulse output parameters at each pulsed relay node, maintaining the faradaic charging process within the electrochemically favorable operating range described with reference to FIG. 10.

The PLC-based pulse charging approach may provide advantages including compatibility with standard industrial automation hardware, support for peer-to-peer distributed control architectures, and the ability to scale the pulse charging function across large battery arrays by adding PLC units to the peer-to-peer mesh without requiring modification of the existing PLC units or the BMS controller 204. In the whole-house configuration described above, the two-PLC implementation may be expanded to accommodate battery arrays larger than sixteen batteries by adding additional PLC units to the peer-to-peer mesh I/O sharing network, with each additional PLC unit assuming responsibility for a further subset of batteries within the expanded array. The modular scalability of the PLC-based pulse charging implementation may thereby complement the broader modular and scalable architecture of the BMS described with reference to the scalability and modularity section above, enabling the pulse charging function to grow with the energy storage capacity of the deployed system.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

A fourth technical advantage may relate to broad interoperability with diverse power sources and external devices. Conventional BTM battery systems may be designed for compatibility with a limited set of power sources, typically grid power and a single type of solar inverter, and may be unable to interface with the full range of energy sources available in modern residential, commercial, and industrial deployments. The dynamic signal conversion unit (206, 246), as illustrated in FIGS. 6 and 8, may adapt the voltage levels, current limits, and waveform characteristics of power inputs from solar photovoltaic panels, wind turbines, electric vehicles, standalone generators, additional battery packs, and grid power sources to a standardized format compatible with the battery system. The external device detection module (244), as illustrated in FIG. 8, may automatically identify connected devices and may transmit device characterization data to the dynamic signal conversion unit (246) to enable automatic adaptation without requiring manual configuration by the user. This open architecture approach may allow the battery system to be deployed in a wide range of energy environments without requiring dedicated power conditioning equipment for each source type, reducing installation complexity and cost. The compatibility profile library stored in memory may further enable the system to recognize and adapt to newly connected devices, extending the range of compatible devices over time through software updates rather than hardware modifications.

A fifth technical advantage may relate to seamless and rapid transition between grid-connected and off-grid operating modes. Conventional BTM battery systems may experience delays or interruptions during mode transitions, which may result in power disruptions to critical loads during grid instability events. The intelligent transfer switch (248), as illustrated in FIG. 8, may employ solid-state relay technology using high-performance semiconductors such as silicon carbide (SiC) or gallium nitride (GaN) to execute mode transitions within milliseconds of detecting grid instability. The grid monitoring module may continuously measure grid voltage, frequency, and power quality, as described in connection with FIG. 4, and may initiate the transition sequence upon detecting voltage sags, frequency deviations, or complete grid failure events. The load prioritization module may ensure that critical loads, including medical equipment, security systems, and essential appliances, may receive uninterrupted power during off-grid operation. The dynamic voltage restorer (DVR) may smooth voltage fluctuations during switching events, further reducing the likelihood of power quality disturbances reaching connected loads. This combination of rapid switching speed, predictive instability detection, and load prioritization may provide a substantially more reliable power continuity solution than conventional mechanical transfer switches, which may require switching times measured in cycles rather than milliseconds.

A sixth technical advantage may relate to enhanced cybersecurity for IoT-connected energy systems. Conventional IoT-connected BTM battery systems may lack comprehensive cybersecurity measures, leaving operational data and control interfaces vulnerable to unauthorized access, data breaches, and denial-of-service (DoS) attacks. The secure mesh network architecture (220), as illustrated in FIG. 7, may implement end-to-end encryption between mesh nodes (222, 224) using the encryption module (228), which may apply industry-standard cryptographic protocols including AES-256 for data at rest and TLS for data in transit. The anomaly detection module (230) may continuously monitor network traffic patterns for deviations indicative of unauthorized access attempts, DoS attacks, or other cybersecurity threats, and may trigger protective responses including node isolation, traffic rate limiting, and administrator alerts. The self-healing mesh topology may dynamically reroute data through alternative nodes when one or more nodes may be compromised or may experience connectivity disruptions, maintaining data integrity and system control even under adverse network conditions. Multi-factor authentication and intrusion detection systems may further protect the communication interfaces between the battery system and the external platform. This multi-layered cybersecurity architecture may provide substantially greater protection than conventional BTM battery systems that may rely on single-layer password protection or unencrypted communication channels.

A seventh technical advantage may relate to scalability and modularity across a wide range of deployment scales. Conventional BTM battery systems may be designed for a fixed capacity range and may require separate product designs for residential, commercial, and industrial applications, increasing manufacturing costs and limiting deployment flexibility. The modular architecture described herein may allow multiple BMS units to be configured in parallel or in series to scale system capacity from a minimal residential installation to a maximum of 320 kilowatts (kW), as described in the Scalability, Modularity, and Battery Chemistry section above. The same standardized BMS unit may be produced in volume on a common manufacturing line and may be tailored to specific applications through software configuration and minor hardware additions, reducing per-unit manufacturing cost and enabling economies of scale across both civilian and military markets. This scalability may allow the system to grow with the energy demands of the user without requiring replacement of the core BMS hardware.

An eighth technical advantage may relate to battery chemistry agnosticism and future compatibility with emerging battery technologies. Conventional BTM battery systems may be designed for a specific battery chemistry and may require hardware redesign to accommodate alternative chemistries. The BMS platform described herein may be compatible with lithium iron phosphate (LiFePO4), sodium-ion, and solid-state battery chemistries through software-configurable voltage thresholds, charge and discharge profiles, thermal management parameters, and cell balancing algorithms. This chemistry-agnostic design may allow the same BMS hardware to be reconfigured for different battery chemistries by updating the control algorithms stored in memory, or by adding minor hardware components such as chemistry-specific sensor modules or interface boards. This approach may protect the user's investment in the BMS hardware as battery technology evolves, and may allow the system to integrate solid-state battery technology as it becomes commercially available without requiring a redesign of the core BMS platform.

A ninth technical advantage may relate to the elimination of energy conversion losses through the inverter-less DC distribution architecture. Conventional BTM battery systems may rely on inverters to convert DC power stored in batteries into AC power before delivery to loads, introducing energy conversion losses at each conversion stage. The inverter-less BMS embodiment described herein may eliminate the DC-to-AC conversion stage by delivering DC power directly to DC-compatible loads through a PLC-controlled direct DC power distribution network incorporating buck-boost converters and charge controllers for voltage regulation. This elimination of the AC conversion stage may reduce energy losses, simplify system architecture, reduce the number of failure points, and lower maintenance costs associated with inverter servicing. The PLC-controlled switching system may govern solid-state relays and contactors to regulate power distribution in real time, enabling load prioritization and fault detection without the complexity and losses associated with AC conversion.

A tenth technical advantage may relate to the integration of artificial intelligence and machine learning for dynamic energy optimization. Conventional BTM battery systems may employ fixed charging and discharging schedules that may not adapt to changing energy prices, renewable generation availability, or load demand patterns. The AI and ML algorithms executing on the external platform and edge computing node may continuously analyze real-time and historical data from the battery system, the connected power sources, and the energy market to generate optimized charging and discharging schedules, source prioritization decisions, and load management strategies. These algorithms may predict grid instability before it occurs, enabling preemptive mode transitions that may further reduce the likelihood of power disruptions to critical loads. The ML-driven compatibility profile generation capability may allow the system to recognize and adapt to newly connected devices without manual configuration, extending the effective range of compatible devices over time. The combination of AI-driven predictive maintenance, dynamic energy optimization, and adaptive device compatibility may provide a level of operational intelligence that may not be achievable with the rule-based control logic employed in conventional BTM battery systems

An eleventh technical advantage may relate to the support for energy trading and participation in decentralized energy markets. Conventional BTM battery systems may function solely as passive energy storage devices and may not provide the communication infrastructure, analytical capabilities, or governance framework required to participate in energy trading markets. The IoT-enabled platform described herein may monitor real-time energy market conditions and may identify optimal opportunities to discharge stored energy to the grid during periods of high demand or elevated pricing, enabling users to generate financial returns from their stored energy. The optional Decentralized Autonomous Organization (DAO) governance framework may enable blockchain-based energy transactions, providing an immutable ledger for energy exchanges and enabling decentralized decision-making among multiple users or stakeholders. This energy trading capability may transform the battery system from a passive storage device into an active participant in the energy market, providing financial benefits that may offset the cost of the system over its service life.

A twelfth technical advantage may relate to the comprehensive human-machine interface (HMI) provided by the display (260), as illustrated in FIG. 9. Conventional BTM battery systems may provide limited on-site visibility into system status, requiring users to rely on remote monitoring platforms or on-site inspection to assess battery conditions. The display (260) may present selectable energy source modes including the SOLAR region (262), the EV region (264), the SUPPLY region (266), and the CUSTOM region (268), as well as real-time operational data including battery voltage, current, SOC percentage, a bar-graph charge level indicator, delta voltage, average voltage, MOS temperature, ambient temperature, alarm status, balance status, charge status, and discharge status. This comprehensive on-site display may allow maintenance technicians and on-site users to assess system status and configure operating modes without requiring access to a remote mobile or web application, reducing the time required for on-site diagnostics and configuration.

A thirteenth technical advantage may relate to the dual-use adaptability of the BMS platform across civilian and military markets. Conventional BTM battery systems may be designed exclusively for civilian applications and may lack the ruggedization, cybersecurity protections, and adaptive load management capabilities required for military deployments. The BMS platform described herein may be adapted for military applications including forward operating bases, mobile energy platforms, directed energy weapon (DEW) systems, and autonomous systems, while retaining compatibility with civilian residential, commercial, and industrial deployments. This dual-use adaptability may allow technologies developed to meet rigorous military specifications, including extreme environmental tolerance and secure communications, to be directly transitioned into commercial products, offering superior reliability and safety in everyday industrial use. The economies of scale realized by producing a common BMS platform for both civilian and military markets may reduce the per-unit manufacturing cost relative to maintaining separate product lines for each application.

1. A method for monitoring and controlling a battery system using an IoT module, comprising:
monitoring battery system parameters comprising state of charge, temperature, and power flow
using an IoT module integrated with the battery system;
transmitting the monitored parameters to an external platform via a communication network;
analyzing the transmitted parameters using control algorithms on the external platform;
generating control signals based on the analysis to optimize battery system performance; and
implementing the control signals on the battery system via the IoT module.

2. The method of claim 1, further comprising implementing fast pulse charging by generating high-frequency electrical pulses with adjustable amplitude, frequency, and duration to accelerate charging of the battery system while reducing thermal stress on battery cells.

3. The method of claim 1, further comprising adapting power inputs from multiple energy sources using a dynamic signal conversion unit to standardize input power characteristics for compatibility with the battery system.

4. The method of claim 1, further comprising detecting grid instability comprising voltage fluctuations and frequency deviations and transitioning the battery system between a grid-connected mode and an off-grid mode using an intelligent transfer switch.

5. The method of claim 1, further comprising providing real-time data and system control to users through a mobile application and a web application communicatively coupled to the external platform.

6. A device for monitoring and controlling a battery system, comprising:
a communication interface configured to receive and transmit data between the battery system and an external platform via a communication network;
a processor configured to analyze battery system parameters comprising state of charge, temperature, and power flow;
a memory storing control algorithms for dynamic adjustment of battery system operations;
a plurality of sensors integrated with the battery system and configured to monitor real-time operational conditions of the battery system; and
a fast pulse charging module comprising a high-frequency switching circuit configured to generate electrical pulses with adjustable amplitude, frequency, and duration to charge the battery system while reducing thermal stress on battery cells.

7. The device of claim 6, wherein the communication interface supports at least one wireless protocol selected from the group consisting of Wi-Fi, Zigbee, Bluetooth, and cellular networks.

8. The device of claim 6, wherein the processor is further configured to predict maintenance needs of the battery system using machine learning algorithms stored in the memory.

9. The device of claim 6, wherein the plurality of sensors comprises voltage sensors, current sensors, and thermal sensors configured to monitor per-cell operational conditions of the battery system.

10. The device of claim 6, further comprising a data encryption unit configured to secure data transmissions between the device and the external platform using end-to-end encryption protocols.

11. The device of claim 6, further comprising an intelligent transfer switch configured to transition the battery system between a grid-connected mode and an off-grid mode within milliseconds of detecting grid instability.

12. The device of claim 6, further comprising a dynamic signal conversion unit configured to adapt input power characteristics from multiple energy sources comprising grid power, solar panels, wind turbines, and electric vehicles into a standardized format compatible with the fast pulse charging module.

13. The device of claim 6, further comprising a load prioritization module configured to maintain uninterrupted power delivery to critical loads during off-grid operation of the battery system.

14. The device of claim 6, further comprising an edge computing node configured to perform real-time analytics and execute control algorithms locally at the battery system to reduce latency in control signal execution.

15. The device of claim 6, wherein the high-frequency switching circuit comprises silicon carbide components configured to reduce switching losses and dissipate heat generated during fast pulse charging cycles.

16. A system for monitoring and controlling a battery system using an IoT module, comprising:
a communication interface configured to receive and transmit data between the battery system and an external platform via a communication network;
a processor configured to analyze battery system parameters comprising state of charge, temperature, and power flow;
a memory storing control algorithms for dynamic adjustment of battery system operations;
a plurality of sensors integrated with the battery system and configured to monitor real-time operational conditions of the battery system;
a fast pulse charging module comprising a high-frequency switching circuit configured to generate electrical pulses with adjustable amplitude, frequency, and duration to charge the battery system while reducing thermal stress on battery cells;
an external platform configured to collect, store, and analyze data received from the IoT module;
a user interface accessible through a mobile application and a web application and configured to monitor and control the battery system; and
a communication network configured to transmit data in real time between the IoT module and the external platform.

17. The system of claim 16, wherein the external platform further comprises a cloud-based analytics engine configured to generate energy optimization recommendations for the battery system based on historical and real-time battery system parameters.

18. The system of claim 16, wherein the user interface is configured to display battery system performance metrics comprising state of charge, power output, energy efficiency, and charge and discharge status.

19. The system of claim 16, further comprising an alert system configured to transmit notifications of abnormal battery system conditions to the user interface.

20. The system of claim 16, wherein the communication network supports redundant communication protocols to maintain data transmission reliability during network disruptions.
